(19) United States
(12) Patent Application Publication
(10) Pub. No.: US 2014/0340746 A1
(43) Pub. Date: Nov. 20, 2014

(54) DISPLAY DEVICE

(71) Applicant: Panasonic Intellectual Property Corporation of America, Torrance, CA (US)

(72) Inventors: Tatsumi Watanabe, Osaka (JP); Ken Mashitani, Osaka (JP)

(21) Appl. No.: 14/364,920

(22) PCT Filed: Dec. 19, 2012
(86) PCT No.: PCT/JP2012/008108

§ 371 Date: Jun. 12, 2014

(30) Foreign Application Priority Data
Dec. 19, 2011 (JP) 2011-277100

(51) Int. Cl. G02B 27/22; H04N 13/04; G02B 27/00

(52) U.S. Cl. CPC G02B 27/2214; G02B 27/0093; H04N 13/0409; H04N 13/0468
USPC 359/464

(57) ABSTRACT

The present application discloses a display device including a display portion for displaying a composite image of left and right images to be viewed by left and right eyes by using display elements arranged in a matrix. The display portion defines first and second element groups for displaying the left and right images, respectively. The first element groups include first and second height group situated at first and second vertical positions, which is different from each other. The second element groups include first and second adjacent groups horizontally adjacent to the first and second height group, respectively. The first and second adjacent groups include first and second adjacent elements adjacent to the first and second height groups, respectively. The first adjacent element emits different light in a luminescent color from the second adjacent element.

### TECHNICAL FIELD

The present invention relates to a display device which allows a viewer to view stereoscopic images without a dedicated eyewear device.

### BACKGROUND ART

A display device for displaying stereoscopic images typically includes a display portion such as a LCD (liquid crystal panel) or a PDP (plasma display panel), and a parallax barrier or a lenticular lens which is situated between the display portion and a viewer. A display portion simultaneously displays a left image to be viewed by the left eye with a right image to be viewed by the right eye. The parallax barrier or the lenticular lens separates image light emitted from the display portion and causes left image light in correspondence to the left image to enter the left eye, and causes right image light in correspondence to the right image to enter the right eye. Consequently, the viewer may stereoscopically perceive the images displayed by the display portion without a dedicated eyewear device.

FIG. 46 is a schematic view of the aforementioned display device 900 (c.f. Non-Patent Document 1). The display device 900 is described with reference to FIG. 46.

The display device 900 includes a display panel 910 and a parallax barrier 920. The display panel 910 displays an image by using vertical pixel columns (indicated with symbol “L” in FIG. 46) which represent a left image, and vertical pixel columns (indicated with symbol “R” in FIG. 46) which represent a right image. The vertical pixel columns, which display the left image, and the vertical pixel columns, which display the right image, are alternately arranged in the horizontal direction. The parallax barrier 920 includes blocking zones 921 for blocking image light emitted from the display panel 910. Like the vertical pixel columns, the blocking zones 921 extend in the vertical direction. Openings (or Apertures) 922 are formed between the blocking zones 921 to allow transmission of the image light.

The left and right images represent different contents by binocular parallax. The viewer may synthesize a three-dimensional image from the left and right images due to the binocular parallax set between the left and right images.

The display panel 910 displays a parallax image, which is a composite image of the left and right images. When a viewer faces the display device 900 at an appropriate position, the image light emitted from the vertical pixel columns to display the right image may reach the right eye of the viewer while the image light emitted from the vertical pixel columns to display the left image reaches the left eye of the viewer. Meanwhile, the blocking zones 921 block the image light directed toward the right eye of the viewer from the vertical pixel columns to display the left image and simultaneously block the image light directed toward the left eye of the viewer from the vertical pixel columns to display the right image. Consequently, the viewer may appropriately view a stereoscopic image displayed by the display device 900.

Each of the aforementioned vertical pixel columns is formed with sub-pixels aligned in the vertical direction. If there are a small size of the sub-pixels and a consistent distance between the display panel 910 and the parallax barrier 920, there may be a long distance from the display device 900 (hereinafter referred to as the “appropriate viewing distance”) at which the viewer may appropriately view the image. The aforementioned characteristics are undesirable, for example, when the display device 900 is a portable device such as a tablet.

FIGS. 47A and 47B are photographs showing other problems which happen to the display device 900. The problems of the display device 900 are described with reference to FIGS. 46 to 47B.

The display device 900 uses the display panel 910 and the parallax barrier 920 to display stereoscopic images. Interference fringes (moire) shown in FIGS. 47A and 47B may be caused by a relationship between a pattern of the openings 922 of the parallax barrier 920 and a structure of pixels of the display panel 910. If the opening 922 is designed to be wide, the moire may be weakened. On the other hand, crosstalk (phenomenon in which there may be blurred images or an overlapping image as a result of the left eye simultaneously viewing not only the left image but also the right image or ghosting) may occur.

FIG. 48 is a schematic view of the display device 930 disclosed in Patent Document 1. The conventional display device 930 is described with reference to FIGS. 46 and 48.

Like the display device 900, the display device 930 includes the parallax barrier 920. The display device 930 includes a display panel 940 (liquid crystal display panel) which emits image light toward a viewer. The display panel 940 includes pixels 941 for displaying the left image and pixel 942 for displaying the right image. The left image pixels 941 include R sub-pixels (indicated with symbol “R” in FIG. 48) which emit red light, G sub-pixels (indicated with symbol “G” in FIG. 48) which emit green light, and B sub-pixels (indicated with symbol “B” in FIG. 48) which emit blue light. Like the left image pixels 941, the right image pixels 942 also include R sub-pixels which emit red light, G sub-pixels which emit green light, and B sub-pixels which emit blue light. The R, G and B sub-pixels are aligned in the vertical direction. The pixels 941, 942 are alternately aligned in the horizontal direction.

The R sub-pixel is situated at the rightmost position in the pixel 941. The B sub-pixel is situated at the leftmost position. The G sub-pixel is situated between the R and B sub-pixels.

The R sub-pixel is situated at the rightmost position in the pixel 942. The B sub-pixel is situated at the leftmost position. The G sub-pixel is situated between the R and B sub-pixels.

The image light emitted from the display panel 940 passes through the openings 922 of the parallax barrier 920 to reach a viewer. When the viewer stands away from the display device 930 at an appropriate viewing distance, the image light emitted from the left image pixels 941 passes through the openings 922 and reaches the left eye, but does not reach the right eye. The image light emitted from the right image pixels 942 passes through the openings 922 and reaches the right eye, but does not reach the left eye. Consequently, the viewer may stereoscopically perceive the image displayed on the display panel 940.

The distance between the pixels 941 for displaying the left image and the pixel 942 for displaying the right image is a length defined by the three sub-pixels aligned in the horizontal direction. Accordingly, the distance between the pixels 941, 942 respectively aligned in the vertical direction is three times as long as the distance between the vertical pixel columns described with reference to FIG. 46. Consequently, the appropriate viewing distance of the display device 930 is ⅓ of that of the display device 900.

FIGS. 49A and 49B are schematic views of the pixels which appear from the opening 922. Problems which happen to the display device 930 are described with reference to FIGS. 49A and 49B.

As described above, each of the pixels 941, 942 are configured from R, G and B sub-pixels. In FIGS. 49A and 49B, the left image pixels 941 are encompassed with a rectangular frame. In FIGS. 49A and 49B, the frame encompassing the pixels 941 aligned in the vertical direction is indicated as the opening 922.

FIG. 49A shows the pixels observed through the opening 922 by a viewer appropriately viewing a stereoscopic image. FIG. 49B shows the pixels observed through the opening 922 by the viewer moving leftward. The rectangular frame of the dotted line in FIG. 49B shows an observed region which is observed by the viewer moving leftward. As shown in the ovals of FIG. 49B, when the viewer moves leftward, the R sub-pixels of the right image pixels 942 are observed by the left eye. Accordingly, color moire is likely to happen.

A slant barrier may be used to set an appropriate aspect ratio of the parallax image. Even when the slant barrier is used, the problem of color moire may not be solved.

As described above, there is a trade-off relationship between moire and crosstalk. Accordingly, when an opening width of a barrier member is set wide, the moire may be weakened but the crosstalk may increase.
Patent Document 1: JP H9-233500 A
Non-Patent Document 1: “Autostereoscopic 3D Displays using Image-Splitter Method”, Journal of The Institute of Image Information and Television Engineers Vol. 51, No. 7, pp. 1070-1078 (1997)

### SUMMARY OF THE INVENTION

An object of the present invention is to provide technologies for reducing moire intensity without a significant increase in crosstalk.

The display device according to one aspect of the present invention includes a display portion configured to display a composite image of a left image to be viewed by a left eye and a right image to be viewed by a right eye by using display elements arranged in a matrix. The display portion defines first element groups for displaying one of the left and right images, and second element groups for displaying the other of the left and right images among the display elements. The first element groups include a first height group situated at a first vertical position, and a second height group situated at a second vertical position different from the first vertical position. The second element groups include a first adjacent group adjacent to the first height group in the horizontal direction, and a second adjacent group adjacent to the second height group in the horizontal direction. The first adjacent group includes a first adjacent element adjacent to the first height group. The second adjacent group includes a second adjacent element adjacent to the second height group. The first adjacent element emits different light in a color from the second adjacent element.

The display device according to the present invention may reduce moire intensity without a significant increase in crosstalk.

The object, features and advantages of the present invention will become more apparent from the ensuing detailed description and appended drawings.

### BRIEF DESCRIPTION OF THE DRAWINGS

FIG. 1 is a schematic block diagram of a display device according to the first embodiment.

FIG. 2 is a schematic view of a display portion of the display device shown in FIG. 1.

FIG. 3 is a schematic view of an exemplary slant barrier which is used as a separator of the display device according to the first embodiment.

FIG. 4 is a schematic view of a display portion of the display device shown in FIG. 1.

FIG. 5 is a schematic view of the display portion of the display device shown in FIG. 1.

FIG. 6 is a schematic view of the display portion of the display device shown in FIG. 1.

FIG. 7 is a schematic view of the display portion of the display device shown in FIG. 1.

FIG. 8 is a schematic view of openings of a step barrier which is superimposed on the display portion shown in FIG. 2.

FIG. 9 is a schematic view of the display portion of the display device shown in FIG. 1.

FIG. 10 is a schematic view of a slant barrier which is used as the separator of the display device according to the first embodiment.

FIG. 11 is an enlarged view of the slant barrier shown in FIG. 10.

FIG. 12A is a conceptual view of a transmission pattern of image light.

FIG. 12B is a conceptual view of a transmission pattern of image light.

FIG. 12C is a conceptual view of a transmission pattern of image light.

FIG. 13 is a schematic view of a sub-pixel.

FIG. 14 is a schematic block diagram of a display device according to the second embodiment.

FIG. 15 is a schematic view of a display portion of the display device shown in FIG. 14.

FIG. 16 is a schematic view of an opening of a slant barrier which is superimposed on the display portion shown in FIG. 15.

FIG. 17 is a schematic view of an opening of a slant barrier which is superimposed on the display portion shown in FIG. 15.

FIG. 18 is a schematic view of an opening of a slant barrier to which a notch structure is applied.

FIG. 19 is a schematic view of the display portion of the display device shown in FIG. 14.

FIG. 20 is a schematic view of an opening of a slant barrier which is superimposed on the display portion shown in FIG. 19.

FIG. 21 is a schematic view of an opening obtained by adding a notch structure to the opening shown in FIG. 20.

FIG. 22 is an enlarged view of a slant barrier having an asymmetrical notch structure.

FIG. 23 is a schematic view of an exemplary opening which is formed on the basis of a design method of the notch structure shown in FIG. 22.

FIG. 24 is a schematic view of an opening of a slant barrier which is superimposed on the display portion shown in FIG. 19.

FIG. 25 is a schematic block diagram of a display device according to the third embodiment.

FIG. 26 is a schematic block diagram of a detector of the display device shown in FIG. 25.

FIG. 27 is a schematic block diagram of a head detector of the detector shown in FIG. 26.

FIG. 28 is a conceptual view of processes executed by the detector shown in FIG. 26.

FIG. 29 is a conceptual view of processes executed by a pattern matching portion shown in FIG. 26.

FIG. 30 is a schematic view of the display device shown in FIG. 25.

FIG. 31 is a schematic view of a display portion of the display device shown in FIG. 30.

FIG. 32 is a schematic view of the display device shown in FIG. 25.

FIG. 33 is a schematic view of the display device shown in FIG. 25.

FIG. 34 is a schematic view of changing operation of a display pattern of the display portion shown in FIG. 31.

FIG. 35 is a schematic view of the changing operation of the display pattern of the display portion shown in FIG. 31.

FIG. 36 is a schematic view of another changing operation of the display pattern.

FIG. 37 is a schematic view of another changing operation of the display pattern.

FIG. 38 is a schematic view of another changing operation of the display pattern.

FIG. 39 is a schematic block diagram of a display device according to the fourth embodiment.

FIG. 40 is a schematic block diagram of a determination portion of the display device shown in FIG. 39.

FIG. 41 is a schematic view of a separator of the display device shown in FIG. 39.

FIG. 42 is a schematic view of another barrier structure.

FIG. 43 is a schematic view of a display device including a lenticular lens.

FIG. 44 is a schematic view of a display device.

FIG. 45 is a schematic view of a display device.

FIG. 46 is a schematic view of a conventional display device.

FIG. 47A shows photographs representing problems which happen to the display device shown in FIG. 46.

FIG. 47B shows photographs representing problems which happen to the display device shown in FIG. 46.

FIG. 48 is a schematic view of a conventional display device.

FIG. 49A is a schematic view of pixels which appear from openings.

FIG. 49B is a schematic view of pixels which appear from openings.

FIG. 50 is a schematic view of a case when a number of sub-pixel columns kk representing a parallax image is not an integer.

FIG. 51 is a schematic view of a case when adjacent pixels are not aligned on one straight line.

### DETAILED DESCRIPTION OF THE INVENTION

Various display devices for displaying high quality images are described with reference to the drawings. It should be noted that the same reference numerals are assigned to the same components in the following various embodiments. In order to clarify a concept of the display device, redundant explanations are omitted as appropriate. Configurations, arrangements and shapes shown in the drawings and descriptions related to the drawings are provided simply for making principles of the embodiments easily understood. Accordingly, the principles of the embodiments are not in any way limited to them.

### First Embodiment

### Display Device

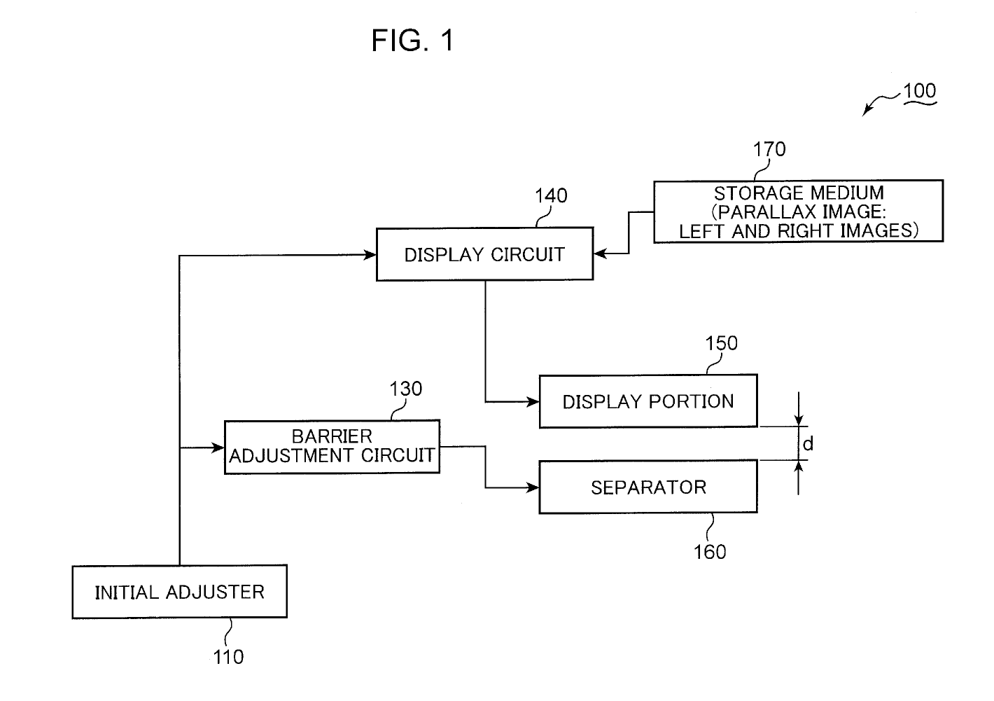

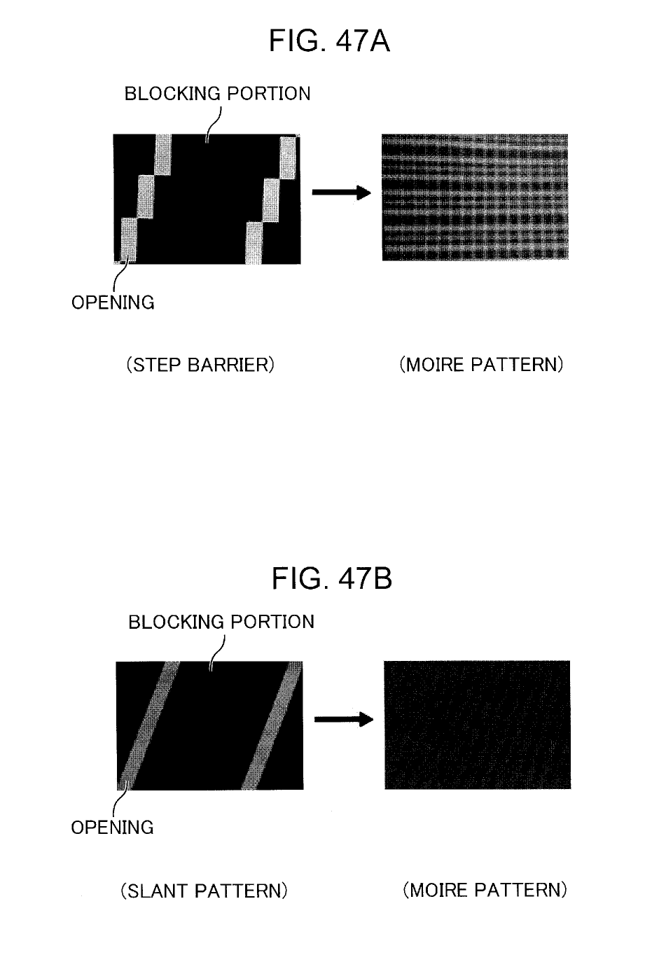

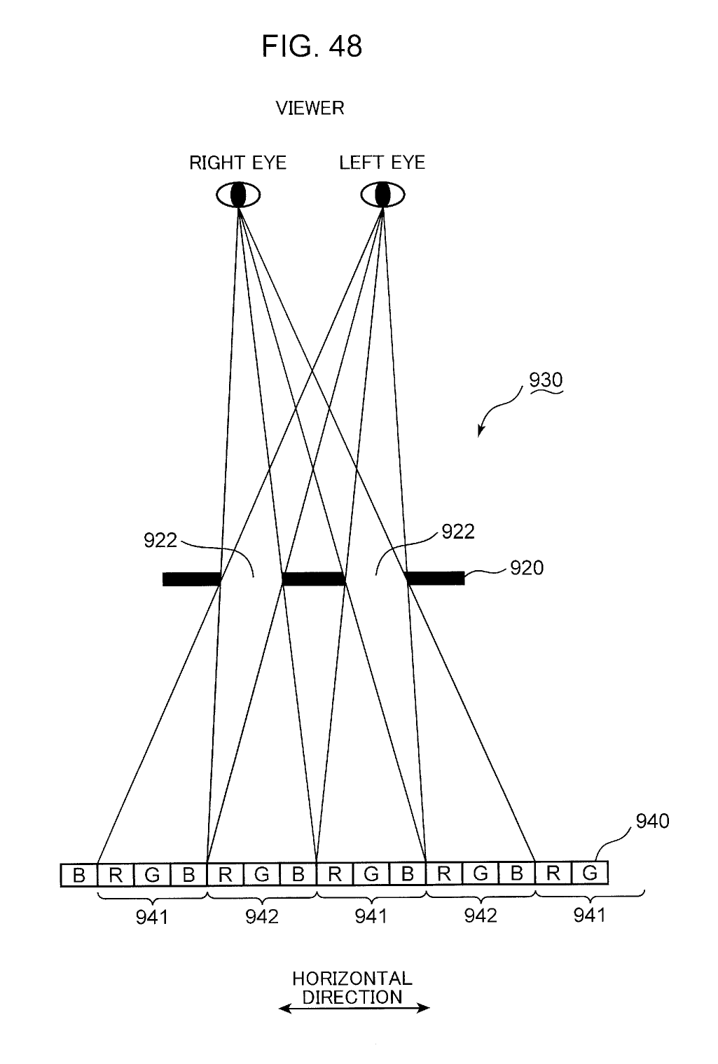

FIG. 1 is a schematic block diagram of the display device 100 according to the first embodiment. The display device 100 is described with reference to FIGS. 1, 47A and 47B.

The display device 100 includes an initial adjuster 110, a barrier adjustment circuit 130, a display circuit 140, a display portion 150, a separator 160 and a storage medium 170. The initial adjuster 110 performs initial adjustments to the barrier adjustment circuit 130 and the display circuit 140. The storage medium 170 stores image data about parallax images, which are obtained by synthesizing a left image to be viewed by a left eye and a right image to be viewed by a right eye. The image data is transferred from the storage medium 170 to the display circuit 140. The display circuit 140 processes the image data to generate drive signals. The drive signals are transferred from the display circuit 140 to the display portion 150. The display portion 150 displays parallax images (2D) in response to the drive signals. In this embodiment, the parallax images are exemplified as the composite image.

The separator 160 may be a parallax barrier situated away from the display portion 150. A slant barrier and a step barrier are exemplified as the parallax barrier. FIG. 47A shows a general step barrier. The step barrier includes openings configured to match a size of the sub-pixels. These openings are formed in a staircase pattern. FIG. 47B shows a general slant barrier. The slant barrier includes openings inclined from a vertical line. These openings are formed at predetermined intervals in the horizontal direction.

The display portion 150 emits image light representing a parallax image toward the separator 160 by using pixels or sub-pixels, which are arranged in a matrix. The separator 160 includes blocking portions for defining a size and shape of the aforementioned openings. The blocking portions block the image light emitted from the display portion 150 whereas the openings allow transmission of the image light. Accordingly, the image light may pass through the openings and reach the viewer's eyes. The separator 160 is formed so that the image light in correspondence to the left image enters the left eye of the viewer existing at a predetermined position whereas the image light in correspondence to the right image enters the right eye of that viewer. In addition, the separator 160 is formed so that the image light of the right image directed toward the left eye and the image light of the left image directed toward the right eye are blocked by the blocking portions. Accordingly, the separator 160 may appropriately separate the image light representing the parallax image displayed by the display portion 150 into image light in correspondence to the left image and image light in correspondence to the right image to provide the left and right images to the viewer. Since the left and right images are different by the parallax, the viewer may perceive the parallax image displayed by the display portion 150 as a stereoscopic image. In this embodiment, the sub-pixels are exemplified as the display elements.

The separator 160 may be a fixed barrier member which is formed from a thin film or a highly transparent material (e.g. glass). Alternatively, the separator 160 may be a barrier device (e.g. TFT liquid crystal panel) configured to change parameters such as the blocking position, blocking area, opening position and opening area under voltage application.

The barrier adjustment circuit 130 adjusts a distance and position of the separator 160 from the display portion 150.

Once the display device 100 starts to display images or when the display device 100 is placed in a usage environment, the initial adjuster 110 adjusts the barrier adjustment circuit 130 and the display circuit 140. If the separator 160 is an active parallax barrier such as a TFT liquid crystal panel, the initial adjuster 110 adjusts parameters such as an interval of openings, a width of the openings and a distance of the separator 160 from the display portion 150 with reference to a viewing position, which is predetermined as an optimal viewing distance. The initial adjuster 110 may perform a positional control of the openings and blocking portions of the separator 160 for each pixel or sub-pixel. If the separator 160 is a fixed barrier member, the initial adjuster 110 may adjust a distance between the display portion 150 and the separator 160 and an inclination angle of the separator 160 from the display portion 150. A predetermined adjustment image may be used for the adjustments to the separator 160 performed by the initial adjuster 110.

During the aforementioned adjustment operations performed by the initial adjuster 110, evaluations and adjustment operations to visually recognized stereoscopic images may be performed by using test images. A viewer observing stereoscopic images at an optimal viewing distance may view the test images and evaluate a level of visibility and blurring/fusion of the stereoscopic images. The viewer may use the display circuit 140 to tune gradation characteristics. Optionally, the viewer may adjust a parallax image to change a parallax amount between the left and right images (e.g. intensity control using a linear coefficient or adjustment to a shift amount in the horizontal direction).

### (Display Portion)

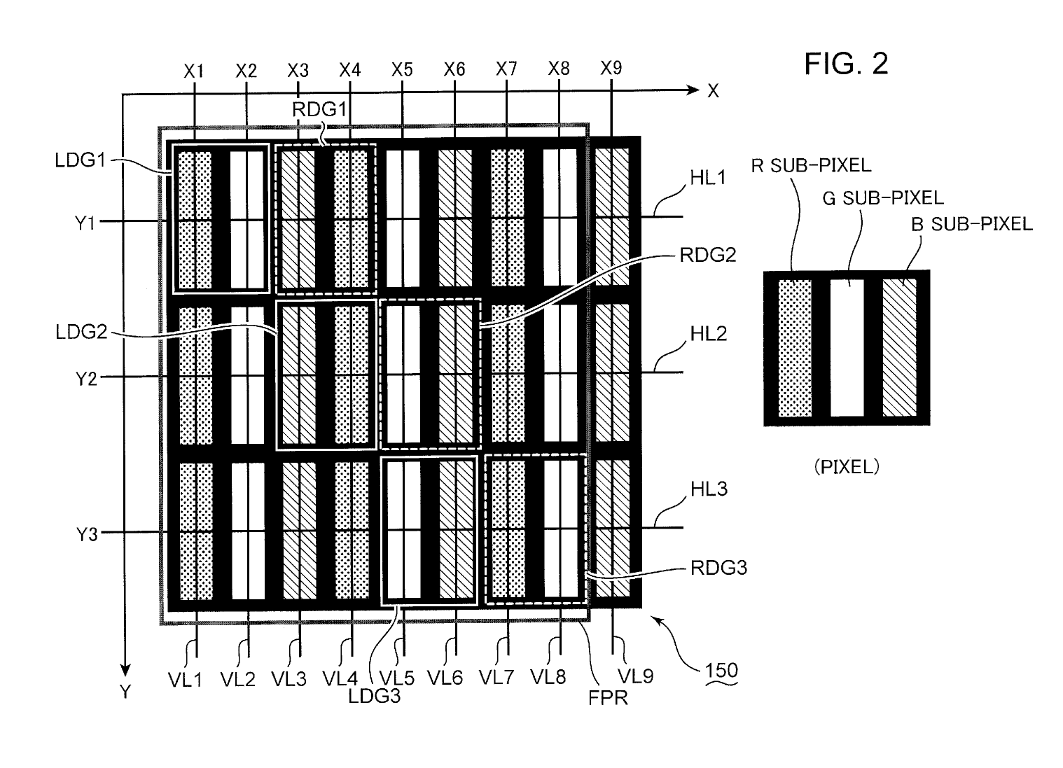

FIG. 2 is a schematic view of the display portion 150. The display portion 150 is described with reference to FIGS. 1 and 2.

The display portion 150 includes pixels arranged in a matrix. Each of the pixels includes an R sub-pixel, which emits red light, a G sub-pixel, which emits green light, and a B sub-pixel, which emits blue light. The R, G and B sub-pixels are sequentially aligned in each of the pixels from left to right in the horizontal direction (X-axis direction in FIG. 2). The R sub-pixels are aligned in the vertical direction (Y-axis direction in FIG. 2). The G sub-pixels are aligned in the vertical direction. The B sub-pixels are aligned in the vertical direction. It should be noted that the arrangement of these sub-pixels does not in any way limit the principles of the present embodiment.

In this embodiment, the number of parallaxes is set to “4”. In other words, when one of the four viewpoints coincides with the left eye and another of the four viewpoints coincides with the right eye, the viewer may stereoscopically perceive images displayed by the display portion 150. FIG. 2 shows a rectangular region FPR, which is recognized as one pixel by the viewer in the four viewpoints. The aspect ratio of the rectangular region FPR is “9:8”.

FIG. 2 shows XY coordinates. The display portion 150 is described with reference to the XY coordinates. It should be noted that the definition of the coordinates is to clarify the description. Accordingly, the principle of this embodiment is not limited in any way to the description about the coordinates.

FIG. 2 shows a horizontal line HL1 extending through a coordinate value “Y1”, a horizontal line HL2 extending through a coordinate value “Y2” set below the coordinate value “Y1”, and a horizontal line HL3 extending through a coordinate value “Y3” set below the coordinate value “Y2”. The horizontal lines HL1 to HL3 extend through the center of each of the sub-pixels.

FIG. 2 shows a vertical line “VL1” extending through a coordinate value “X1”, a vertical line “VL2” extending through a coordinate value “X2” set to the right of the coordinate value “X1”, a vertical line “VL3” extending through a coordinate value “X3” set to the right of the coordinate value “X2”, a vertical line “VL4” extending through a coordinate value “X4” set to the right of the coordinate value “X3”, a vertical line “VL5” extending through a coordinate value “X5” set to the right of the coordinate value “X4”, a vertical line “VL6” extending through a coordinate value “X6” set to the right of the coordinate value “X5”, a vertical line “VL7” extending through a coordinate value “X7” set to the right of the coordinate value “X6”, a vertical line “VL8” extending through a coordinate value “X8” set to the right of the coordinate value “X7”, and a vertical line “VL9” extending through a coordinate value “X9” set to the right of the coordinate value “X8”. The vertical lines VL1 to VL9 extend through the centers of the sub-pixels, respectively. In the following description, the sub-pixels are described with reference to the coordinates of the intersections between the horizontal lines HL1 to HL3 and the vertical lines VL1 to VL9. For example, the sub-pixel positioned at the intersection between the horizontal line HL1 and the vertical line VL1 is referred to as the “sub-pixel (X1, Y1)”.

The display portion 150 sets one display group LDG1 by using the sub-pixel (X1, Y1), and the sub-pixel (X2, Y1), which is adjacent to the sub-pixel (X1, Y1) in the horizontal direction. The display portion 150 sets one display group LDG2 by using the sub-pixel (X3, Y2) and the sub-pixel (X4, Y2), which is adjacent to the sub-pixel (X3, Y2) in the horizontal direction. The display portion 150 sets one display group LDG3 by using the sub-pixel (X5, Y3) and the sub-pixel (X6, Y3), which is adjacent to the sub-pixel (X5, Y3) in the horizontal direction. The display portion 150 defines the display groups LDG1 to LDG3 among the sub-pixels arranged in the rectangular region FPR as a group for displaying a left image. The viewer recognizes the display groups LDG1 to LDG3 as one pixel at one viewpoint. In this embodiment, each of the display groups LDG1 to LDG3 may be exemplified as the first element group.

The display portion 150 sets one display group RDG1 by using the sub-pixel (X3, Y1) and the sub-pixel (X4, Y1), which is adjacent to the sub-pixel (X3, Y1) in the horizontal direction. The display portion 150 sets one display group RDG2 by using the sub-pixel (X5, Y2) and the sub-pixel (X6, Y2), which is adjacent to the sub-pixel (X5, Y2) in the horizontal direction. The display portion 150 sets one display group RDG3 by using the sub-pixel (X7, Y3) and the sub-pixel (X8, Y3), which is adjacent to the sub-pixel (X7, Y3) in the horizontal direction. The display portion 150 defines the display groups RDG1 to RDG3 among the sub-pixels arranged in the rectangular region FPR as a group for displaying a right image. The viewer recognizes the display groups RDG1 to RDG3 as one pixel at another viewpoint. In this embodiment, each of the display groups RDG1 to RDG3 may be exemplified as the second element group.

In this embodiment, the display group LDG1 set on the horizontal line HL1 may be exemplified as the first height group. In this case, the display group LDG2 or LDG3 set on the horizontal line HL2 or HL3, which is set at a vertical position different from the horizontal line HL1 may be exemplified as the second height group.

In this embodiment, the display group RDG1 adjacent to the display group LDG1 in the horizontal direction may be exemplified as the first adjacent group. The display group RDG2 adjacent to the display group LDG2 in the horizontal direction or the display group RDG3 adjacent to the display group LDG3 in the horizontal direction may be exemplified as the second adjacent group.

In the display group RDG1, the sub-pixel (X3, Y1) adjacent to the display group LDG1 is a B sub-pixel which emits blue light. In this embodiment, the sub-pixel (X3, Y1) may be exemplified as the first adjacent element.

In the display group RDG2, the sub-pixel (X5, Y2) adjacent to the display group LDG2 is a G sub-pixel which emits green light. In this embodiment, the sub-pixel (X5, Y2) may be exemplified as the second adjacent element.

In the display group RDG3, the sub-pixel (X7, Y3) adjacent to the display group LDG3 is an R sub-pixel which emits red light. In this embodiment, the sub-pixel (X7, Y3) may be exemplified as the second adjacent element.

In this embodiment, the display groups LDG1 to LDG3 form a group column, which is inclined at a predetermined angle from the vertical line. Likewise, the display groups RDG1 to RDG3 form a group column, which is inclined at an inclination angle as large as that of the group column formed by the display groups LDG1 to LDG3. In this embodiment, the group column formed by the display groups LDG1 to LDG3 may be exemplified as the first group column. The group column formed by the display groups RDG1 to RDG3 may be exemplified as the second group column.

The display portion 150 alternately sets a group column, which displays a left image, and a group column, which displays a right image, in the horizontal direction. Accordingly, when a slant barrier is used as the separator 160 described with reference to FIG. 1, the image light emitted by the display portion 150 is appropriately separated into image light representing the left image and image light representing the right image.

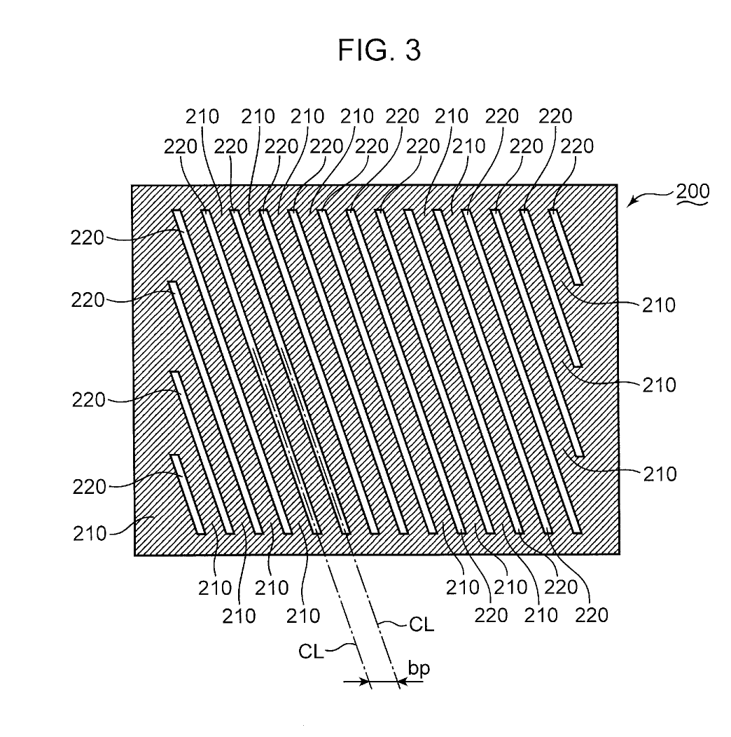

FIG. 3 is a schematic view of an exemplary slant barrier 200, which is used as the separator 160. The slant barrier 200 is described with reference to FIGS. 1 and 3.

The slant barrier 200 includes blocking regions 210 for blocking image light emitted from the display portion 150. Openings 220 are formed between the blocking regions 210 to allow transmission of the image light. A distance between the center lines CL of the openings 220 extending diagonally (hereinafter referred to as the “barrier pitch”) is generally determined on the basis of a distance between the sub-pixels in the horizontal direction (hereinafter referred to as the “horizontal sub-pixel pitch”), an appropriate viewing distance, a distance between the display portion 150 and the slant barrier 200 (separator 160) (indicated with symbol “d” in FIG. 1), and the number of parallaxes. In FIG. 3, the barrier pitch is indicated with symbol “bp”. It should be noted that the horizontal sub-pixel pitch corresponds to a distance between the horizontal lines HL1, HL2 described with reference to FIG. 2.

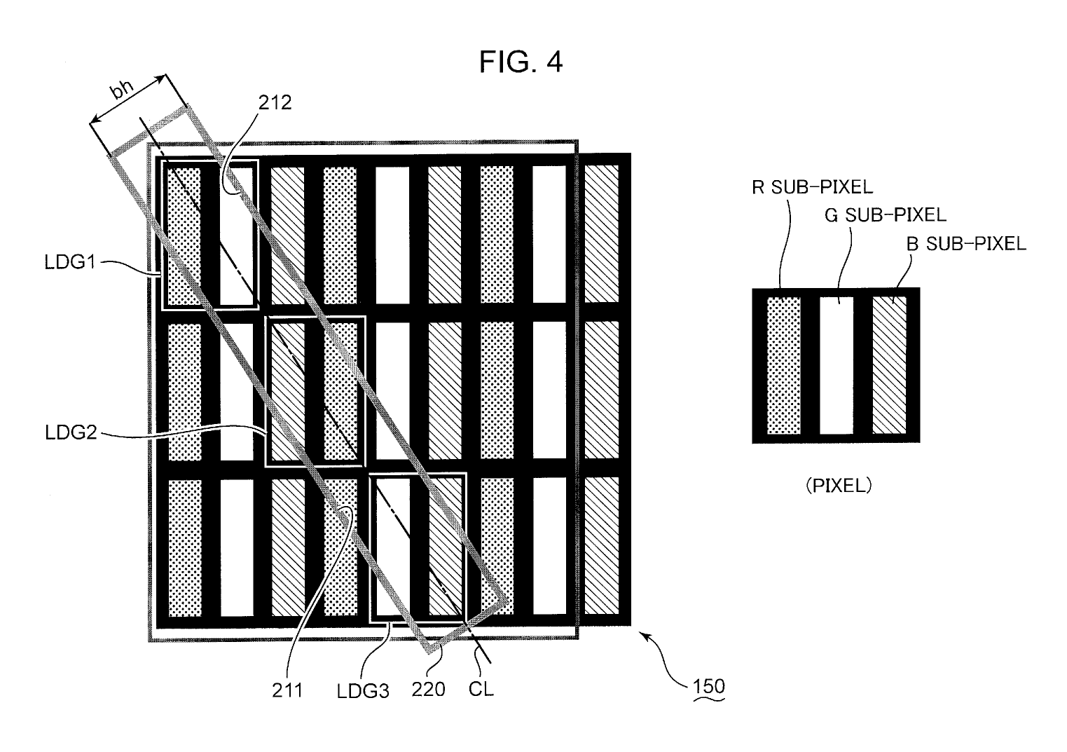

FIG. 4 is a schematic view of the display portion 150. The display portion 150 is described with reference to FIGS. 1 to 4.

FIG. 4 shows the center line CL of the column group, which is formed by the display groups LDG1 to LDG3, and the opening 220, which extends along the center line CL. The blocking region 210 includes a first contour line 211, which is substantially parallel to the center line CL, and a second contour line 212, which faces the first contour line 211. The second contour line 212 is substantially parallel to the first contour line 211. The first and second contour lines 211, 212 define a boundary between the opening 220 and the blocking region 210. In the following description, a distance between the first and second contour lines 211, 212 is referred to as “opening width”. Symbol “bh” is used for representing a dimension of the opening width. In this embodiment, the first contour line 211 may be exemplified as the first contour. The second contour line 212 may be exemplified as the second contour.

As described above, each of the display groups LDG1 to LDG3 are set by using two sub-pixels aligned in the horizontal direction. Accordingly, the opening width may be set to be twice as large as the horizontal sub-pixel pitch. The following Formula represents an exemplary relationship between the opening width and the horizontal sub-pixel pitch. In the following Formula, symbol “sp” is used to represent a dimension of the horizontal sub-pixel pitch.

bh=sp×2 [Formula 1]

The following Formula represents an appropriate viewing distance “L1”, which is obtained on the basis of the display portion 150 and the slant barrier 200. Symbol “E” is used to represent an average distance (interocular distance) between the left and right eyes.

$$L 1 = \frac{E \times d}{sp \times 2} \qquad [ Formula 2 ]$$

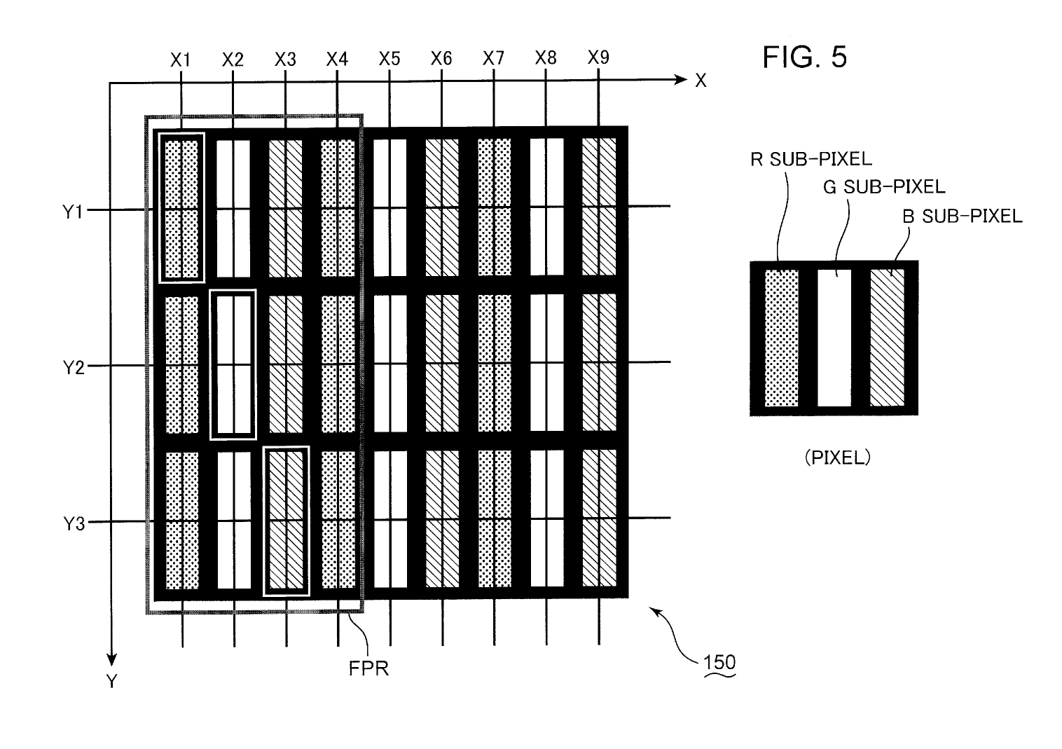

FIG. 5 is a schematic view of the display portion 150. The display portion 150 is described with reference to FIGS. 2 and 5.

Unlike FIG. 2, the display portion 150 shown in FIG. 5 assigns the sub-pixel (X1, Y1), the sub-pixel (X2, Y2) and the sub-pixel (X3, Y3) as a region for displaying the left image. The display portion 150 assigns the sub-pixel (X2, Y1), the sub-pixel (X3, Y2) and the sub-pixel (X4, Y3) as a region for displaying the right image. A viewer recognizes the sub-pixel (X1, Y1), the sub-pixel (X2, Y2) and the sub-pixel (X3, Y3) as one pixel at one viewpoint. The viewer recognizes the sub-pixel (X2, Y1), the sub-pixel (X3, Y2) and the sub-pixel (X4, Y3) as one pixel at another viewpoint.

Like FIG. 2, the display portion 150 shown in FIG. 5 sets four viewpoints. With regard to a display pattern of an image which is set by the display portion 150 of FIG. 5, the aspect ratio of the rectangular region FPR, which is recognized as one pixel by the viewer at the four viewpoints, is “9:4”.

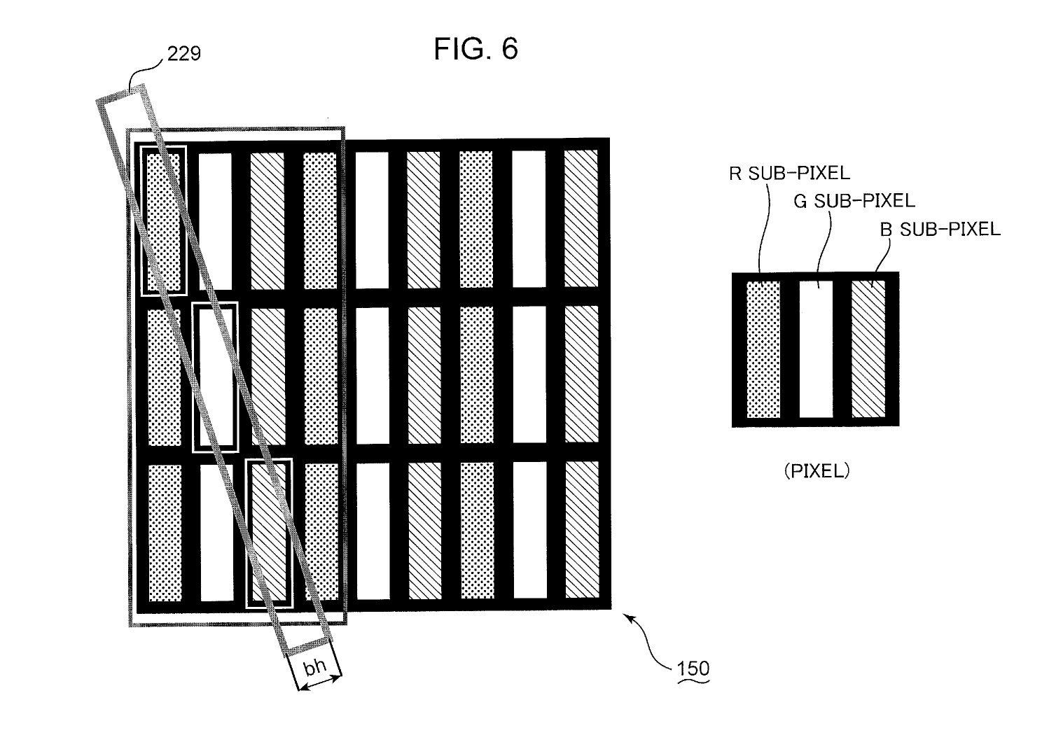

FIG. 6 is a schematic view of the display portion 150. The display portion 150 is described with reference to FIGS. 4 to 6.

FIG. 6 shows an opening 229 of a slant barrier designed to match a display pattern of an image, which is set by the display portion 150 depicted in FIG. 5. The opening 229 extends diagonally so as to overlap with the sub-pixel (X1, Y1), the sub-pixel (X2, Y2) and the sub-pixel (X3, Y3).

The display portion 150 shown in FIG. 5 forms a diagonal region for displaying a left image by using one sub-pixel at each of the vertical positions. Accordingly, the opening width (indicated with symbol “bh” in FIG. 6) of the opening 229 may be set to be as large as the horizontal sub-pixel pitch. In this case, the appropriate viewing distance “L2” obtained on the basis of the display portion 150 and the opening 229 is represented by using the following Formula.

$$L 2 = \frac{E \times d}{sp} \qquad [ Formula 3 ]$$

The following Formula shows a relationship between the appropriate viewing distance “L1” and the appropriate viewing distance “L2”.

L1=L2×0.5 [Formula 4]

When the distance (dimension indicated with symbol “d” in FIG. 1) between the display portion 150 and the slant barrier 200 is constant, the display pattern of the image described with reference to FIG. 2 may result in an appropriate viewing distance which is half in comparison to the display pattern of the image described with reference to FIG. 5.

It is known that a wide opening width contributes to a reduction in moire. As shown in FIG. 4, when the display portion 150 sets the display group by using sub-pixels aligned in the horizontal direction, an opening 220 with a wide opening width is used. Accordingly, the display pattern of the image shown in FIG. 4 leads to less moire than the display pattern of the image shown in FIGS. 5 and 6. When a wide opening 220 is applied to the display pattern of the image described with reference to FIGS. 5 and 6, a region for displaying a right image appears from the opening 220. This results in crosstalk.

As described with reference to FIG. 4, the region, which is recognized as one pixel by a viewer at one viewpoint, includes two R sub-pixels, two G sub-pixels and two B sub-pixels (RG+BR+GB). Accordingly, the display pattern of the image shown in FIG. 4 is less likely to cause a color imbalance.

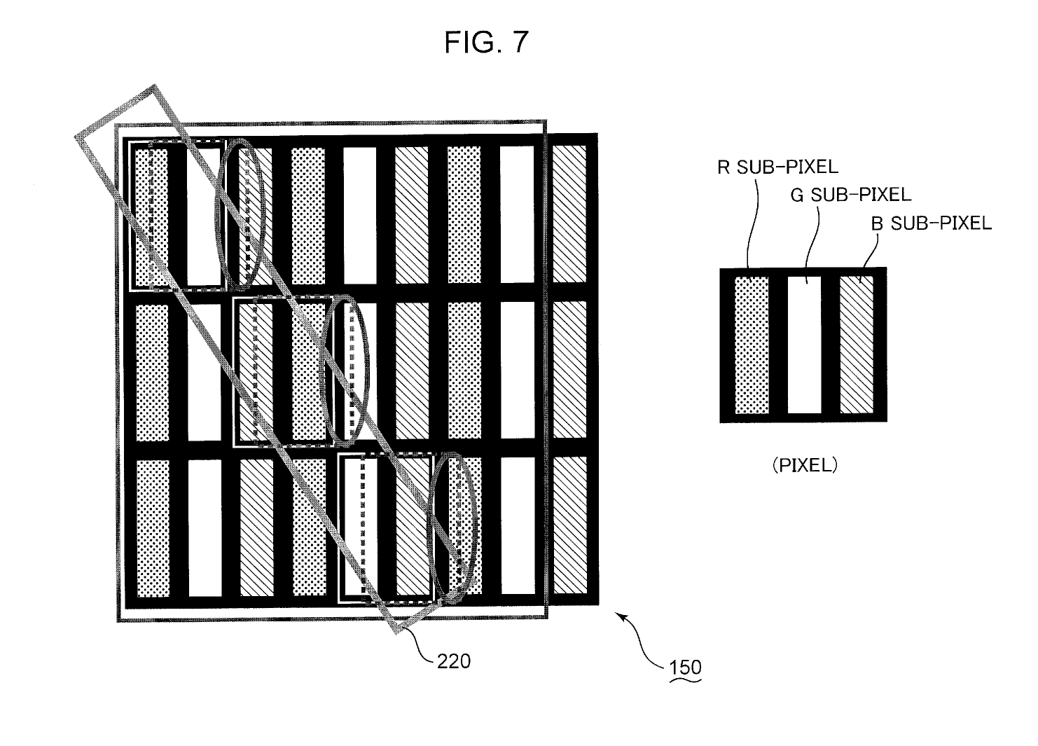

FIG. 7 is a schematic view of the display portion 150. The display portion 150 is described with reference to FIG. 4, FIGS. 5 to 7 and FIG. 49B.

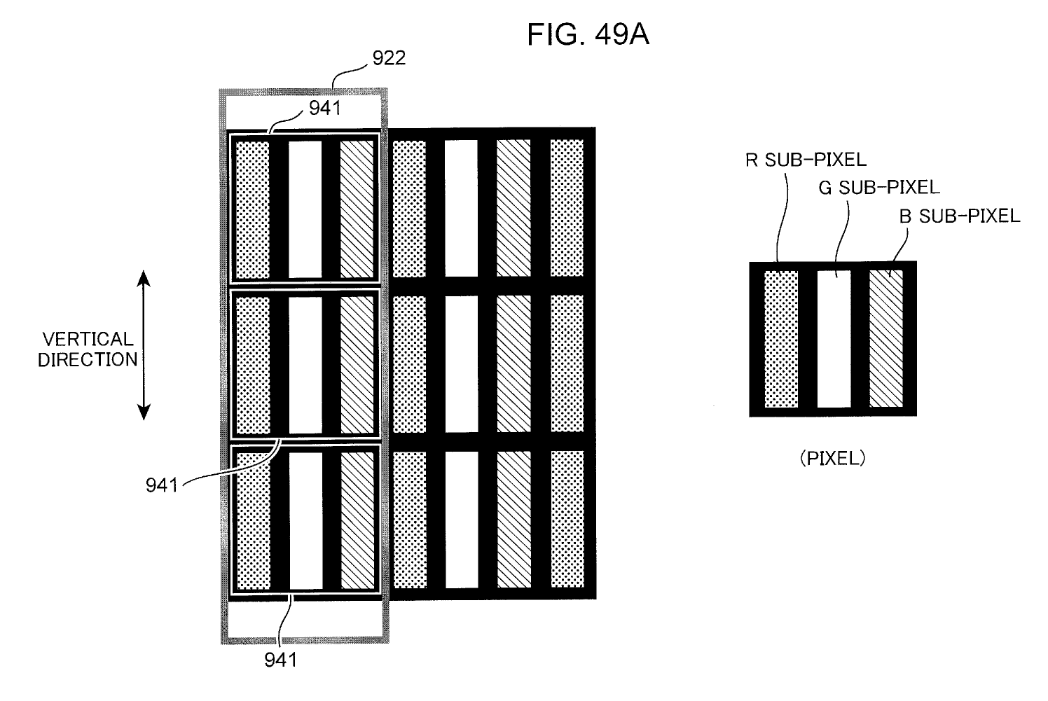

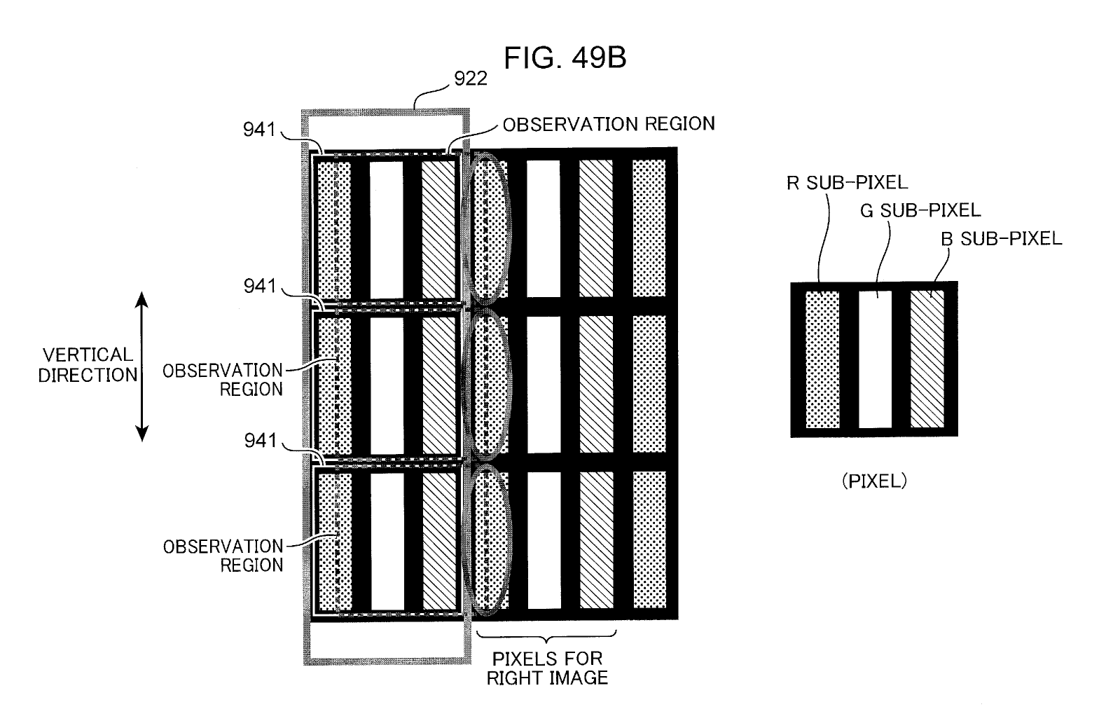

When a viewer moves in the horizontal direction from a position for observing the left image with the left eye (c.f. FIG. 4), a region viewed by the viewer also moves in the horizontal direction. The region encompassed with the dotted line of FIG. 7 shows a region, which is observed through the opening 220 by the viewer moving in the horizontal direction. As shown with the region encompassed with the oval of FIG. 7, the viewer may view a part of a right image with one's left eye. Unlike FIG. 49B, since the R sub-pixels displaying the right image, the G sub-pixels displaying the right image, and the B sub-pixels displaying the right image simultaneously appear in the region which is viewed by the viewer, problems about color moire, which happens to conventional technologies, are less likely to occur.

As shown in FIG. 7, even after the viewer moves in the horizontal direction, a region of the left image, which is viewed by the viewer's left eye, is sufficiently wider than a region of the right image, which is viewed by the viewer's left eye. Accordingly, noticeable crosstalk is less likely to occur. On the other hand, under the display pattern of the image described with reference to FIGS. 5 and 6, differences between the region of the left image, which is viewed with the left eye, and the region of the right image, which is viewed with the left eye, is likely to be small when the viewer moves in the horizontal direction, so that noticeable crosstalk is likely to occur.

The opening width of the openings of the slant barrier may be shorter than the horizontal width of the display group, which is set by the display portion 150. For example, the opening width of the openings of the slant barrier may be set to a value which is “1.5 times” as large as the horizontal sub-pixel pitch. When the opening width of the openings of the slant barrier is set to be shorter than the horizontal width of the display group, which is set by the display portion 150, crosstalk is less likely to occur. In this case, since the opening width is set to be wider than the opening 229 described with reference to FIGS. 5 and 6, moire is less likely to occur.

The number of sub-pixels to be used for forming one display group may be defined on the basis of an aspect ratio of the rectangular region FPR. The horizontal ratio of the rectangular region FPR may be represented as a product of the number of parallaxes and the number of sub-pixels in the display group. Accordingly, the horizontal ratio of the rectangular region FPR shown in FIG. 2 is represented with a value of “8”. On the other hand, the horizontal ratio of the rectangular region FPR shown in FIG. 5 is represented with a value of “4”. The vertical sub-pixel pitch is three times as large as the horizontal sub-pixel pitch. Since a length of the rectangular region FPR in the vertical direction shown in FIGS. 2 and 5 is determined on the basis of three sub-pixels aligned in the vertical direction, the vertical ratio of the rectangular region FPR shown in FIGS. 2 and 5 is represented with a value of “9”. Consequently, the aspect ratio of the rectangular region FPR shown in FIG. 2 becomes “9:8” whereas the aspect ratio of the rectangular region FPR shown in FIG. 5 becomes “9:4”. Since the rectangular region FPR shown in FIG. 2 has an aspect ratio that is approximate to a square, problems such as jagged feel at profile in the horizontal direction are less likely to occur.

### (Step Barrier)

A step barrier may be used instead of the aforementioned slant barrier 200 as the separator 160 described with reference to FIG. 1.

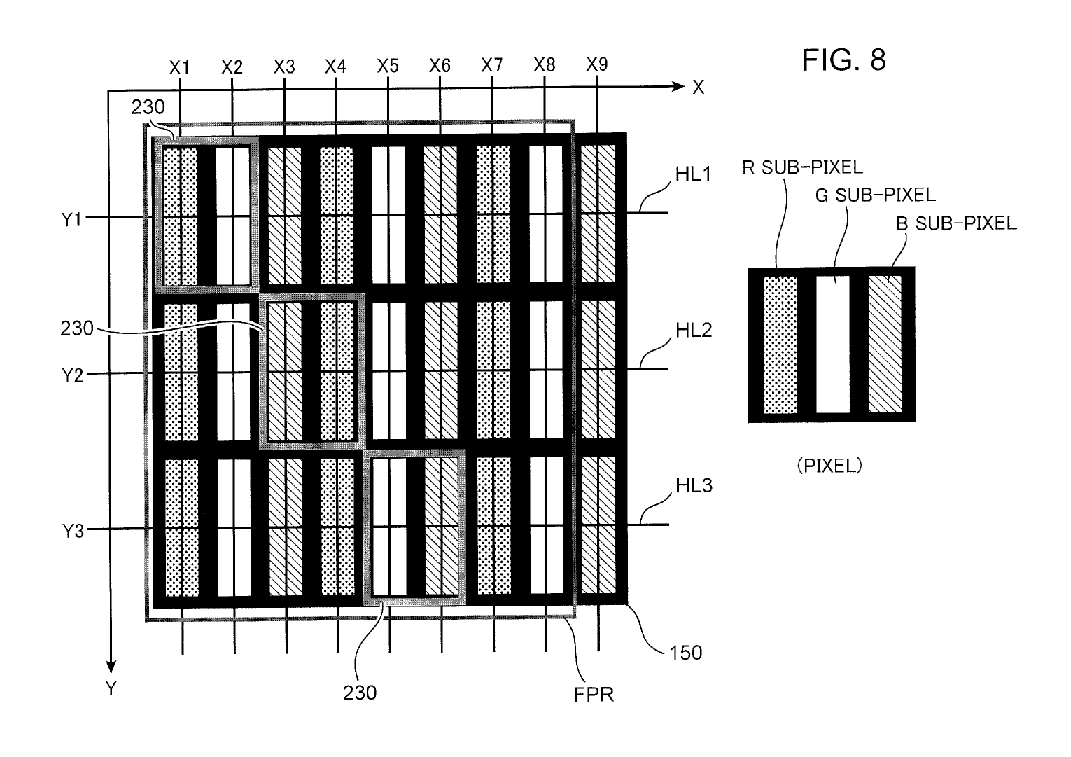

FIG. 8 is a schematic view of the openings 230 of the step barrier, which is superimposed on the display portion 150. The step barrier is described with reference to FIGS. 2 and 8.

The display portion 150 displays an image under the display pattern described with reference to FIG. 2. In comparison between FIGS. 2 and 8, the openings 230 of the step barrier overlap with the display groups LDG1 to LDG3. Accordingly, the sub-pixel (X1, Y1) and the sub-pixel (X2, Y1) become exposed from the opening 230 formed on the horizontal line HL1. The sub-pixel (X3, Y2) and the sub-pixel (X4, Y2) become exposed from the opening 230 formed on the horizontal line HL2. The sub-pixel (X5, Y3) and the sub-pixel (X6, Y3) become exposed from the opening 230 formed on the horizontal line HL3.

The inclination angle of the placement of the opening 230 is “3:2 (3 sp×3 sub-pixels (vertical direction):1 sp×6 sub-pixels (horizontal direction))”. The openings 230 arranged at an inclination angle of “3:2” form an opening region of a staircase pattern.

Like the aforementioned slant barrier 200, the relationship represented by the aforementioned Formula 2 may be also applied to the step barrier with regard to the appropriate viewing distance. Accordingly, the step barrier shown in FIG. 8 may achieve a short appropriate viewing distance.

Like the aforementioned slant barrier 200, the relationship represented by the aforementioned Formula 1 may be applied to the step barrier with regard to the opening width. Accordingly, the step barrier shown in FIG. 8 may cause little moire.

Even when the step barrier is used as the separator 160, the display portion 150 displays images under the display pattern described with reference to FIG. 2. Since the rectangular region FPR is set so that an aspect ratio of the rectangular region FPR is approximate to a square, problems such as an unnatural profile (jagged feel) is less likely to occur.

Like the slant barrier 200, a region recognized as one pixel by the viewer at one viewpoint includes two R sub-pixels, two G sub-pixels and two B sub-pixels (RG+BR+GB). Accordingly, even when a step barrier is used, a color imbalance is less likely to occur.

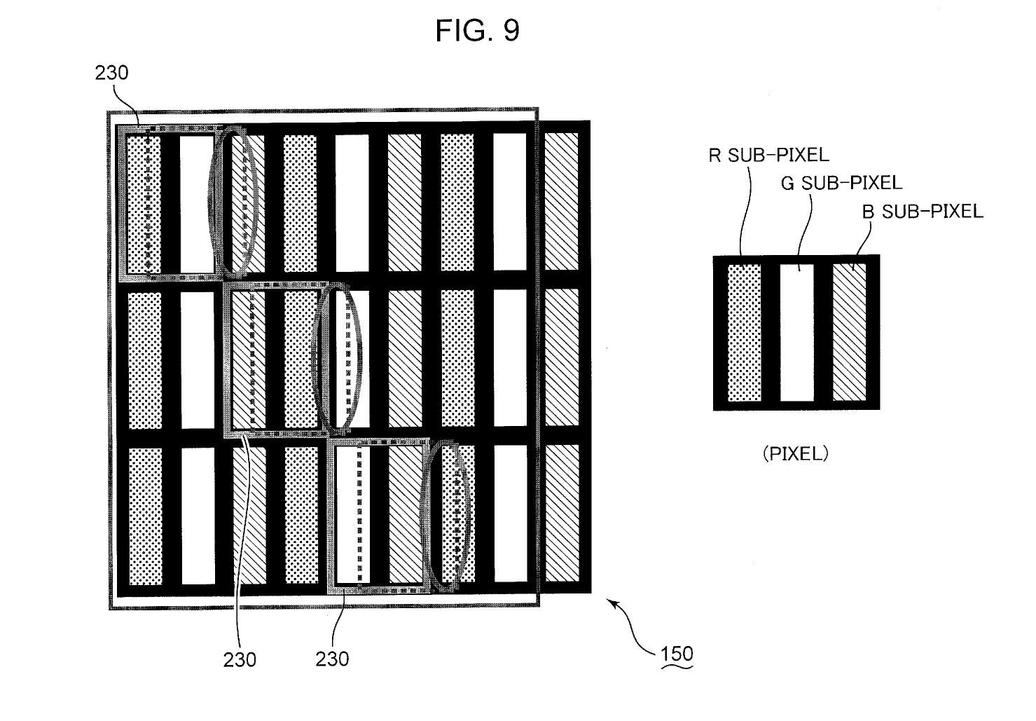

FIG. 9 is a schematic view of the display portion 150. The display portion 150 is described with reference to FIGS. 7 and 9.

Like FIG. 7, FIG. 9 shows a region viewed by a viewer moving in the horizontal direction with dotted rectangular frames. The display regions of a right image viewed by the viewer's left eye are encompassed with an oval.

As shown in FIG. 9, the display regions of the right image viewed by the left eye of the view moving in the horizontal direction include the R, G and B sub-pixels. Accordingly, color moire is likely to occur.

As shown in FIG. 9, even after the viewer moves in the horizontal direction, the region of a left image viewed by the viewer's left eye is significantly wider than the region of a right image viewed by the viewer's left eye. Accordingly, noticeable crosstalk is less likely to occur.

(Slant Barrier with Notch Structure)

A slant barrier having a notch structure may be used as the separator 160 described with reference to FIG. 1.

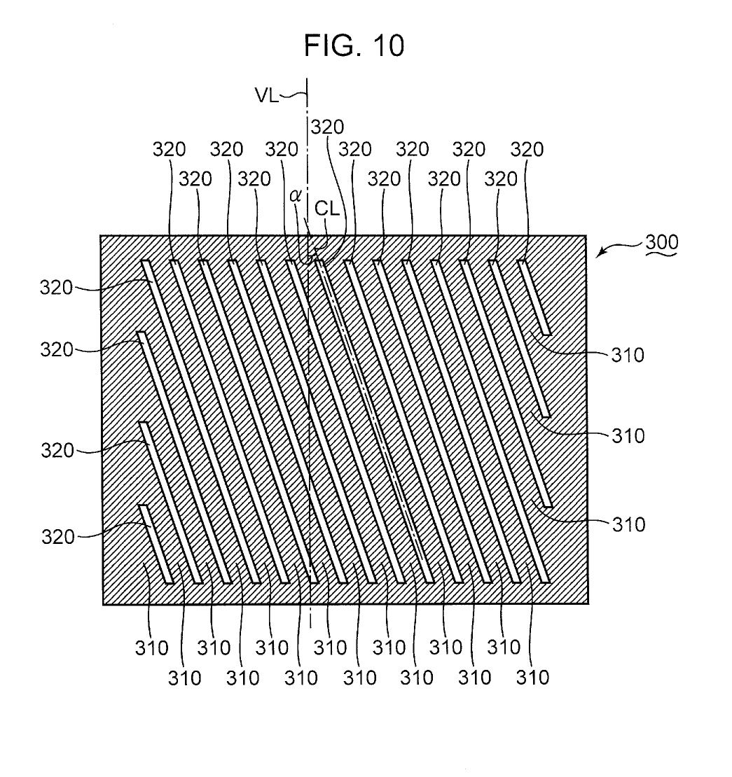

FIG. 10 is a schematic view of the slant barrier 300 having a notch structure. The slant barrier 300 is described with reference to FIGS. 1 and 10.

The slant barrier 300 includes blocking regions 310 for blocking the image light emitted from the display portion 150. An opening 320 is formed between the blocking regions 310 to allow transmission of the image light. FIG. 10 shows the center line CL of the opening 320 and the vertical line VL. The center line CL is inclined from the vertical line VL. In FIG. 10, the inclination angle of the center line CL from the vertical line VL is represented with symbol “a”. In this embodiment, the inclination angle “a” is exemplified as the predetermined angle.

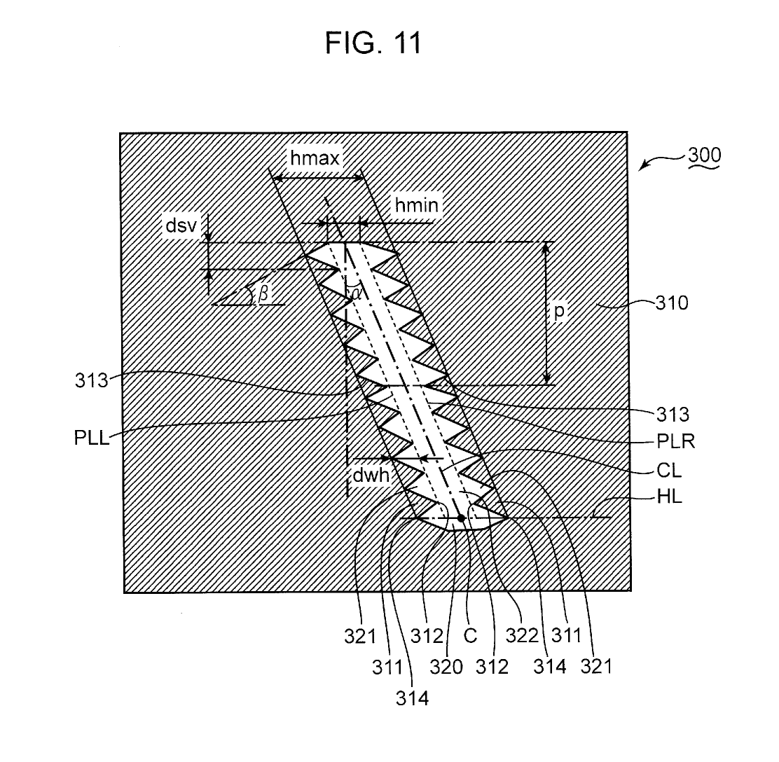

FIG. 11 is an enlarged view of the slant barrier 300 around the opening 320. The slant barrier 300 is described with reference to FIG. 11.

The blocking region 310 includes triangular protrusions 311 which protrude toward the center line CL of the opening 320. The protrusions 311 are aligned along the center line CL. Triangular notch regions 321 are formed between the protrusions 311.

The protrusion 311 includes apexes 312, which are tapered toward the center line CL. FIG. 11 shows a virtual line PLR, which connects the apexes 312 of the protrusions 311 formed on the right of the center line CL, and a virtual line PLL, which connects the apexes 312 of the protrusions 311 formed on the left of the center line CL. The opening 320 includes a rectangular opening region 322 between the virtual lines PLR, PLL in addition to the aforementioned notch region 321.

The opening region 322 has a substantially constant opening width (horizontal direction) along the center line CL. The opening region 322 has the narrowest horizontal width within the opening 320. In the following description, the horizontal direction width of the opening region 322 is referred to as “minimum opening width”. In FIG. 11, the minimum opening width is represented with symbol “hmin”.

The blocking region 310 includes contour portions 313 for defining a contour shape of the opening 320. The contour portions 313 include trough portions 314 for defining sharp apexes of the notch region 321. The trough portion 314 on the left of the center line CL and the trough portion 314 on the right of the center line CL are aligned on the horizontal line HL. In the following description, the distance between the trough portions 314 aligned on the horizontal line HL is referred to as “maximum opening width”. In FIG. 11, the maximum opening width is represented with symbol “hmax”. The notch structure linearly changes a width dimension of the opening 320 between the minimum and maximum opening widths.

FIG. 11 shows the intersection C of the horizontal line HL, which connects the two trough portions 314 to the center line CL. The notch region 321 on the right of the center line CL has a point-symmetrical relationship with the notch region on the left of the center line CL around the intersection C.

The vertical direction distance between the apexes 312 of the two consecutive protrusions 311 along the center line CL is referred to as “vertical period width” in the following description. In FIG. 11, the vertical period width is represented with symbol “dsv”.

In FIG. 11, the inclination angle of the upper boundary of the notch region 321 on the right of the center line CL from the horizontal line is represented with symbol “β”.

In the following description, the horizontal distance between the trough portion 314 and the virtual line PLL (or the virtual line PLR) is referred to as “notch depth”. In FIG. 11, the notch depth is represented with symbol “dwh”. The notch depth may be represented by the following Formula.

$$dwh = 0.5 \times dsv \times ( \frac{1}{tan α} + tan β ) \qquad [ Formula 5 ]$$

In FIG. 11, the dimension represented with symbol “p” represents the vertical direction pitch of the sub-pixels. In this embodiment, since the pixel includes three sub-pixels (R, G and B sub-pixels) and the pixel has an even pixel structure, the vertical direction pitch p of the sub-pixels is represented by the following Formula.

p=2×sp [Formula 6]

The relationship of the number of divisions of the notch structure in the vertical direction pitch p of the sub-pixels (number of protrusions 311 or notch regions 321) and the vertical period width may be represented by the following Formula. It should be noted that the number of divisions of the notch structure is represented with symbol “n” in the following Formula.

$$dsv = \frac{p}{n} \qquad [ Formula 7 ]$$

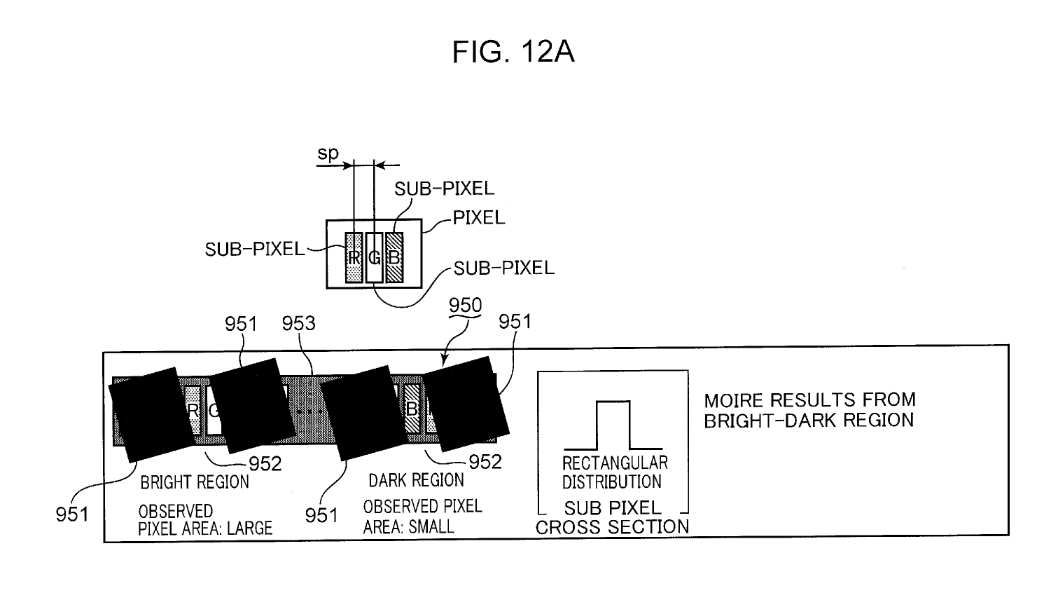

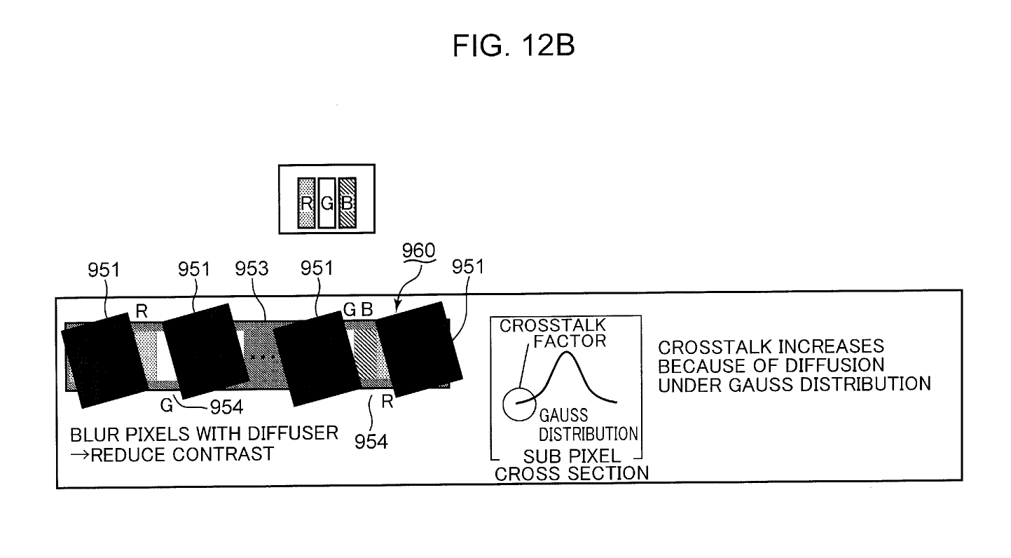

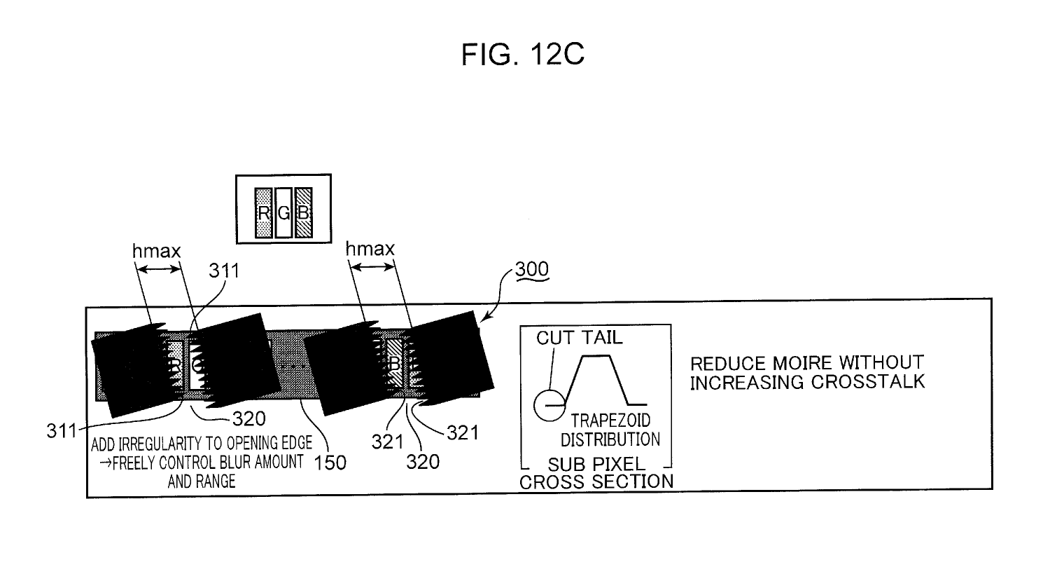

FIGS. 12A to 12C are conceptual views of transmission patterns of image light passing through various slant barriers. Effect of the aforementioned notch structure is described with reference to FIGS. 11 to 12C.

FIG. 12A is a conceptual view of transmission pattern of the image light passing through the general slant barrier 950.

The slant barrier 950 includes blocking portions 951 aligned in the horizontal direction. An opening 952 is formed between the adjacent blocking portions 951.

A display surface 953 formed from pixels is arranged behind the slant barrier 950. The pixel includes three sub-pixels (R sub-pixel emitting red light, G sub-pixels emitting green light, and B sub-pixel emitting blue light).

The barrier pitch is designed so that the image light representing the left image enters the viewer's left eye whereas the image light representing the right image enters the viewer's right eye when the viewer views images projected on the display surface 953 at an appropriate viewing position. In general, the barrier pitch is determined so as to satisfy the following Formula. In the following Formula, the barrier pitch is represented with symbol “bp”. Symbol “N” represents the number of parallaxes.

bp−N×sp [Formula 8]

As represented in the aforementioned Formula, the barrier pitch is designed to be slightly smaller than the parallax multiplication of the horizontal sub-pixel pitch. Accordingly, an area size of the sub-pixels exposed from the opening 952 changes in the horizontal direction. When the area size of the sub-pixels exposed from the opening 952 is large, a bright region is generated. When the area size of the sub-pixels exposed from the opening 952 is small, a dark region is generated. Accordingly, the slant barrier 950 shown in FIG. 12A causes a bright-dark pattern. A viewer may view the bright-dark pattern as moire. A luminance difference between the bright and dark regions may be defined as the moire intensity.

FIG. 12B is a conceptual view of transmission pattern of the image light passing through the slant barrier 960 having a diffusion structure.

Like the slant barrier 950 described with reference to FIG. 12A, the slant barrier 960 includes blocking portions 951. The slant barrier 960 further includes a diffuser 954, which covers openings formed between the blocking portions 951.

A display surface 953 is arranged behind the slant barrier 960. The image light emitted from the display surface 953 passes through the diffuser 954, and then reaches the viewer. The diffuser 954 may be a standard diffuser or a diffusion film configured to diffuse the image light. Since the diffuser 954 diffuses the image light, contrast of the bright-dark pattern caused by the black matrix (not shown) of the display surface 953 or an auxiliary electrode (not shown) is reduced. In addition, since the diffuser 954 reduces a luminance difference between the bright and dark regions described with reference to FIG. 12A, the viewer may view little moire. It should be noted that the black matrix means partitions of emitting pixels in a PDP, and corresponds to rib parts of an LCD. Similar concepts about a notch may be applied to panels, which have a black region in or around the aforementioned pixels, and a PDP is taken as an example in the following description.

The graph shown in FIG. 12B is a schematic light quantity distribution of light passing through the diffuser 954 from the sub-pixels. Since the diffuser 954 diffuses the image light to cause the light quantity distribution as the gauss distribution, the parallax image may be blurred to cause increased crosstalk. Accordingly, the slant barrier 960 is undesirable in terms of image quality.

FIG. 12C is a conceptual view of a transmission pattern of image light passing through the slant barrier 300 described with reference to FIG. 11.

The display portion 150 is arranged behind the slant barrier 300. With respect to the slant barrier 300, the relationship described with reference to FIG. 12A (i.e. the relationship represented in Formula 8) is satisfied between the barrier pitch and the horizontal sub-pixel pitch. Accordingly, an area size of sub-pixels in a region on the display portion 150 corresponding to the region represented with the maximum opening width depends on the horizontal position.

Like the left opening 952, which forms the bright region described with reference to FIG. 12A, two sub-pixels are exposed from the left opening 320 of FIG. 12C. Since the protrusions 311 partially cover the sub-pixels, the brightness is reduced.

Like the right opening 952, which forms the dark region described with reference to FIG. 12A, the B sub-pixels are exposed from the right opening 320 of FIG. 12C. Since the notch region 321 exposes the R and G sub-pixels adjacent to the B sub-pixels, brightness is increased. Accordingly, the slant barrier 300 causes less moire than the slant barrier 950. A blurring level and a blurring range of viewed images are controlled by a design of the notch structure. For example, the notch structure may be designed by cutting the left and right tails of the light quantity distribution shown in FIG. 12A so as to obtain a trapezoidal light quantity distribution.

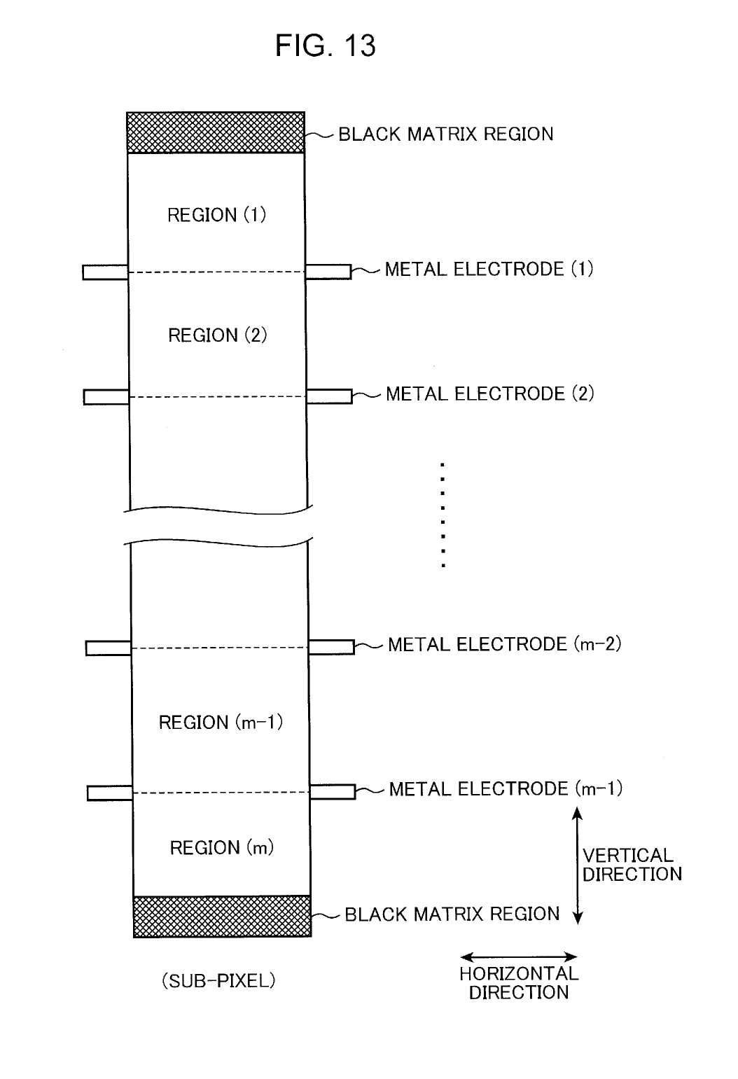

FIG. 13 is a schematic view of sub-pixels. A relationship between the number of divisions of the notch structure and the regional division of sub-pixels is described with reference to FIGS. 1 and 13. It should be noted that a dividing pattern and a method for counting the divided regions shown in FIG. 13 are exemplary, and do not limit the principle of this embodiment in any way.

The display portion 150 includes metal electrodes for applying voltages to the sub-pixels, and two black matrix regions, which are situated above and below the sub-pixels. The metal electrodes shown in FIG. 13 extend in the horizontal direction and traverse the sub-pixels. The metal electrodes are aligned in the vertical direction. FIG. 13 shows (m−1) number of the metal electrodes. The region in the sub-pixels corresponding to the metal electrode is exemplified as the boundary region.

The sub-pixels are divided into m-number of regions by (m−1) number of metal electrodes. The m-number of regions are aligned in the vertical direction.

In order to obtain reduction effect of the aforementioned moire, an optimal value of the vertical period width is dependent on a divided structure of the sub-pixels according to learnings of the present inventors although it is considered that the vertical period width of the notch structure is desirably set to a small value. As shown in FIG. 13, moire may be considerably reduced when the sub-pixels are divided into m-number of regions and the number of divisions of the notch structure is set to a value, which is approximate to the conditions represented in the following Formula. It should be noted that symbol “k” in the following Formula is a natural number greater than 1 (k>1).

n=k×m [Formula 9]

According to learnings of the present inventors, moire may be considerably reduced when the vertical period width is set by using the number of divisions defined by aforementioned Formula 9.

According to other learnings of the present inventors about the vertical period width, moire may be considerably reduced when the vertical period width is set by using parameters, which are defined by the following Formula, even under manufacturing errors in the slant barrier.

$$nnd = \frac{p}{dsv} \qquad [ Formula 10 ]$$

In the aforementioned Formula, moire may be considerably reduced even under manufacturing errors in the slant barrier when the vertical period width is set so that the parameter represented with symbol “nnd” becomes a median value or is set to a value approximate to the median value between consecutive integer values.

The width of the opening of the slant barrier relative to the horizontal sub-pixel pitch (aperture ratio) is used as a reference of crosstalk. Since the width of the opening 320 of the slant barrier 300 changes as shown in FIG. 11, the ratio of the width of the opening 320 of the slant barrier 300 relative to the horizontal sub-pixel pitch may be defined as “average aperture ratio” by using the average width of the opening 320.

Since the slant barrier 300 has a very fine notch structure, characteristics about crosstalk of the slant barrier 300 become substantially equivalent to those of a general slant barrier (slant barrier without a notch structure) having an aperture ratio, which is equal to an average aperture ratio of the slant barrier 300.

The area size of the pixels viewed through the opening 320 may be averaged with little growth in crosstalk by an average aperture ratio set appropriately with taking account of crosstalk and a notch structure designed appropriately with taking account of a blurring level.

As shown in FIG. 11, the protrusions 311 and the notch regions 321 are triangular. Alternatively, elements for forming the notch structure may be trapezoidal or parallelogram. Further alternatively, a profile of these elements may be curved (e.g. an elliptic arc).

In this embodiment, the notch structure is described with reference to the slant barrier 300. Alternatively, the notch structure may be applied to a vertical stripe barrier or a step barrier.

As shown in FIG. 11, the protrusions 311 protrude horizontally toward the center line CL. Alternatively, the protruding direction of the protrusions may be perpendicular to the center line CL.

The sum total of the opening areas of the notch regions 321 in one sub-pixel pitch in the vertical direction may be represented by the following Formula. It should be noted that symbol “dSnt” in the following Formula represents the sum total of the opening areas of the notch regions 321 in one sub-pixel pitch in the vertical direction.

dSnt=dwh×p [Formula 11]

The opening area of the opening region 322 in one sub-pixel pitch in the vertical direction may be represented by the following Formula. It should be noted that symbol “dSot” in the following Formula represents the opening area of the opening region 322 in one sub-pixel pitch in the vertical direction.

dSot=h min×p [Formula 12]

The opening area of the opening 320 in one sub-pixel pitch in the vertical direction may be represented by the following Formula. It should be noted that symbol “S” in the following Formula represents the opening area of the opening 320 in one sub-pixel pitch in the vertical direction.

S=dSnt+dSot [Formula 13]

It is figured out from the aforementioned Formulas 11 to 13 that the area size of the opening 320 in one sub-pixel pitch in the vertical direction does not change even when the number of divisions in one sub-pixel pitch in the vertical direction increases.

The maximum opening width is set appropriately with taking account of crosstalk. Unless the maximum opening width is set to an excessively large value, there is little crosstalk. For example, when one parallax image is formed from two sub-pixels like this embodiment, a crosstalk reduction may be satisfied by causing the maximum opening width hmax to be within LMax=sp×dmax (dmax≦2) relative to the sub-pixel size sp while maintaining the average aperture ratio of the pixel size to be a predetermined value. In this case, the minimum opening width may be set to be a horizontal sub-pixel pitch or less in order to set the appropriate average aperture ratio in consideration of crosstalk. When the minimum opening width becomes “0.5 times” or less as large as the horizontal sub-pixel pitch, adverse effects such as a striped pattern formed on the image may occur because of a steep change in the opening width. Or, observed images may be likely to be susceptible to a change in viewing position of the viewer in the horizontal and/or vertical direction. Accordingly, the minimum opening width may be set to a value that is “0.7 times” or more as large as the horizontal sub-pixel pitch.

The horizontal sub-pixel pitch is used as various references about the parallax image. As described above, when the average aperture ratio, the maximum opening width and the minimum opening width are set appropriately with reference to the sub-pixel pitch, a moire pattern may be weakened with little growth in crosstalk.

It should be noted that this embodiment described a case of configuring one parallax image with two sub-pixels. Nonetheless, it may be preferable that the number of sub-pixels to configure one parallax image is set so that the ratio of the horizontal and vertical directions in the rectangular region FPR shown in FIG. 2 becomes approximately equal although one parallax image may be configured with sub-pixels in a natural number kk greater than 1.0. In this case, if the kk is an integer, the respective parallax images may be subject to pixel placement in sub-pixel units in the rectangular region. On the other hand, unless the kk is an integer, upon arranging the respective parallax images in the rectangular region, the sub-pixel value corresponding to the respective parallax images is represented, for example, on the basis of synthesis of the sub-pixels in the rectangular region. In other words, unless kk is an integer, there may be an element positioned at a boundary between the first height group and the first adjacent group. In such a case, the first adjacent element may be replaced with the first boundary element. A pixel value of the left image may be assigned as a pixel value of the first boundary element. A pixel value of the right image may be assigned as a pixel value of the first boundary element. A pixel value generated from the pixel values of the right and left images may be assigned as a pixel value of the first boundary element. A pixel value (e.g. pixel value 0: black) different from the pixel values of the right and left images image may be assigned as a pixel value of the first boundary element. Likewise, the second adjacent element may be replaced with the second boundary element if an element is positioned at a boundary between the second height group and the second adjacent group. A pixel value of the left image may be assigned as a pixel value of the second boundary element. A pixel value of the right image may be assigned as a pixel value of the second boundary element. A pixel value generated from the pixel values of the right and left images may be assigned as a pixel value of the second boundary element. A pixel value (e.g. pixel value 0: black) different from pixel values of the right and left images may be assigned as a pixel value of the second boundary element.

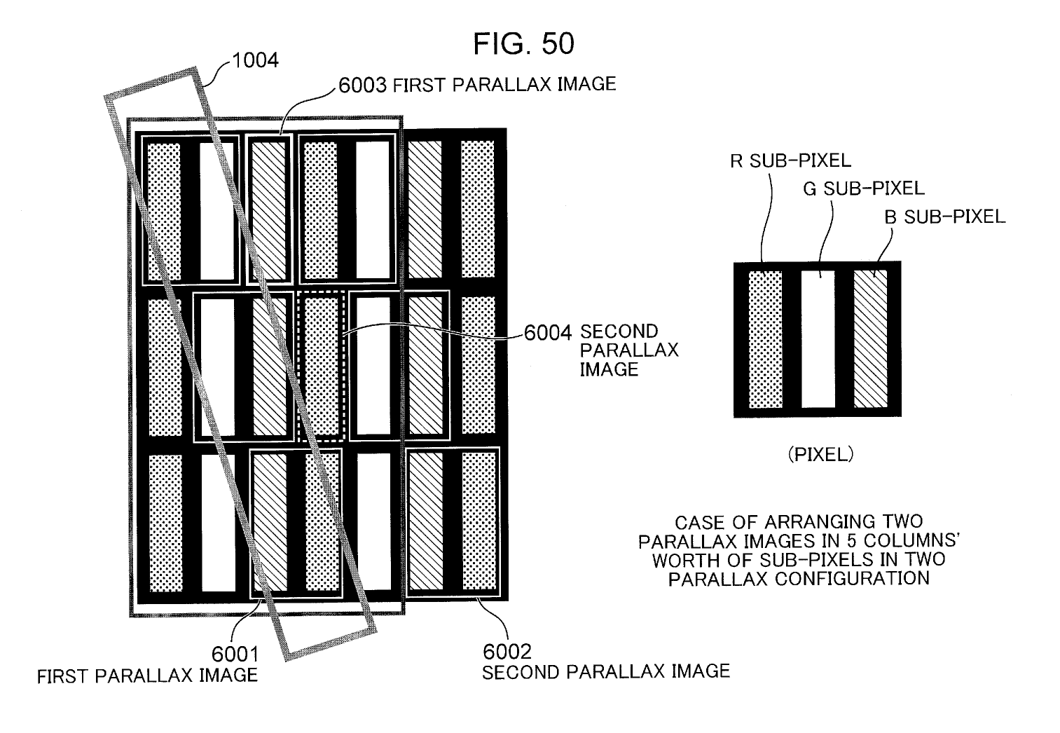

In this case, crosstalk caused by the image separator such as a parallax barrier is inhibited, as described in this invention. On the other hand, crosstalk may be likely to happen as a result of representing the sub-pixel value corresponding to the respective parallax images on the basis of synthesis of the sub-pixels in the rectangular region. Therefore, pixel placement has to be performed so as to inhibit resultant crosstalk from the image placement itself. FIG. 50 shows a case of arranging five sub-pixel columns relative to two parallax images. Reference numeral “6001” represents the first parallax image column, reference numeral “6002” represents the second parallax image column, reference numeral “6003” represents those corresponding to the sub-pixels of the first parallax image between the two, and reference numeral “6004” represents those corresponding to the sub-pixels of the second parallax image between the two. It should be noted that reference numeral “6003” and reference numeral “6004” are disposed so that the number of sub-pixels is equal in the first and second parallax images.

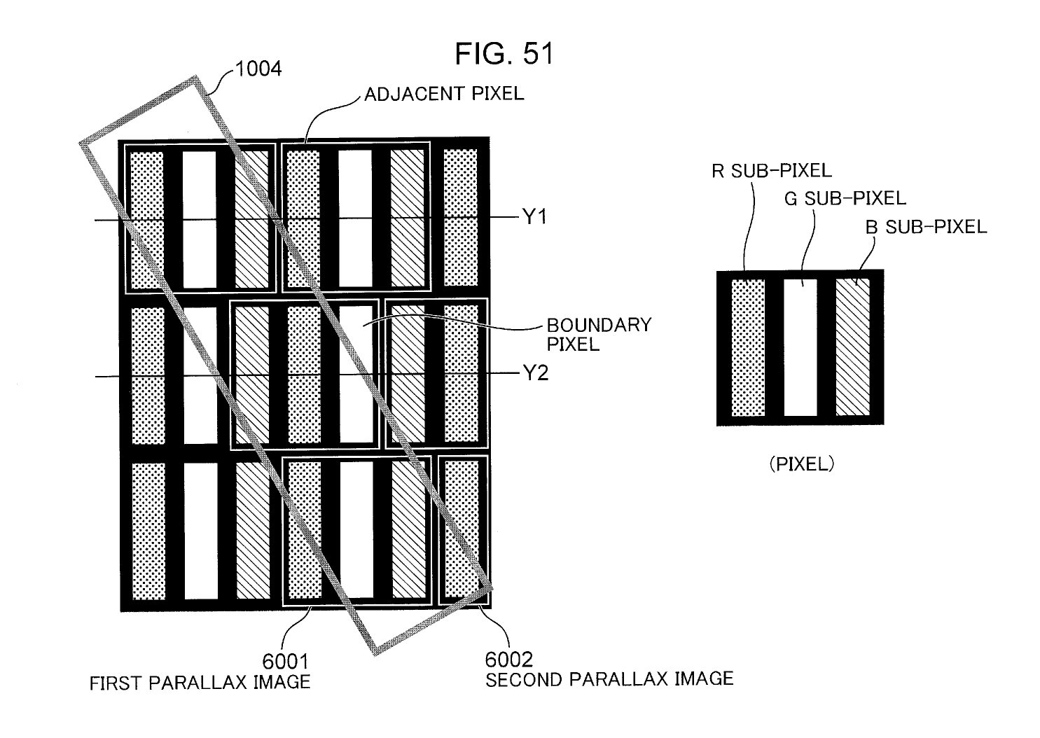

If kk is an integer, as shown in FIG. 51, the adjacent pixels may not be aligned on one straight line. In this case, for example, even when an adjacent pixel exists on the coordinate value “Y1”, a boundary pixel may exist on the coordinate value “Y2”. In this case, both may be set as adjacent pixels or both may be set as boundary pixels.

### Second Embodiment

### Display Device

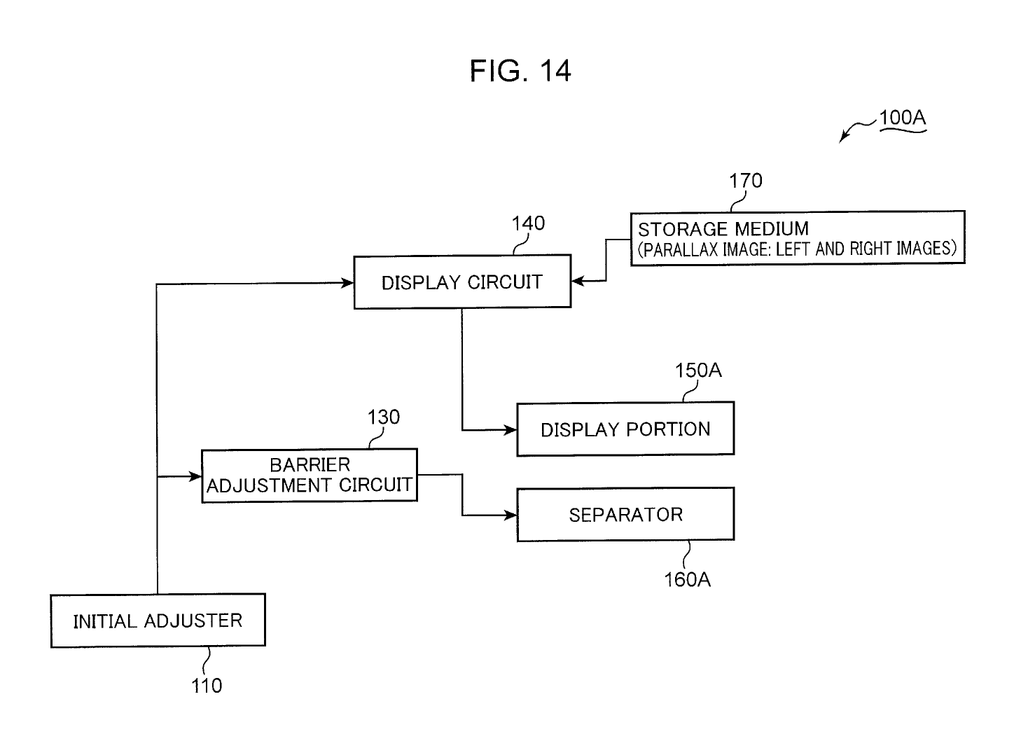

FIG. 14 is a schematic block diagram of the display device 100A according to the second embodiment. The display device 100A is described with reference to FIG. 14. It should be noted that the same reference numerals are assigned to elements which are common with the first embodiment. The description in the first embodiment is applied to the elements to which the same reference numerals are assigned.

Like the first embodiment, the display device 100A includes the initial adjuster 110, the barrier adjustment circuit 130, the display circuit 140 and the storage medium 170. The display device 100A further includes a display portion 150A and a separator 160A. The display portion 150A displays images under a display pattern which is different from the first embodiment. The separator 160A is formed to be suitable for the display pattern created by the display portion 150A.

### (Display Pattern)

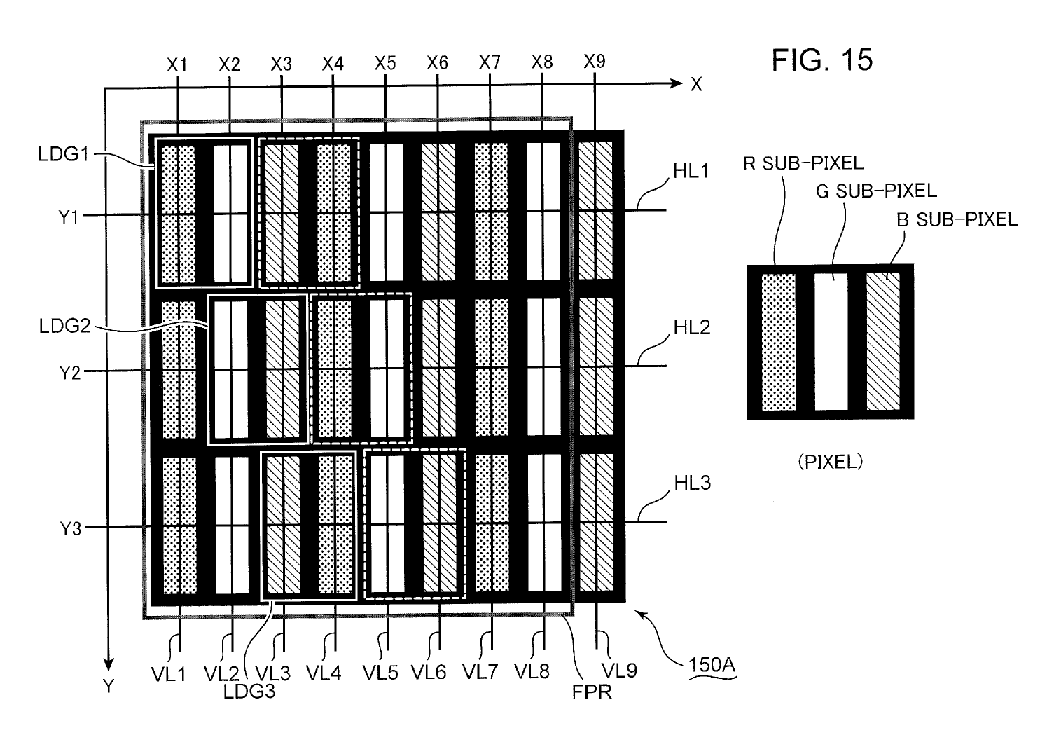

FIG. 15 is a schematic view of the display portion 150A. The display portion 150A is described with reference to FIG. 15.

In this embodiment, the number of parallaxes is set to “4”. In other words, when one of the four viewpoints coincides with the left eye and another of the four viewpoints coincides with the right eye, the viewer may stereoscopically perceive images displayed by the display portion 150A. FIG. 15 shows a rectangular region FPR, which is recognized as one pixel by the viewer in the four viewpoints. An aspect ratio of the rectangular region FPR is “9:8”.

The display portion 150A sets one display group LDG1 by using a sub-pixel (X1, Y1) and a sub-pixel (X2, Y1) adjacent to the sub-pixel (X1, Y1) in the horizontal direction. The display portion 150A sets one display group LDG2 by using a sub-pixel (X2, Y2) and a sub-pixel (X3, Y2) adjacent to the sub-pixel (X2, Y2) in the horizontal direction. The display portion 150A sets one display group LDG3 by using a sub-pixel (X3, Y3) and a sub-pixel (X4, Y3) adjacent to the sub-pixel (X3, Y3) in the horizontal direction. The display portion 150A defines the display groups LDG1 to LDG3 among the sub-pixels arranged in the rectangular region FPR as a group for displaying a left image. A viewer recognizes the display groups LDG1 to LDG3 as one pixel at one viewpoint.

The display portion 150A sets one display group RDG1 by using a sub-pixel (X3, Y1) and a sub-pixel (X4, Y1) adjacent to the sub-pixel (X3, Y1) in the horizontal direction. The display portion 150A sets one display group RDG2 by using a sub-pixel (X4, Y2) and a sub-pixel (X5, Y2) adjacent to the sub-pixel (X4, Y2) in the horizontal direction. The display portion 150A sets one display group RDG3 by using a sub-pixel (X5, Y3) and a sub-pixel (X6, Y3) adjacent to the sub-pixel (X5, Y3) in the horizontal direction. The display portion 150A defines the display groups RDG1 to RDG3 among the sub-pixels arranged in the rectangular region FPR as a group for displaying a right image. The viewer recognizes the display groups RDG1 to RDG3 as one pixel at another viewpoint.

In the display group RDG1, the sub-pixel (X3, Y1) adjacent to the display group LDG1 is a B sub-pixel configured to emit blue light. In this embodiment, the sub-pixel (X3, Y1) may be exemplified as the first adjacent element.

In the display group RDG2, the sub-pixel (X4, Y2) adjacent to the display group LDG2 is an R sub-pixel configured to emit red light. In this embodiment, the sub-pixel (X4, Y2) may be exemplified as the second adjacent element.

In the display group RDG3, the sub-pixel (X5, Y3) adjacent to the display group LDG3 is a G sub-pixel configured to emit green light. In this embodiment, the sub-pixel (X5, Y3) may be exemplified as the second adjacent element.

In this embodiment, the display groups LDG1 to LDG3 used for displaying a left image and the display groups RDG1 to RDG3 used for displaying a right image form a group column, which is inclined at a predetermined angle from a vertical line. The inclination angle of the group column formed by the display groups LDG1 to LDG3, RDG1 to RDG3 is “18.435°” (3:1). It should be noted that the inclination angle of the group column formed by the display groups LDG1 to LDG3, RDG1 to RDG3 described in the context of the first embodiment is “33.69°”(3:2). The display pattern of this embodiment is different from the display pattern of the first embodiment in this aspect.

It is known that moire becomes pale or disappear when the inclination angle of the opening of the slant barrier is 20° to 30°. Since the aspect ratio of the sub-pixels is generally “3:1”, if the inclination angle of the group column exceeds “18.435°”, there is a large visible area of the adjacent pixel, so that crosstalk is likely to occur. For example, an adjacent sub-pixel for displaying a right image may appear in the region viewed with the left eye, or an adjacent sub-pixel for displaying a left image may appear in the region viewed with the right eye.

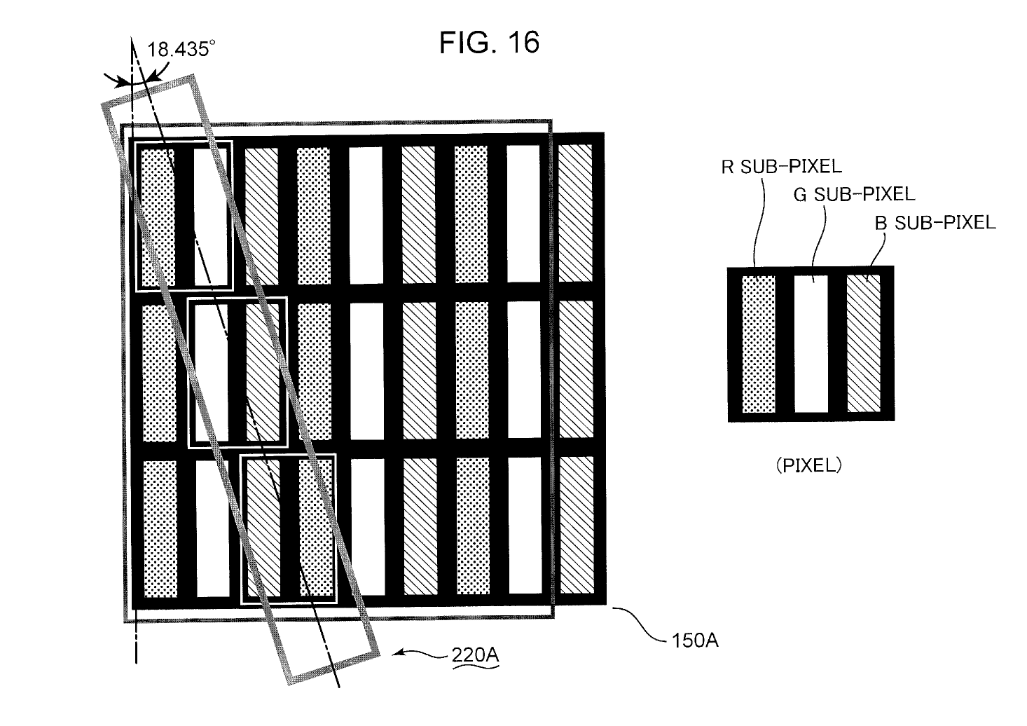

FIG. 16 is a schematic view of an opening 220A of a slant barrier superimposed on the display portion 150A. Advantageous effects of the display device 100A are described with reference to FIGS. 14 to 16.

As described above, the group column formed with the display groups LDG1 to LDG3, RDG1 to RDG3 of this embodiment is inclined at the angle of “18.435°”. Accordingly, the opening 220A of the slant barrier used as the separator 160A is also inclined at the angle of “18.435°”. Accordingly, there is little crosstalk.

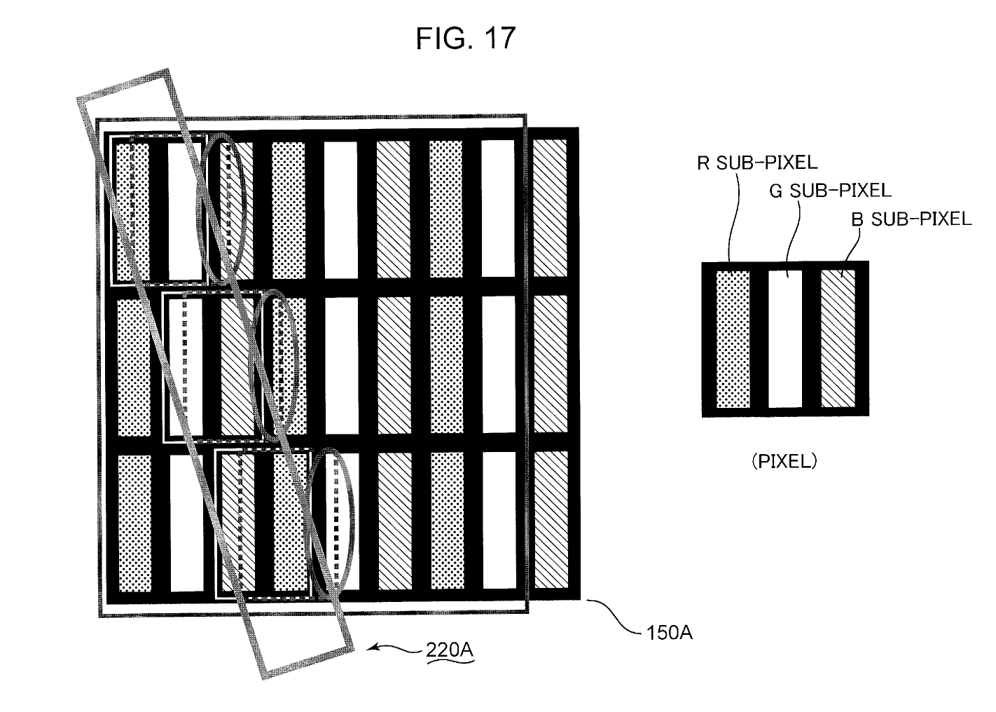

FIG. 17 is a schematic view of the opening 220A of the slant barrier superimposed on the display portion 150A. Advantageous effects of the display device 100A are described with reference to FIGS. 14 to 17.

In FIG. 17, a region viewed by a viewer moving in the horizontal direction is shown with the dotted rectangular frames. The display regions of the right image viewed by the viewer's left eye are encompassed by the oval.

As shown in FIG. 17, the display regions of the right image viewed by the left eye of the viewer moving in the horizontal direction include the R, G and B sub-pixels. Accordingly, color moire is less likely to occur.

As shown in FIG. 17, even after the viewer moves in the horizontal direction, the region of the left image viewed by the viewer's left eye is sufficiently wider than the region of the right image viewed by the viewer's left eye. Accordingly, there is little noticeable crosstalk.

(Slant Barrier with Notch Structure)

In this embodiment, a slant barrier having a notch structure designed on the basis of the method described in the context of the first embodiment may be used as the separator 160A described with reference to FIG. 14.

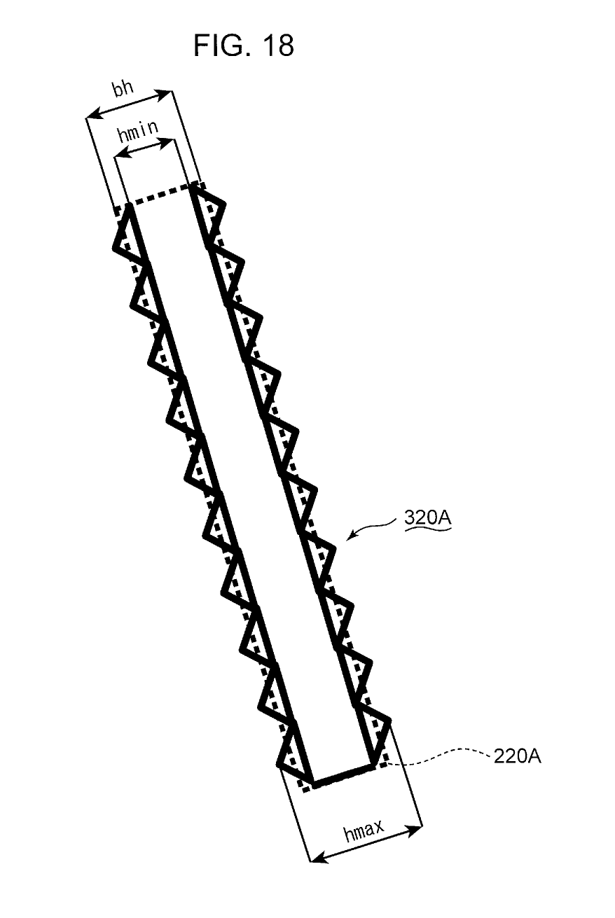

FIG. 18 is a schematic view of an opening 320A of a slant barrier to which a notch structure is applied. The opening 320A is described with reference to FIGS. 14, 16 and 18.

In FIG. 18, the opening 220A described with reference to FIG. 16 is represented with the dotted line. The average aperture ratio of the opening 320A is set to be equal to the aperture ratio of the opening 220A. Thus, the minimum opening width (indicated with symbol “hmin” in FIG. 18) of the opening 320A is smaller than the opening width (indicated with symbol “bh” in FIG. 8) of the opening 220A.

In this embodiment, the opening width of the opening 220A is set to a value, which is twice as large as the horizontal sub-pixel pitch. On the other hand, the minimum opening width of the opening 320A is set to a value, which is smaller than a value that is twice as large as the horizontal sub-pixel pitch. For example, the minimum opening width of the opening 320A may be set to a value, which is “1.2 times” to “1.6 times” as large as the horizontal sub-pixel pitch. Accordingly, when a slant barrier having a notch structure is used as the separator 160A, moire may be reduced with causing little crosstalk.

The maximum opening width (indicated with symbol “hmax” in FIG. 18) is set appropriately with taking account of the crosstalk. Unless a maximum opening is set to be excessively large, crosstalk is less likely to occur. The minimum opening width may be set to be no more than the horizontal sub-pixel pitch in order to set an appropriate average aperture ratio with taking account of crosstalk. When the minimum opening width becomes “0.5 times” or less as large as the horizontal sub-pixel pitch, adverse effects such as a striped pattern formed on an image may occur because of a steep change in the opening width. Or, observed images may be likely to be susceptible to horizontal and/or vertical changes in the viewing position of the viewer. Accordingly, the minimum opening width may be set to a value, which is “0.7 times” or more as large as the horizontal sub-pixel pitch.

The horizontal sub-pixel pitch is used as various references about parallax images. As described above, when the average aperture ratio, the maximum and minimum opening widths are set appropriately with reference to the sub-pixel pitch, a moire pattern may be reduced with little crosstalk growth.

(Slant Barrier with Opening of Small Opening Width)

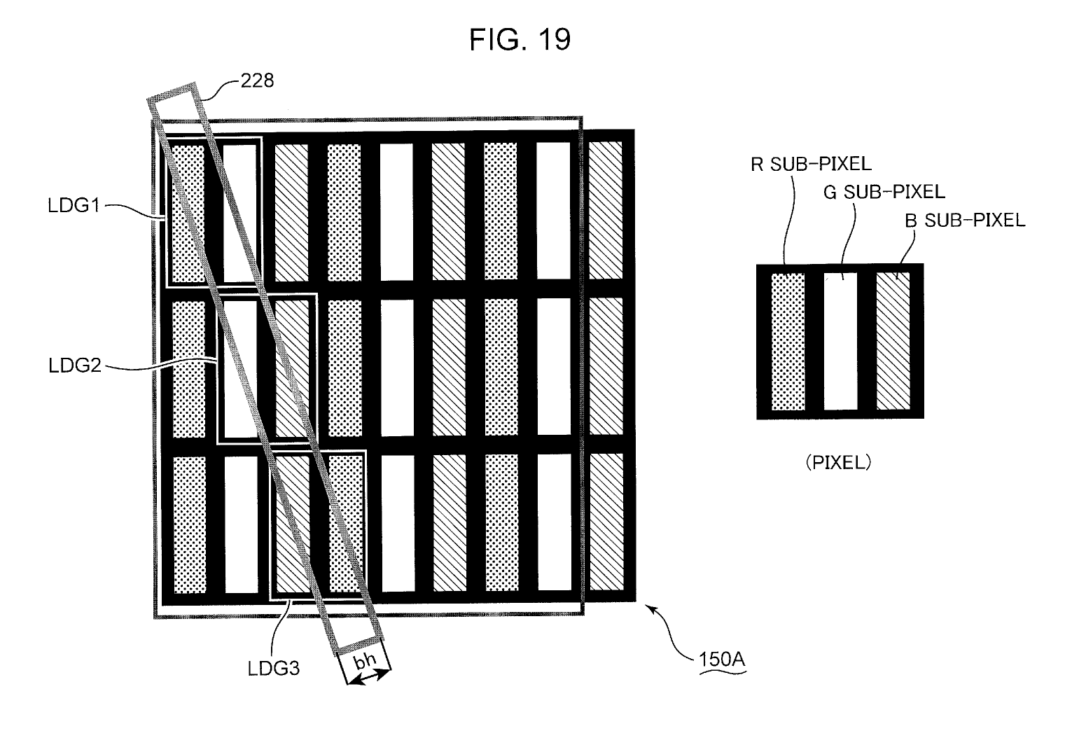

FIG. 19 is a schematic view of the display portion 150A. Effects of the slant barrier having an opening with a small opening width are described with reference to FIGS. 16 and 19.

An opening 228 is drawn on the display portion 150A of FIG. 19. The opening 228 has an opening width (indicated with symbol “bh” in FIG. 19) which is smaller than the opening 220A described with reference to FIG. 16. For example, the opening width of the opening 228 is set to a value, which is “1 time” to “1.4 times” as large as the horizontal sub-pixel pitch.

The opening 228 is overlapped with the display groups LDG1 to LDG3. As described above, since the opening width of the opening 228 is set to be narrow, a viewer is less likely to view sub-pixels, which are included in a display group other than the display groups LDG1 to LDG3, through the opening 228. Accordingly, a slant barrier designed to have a narrow opening width is less likely to cause crosstalk.

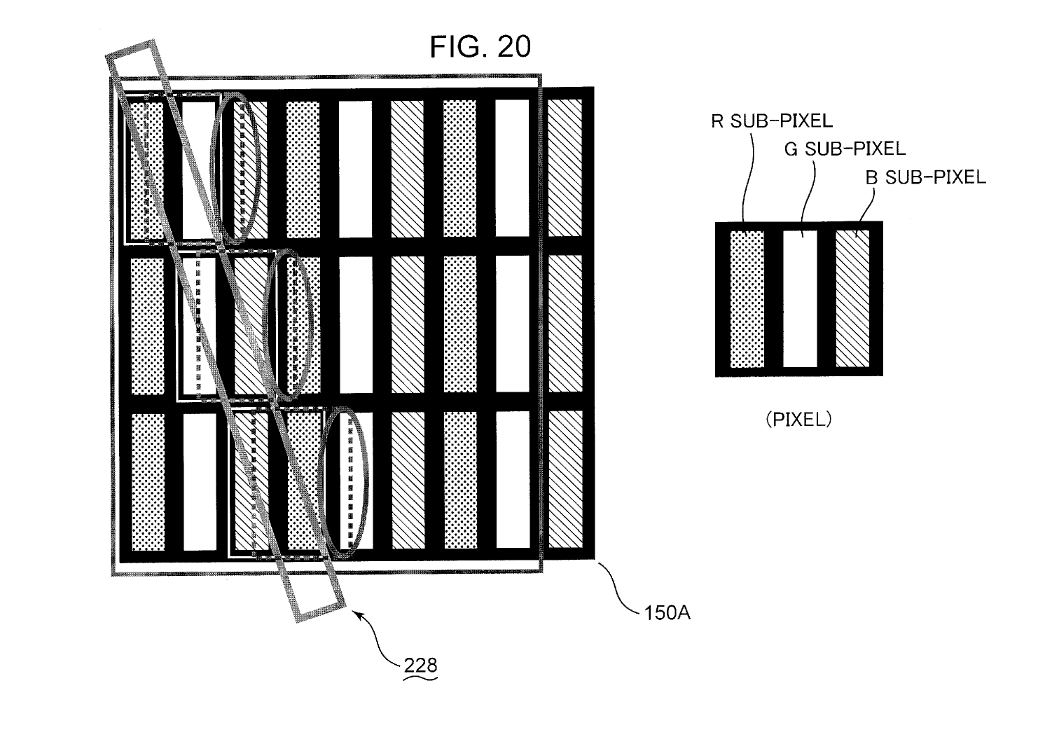

FIG. 20 is a schematic view of the opening 228 of the slant barrier superimposed on the display portion 150A. Effects of the slant barrier having an opening with a small opening width are further described with reference to FIGS. 19 and 20.

In FIG. 20, a region viewed by the viewer moving in the horizontal direction is shown with the dotted rectangular frames. The display regions of a right image viewed by the viewer's left eye are encompassed by the oval.

As shown in FIG. 20, the display regions of a right image viewed by the left eye of the viewer moving in the horizontal direction include the R, G and B sub-pixels. Accordingly, color moire is less likely to occur.

As shown in FIG. 20, even after the horizontal movement of the viewer, the region for a left image viewed by the viewer's left eye is sufficiently wider than the region for the right image viewed by the viewer's left eye. Accordingly, there is little noticeable crosstalk.

As described above, a slant barrier having a narrow opening width has various advantages whereas moire may not be sufficiently reduced because of the narrow opening width.

### (Effect of Notch Structure)

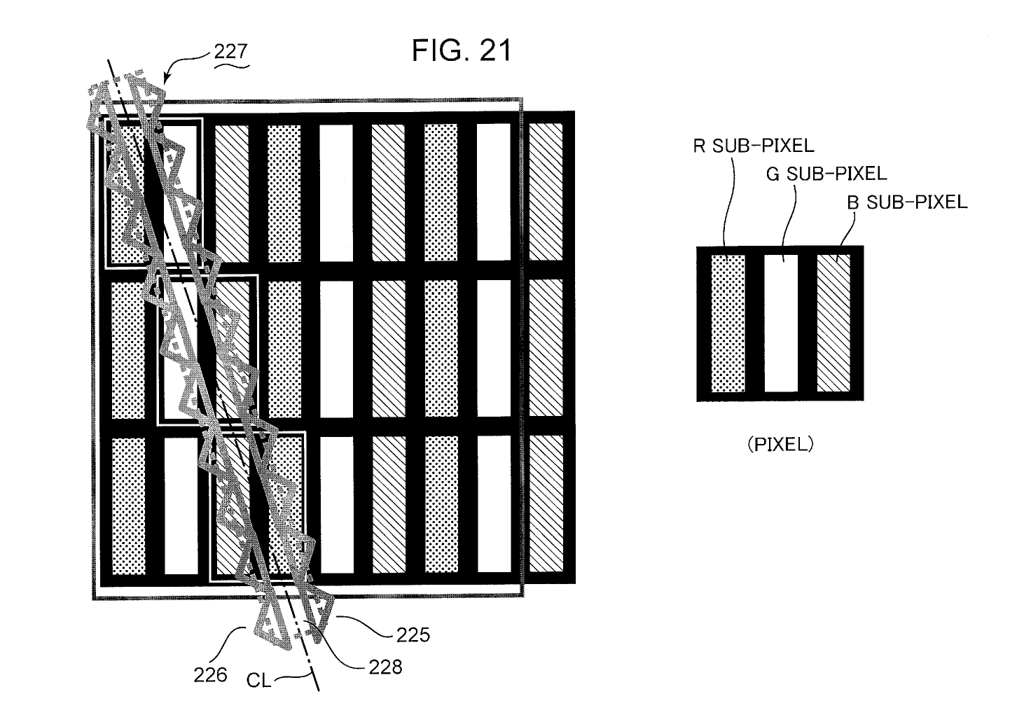

FIG. 21 is a schematic view of the opening 227 obtained by adding a notch structure to the opening 228. Effects of a notch structure are described with reference to FIGS. 18, 19 and 21.

FIG. 21 shows the center line CL of the opening 228. A left notch structure 226 is formed on the left of the center line CL. A right notch structure 225 is formed on the right of the center line CL. The left and right notch structures 226, 225 are formed on the basis of the design method described in the context of the first embodiment.

In comparison between FIGS. 18 and 21, the opening 227 shown in FIG. 21 is geometrically the same as or similar to the opening 320A described with reference to FIG. 18. Accordingly, the shape of the opening 227 may sufficiently reduce moire as described with reference to FIG. 18.

The maximum opening width is set appropriately with taking account of crosstalk. Unless a maximum opening width is set to be excessively large, crosstalk is less likely to occur. The minimum opening width may be set to be no more than the horizontal sub-pixel pitch in order to set an appropriate average aperture ratio with taking account of crosstalk. If the minimum opening width becomes “0.5 times” or less as large as the horizontal sub-pixel pitch, adverse effects such as a striped pattern formed on the image may occur because of a steep change in the opening width. Or, observed images may be likely to be susceptible to horizontal and/or vertical changes in a viewing position of the viewer. Accordingly, the minimum opening width may be set to a value, which is “0.7 times” or more as large as the horizontal sub-pixel pitch.

The horizontal sub-pixel pitch is used as various references about the parallax image. As described above, when the average aperture ratio, the maximum and minimum opening widths are set appropriately with reference to the sub-pixel pitch, a moire pattern may be reduced with causing little crosstalk growth.

### (Asymmetrical Notch Structure)

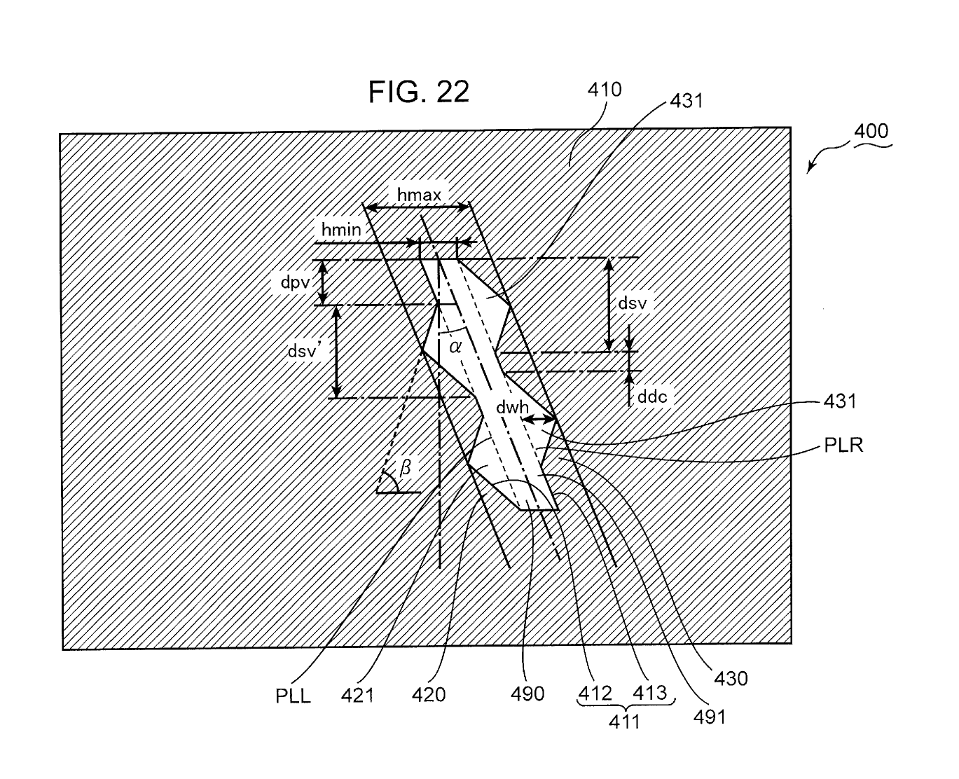

FIG. 22 is an enlarged view of a slant barrier 400 having an asymmetrical notch structure. The slant barrier 400 is described with reference to FIGS. 11, 14 and 22.

The slant barrier 400 includes a blocking region 410 for blocking image light emitted from the display portion 150A. The blocking region 410 includes a contour portion 411 which defines the profile shape of the opening 490. The contour portion 411 includes a left contour portion 412 which forms a left notch structure 420, and a right contour portion 413 which forms a right notch structure 430.

The left notch structure 420 forms a triangular left notch region 421. The right notch structure 430 forms a triangular right notch region 431. In addition to the left and right notch regions 421, 431, the opening 490 includes a rectangular opening region 491 formed between the left and right notch regions 421, 431. The boundary between the left notch region 421 and the opening region 491 is indicated by the virtual line PLL. The boundary between the right notch region 431 and the opening region 491 is indicated by the virtual line PLR.

A distance between the upper corner of the right notch region 431 and the lower corner of the right notch region 431 corresponds to the vertical period width described with reference to FIG. 11. Therefore, in FIG. 22, the distance between the upper and lower corners of the right notch region 431 is represented by symbol “dsv” like FIG. 11.

The vertical period width of the left notch structure 420 is set to a value different from the vertical period width of the right notch structure 430. The vertical period width of the left notch structure 420 may be represented by the following Formula. It should be noted that the vertical period width of the left notch structure 420 is represented by symbol “dsv′” in the following Formula and FIG. 22. In the following Formula, symbol “kdsR” is a change parameter associated with the vertical period width of the left notch structure 420. The change parameter “kdsR” may be set appropriately on the basis of data about an estimated moire pattern.

dsv=dsv×(1+kdsR) [Formula 14]

The upper corner of the upper right notch region 431 coincides with the upper end of the opening region 491 whereas the upper corner of the upper left notch region 421 is shifted downward from the upper end of the opening region 491. In the following description, the shift amount of the upper corner of the left notch region 421 from the upper end of the opening region 491 in the vertical direction is referred to as “phase shift”. In FIG. 22, the phase shift is represented by symbol “dpv”.

The lower corner of the upper right notch region 431 is distant from the upper corner of the lower right notch region 431. In the following description, a vertical distance between the lower corner of the upper right notch region 431 and the upper corner of the lower right notch region 431 is referred to as “notch structure gap”. In FIG. 22, the notch structure gap is represented by symbol “dds”. It should be noted that the notch structure gap may be equivalent between the left and right notch structures 420, 430.

Design factors (maximum opening width, minimum opening width, inclination angle of opening, inclination angle of profile of notch region) described with reference to FIG. 11 are represented by using the same symbols in FIG. 22. The notch structure may be designed appropriately by using the aforementioned various design factors.

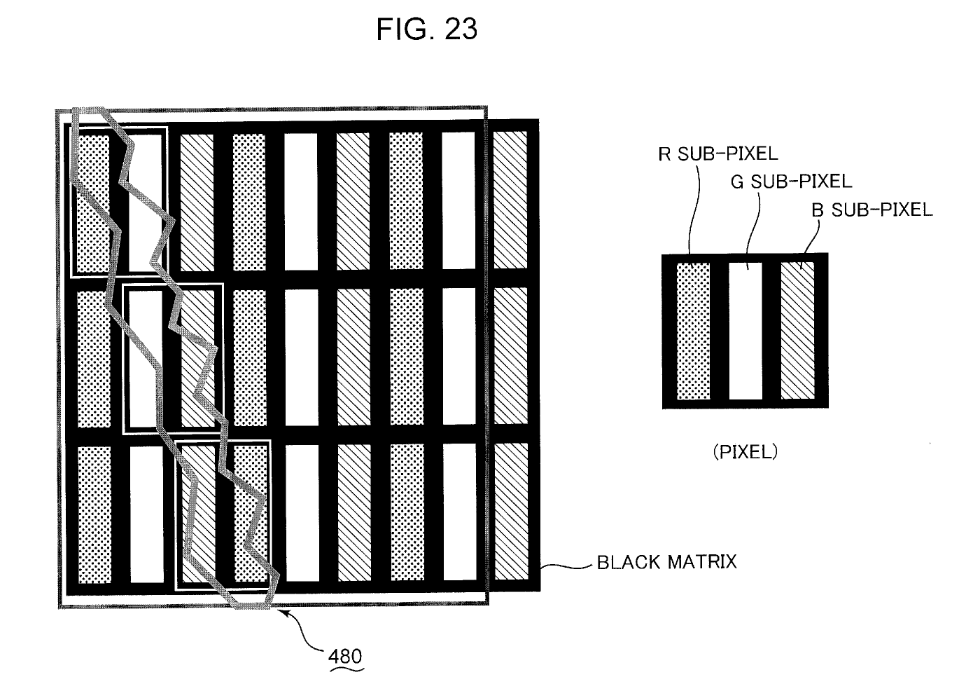

FIG. 23 is a schematic view of an exemplary opening 480 which is formed on the basis of the design method of the notch structure described with reference to FIG. 22. Effects of the notch structure are described with reference to FIG. 23.

According to the design method of the notch structure described with reference to FIG. 22, the opening 480 is formed in various shapes. Accordingly, a large opening width may be set in a dark region (e.g. region around the black matrix). A small opening width may be set in a bright region (region of the sub-pixels).

Values of the various design factors described with reference to FIG. 22 may be determined with taking account of manufacturing errors of a slant barrier. In particular, the minimum opening width is likely to be susceptible to manufacturing errors. Accordingly, a value of the minimum opening width may be determined with taking account of the manufacturing errors. Subsequently, a moire pattern may be estimated on the basis of the determined minimum opening width. A region to be hidden by the blocking region may be determined on the basis of the estimated moire pattern.

As shown in FIG. 22, the left and right notch regions 421, 431 are triangular. Alternatively, elements forming the notch structure may be trapezoidal or parallelogram. Further alternatively, the profile of these elements may be curved (e.g. an elliptic arc).

The notch region may be tapered in the horizontal direction or tapered in a direction perpendicular to the center line of the opening.

A notch depth of the left notch region may be set to a value different from the notch depth of a right notch region. If the sum of the notch depths of the left and right notch regions is twice as large as the average opening width, the relationship described in the context of the aforementioned Formulas 11 to 13 is satisfied.

Since a shape of the opening may be set on the basis of the aforementioned various factors, candidates about the appropriate vertical period width may be obtained. As described with reference to FIG. 13, the vertical period width, which is effective for reducing moire, is dependent on a structure of sub-pixels.

Moire may be considerably reduced even under manufacturing errors in a slant barrier if the vertical period width is set so that the parameter “nnd” determined on the basis of the aforementioned Formula 10 becomes a median value or a value, which is approximate to the median value between consecutive integer values. Accordingly, a candidate which satisfies the aforementioned condition may be selected as the vertical period width among the candidates about the appropriate vertical period width.

Design data about the various design factors (e.g. the dimensions represented by “hmax”, “hmin”, “dpv”, “dwh”, “α” and “β” in FIG. 22) described with reference to FIG. 22 may be set in correspondence with the selected vertical period width. A moire pattern viewed from a predetermined viewing position may be estimated on the basis of the set design data. It should be noted that values set by the initial adjuster 110 (c.f. FIG. 14) for the appropriate viewing distance, the distance between the display portion 150A and the separator 160A, the vertical sub-pixel pitch, the horizontal sub-pixel pitch, and the number of parallaxes may be used in moire pattern estimation process.

Some of the aforementioned various design factors (e.g. angle “α”, average aperture ratio, minimum opening width “hmin”) may be handled as fixed values based on a structure or other design conditions of the sub-pixels. The other design factors (e.g. maximum opening width “hmax”, notch depth “dwh”) may be variable. The values of these design factors may be determined appropriately by using change parameters assigned to these design factors.

A moire pattern may be estimated on the basis of geometric data of the opening, which is determined on the basis of the aforementioned design data. Appropriate arithmetic operation software (e.g. software configured to execute operations for estimating locus of light) may be used for the estimation and/or the evaluation of the moire pattern. The shape of the opening may be optimized on the basis of the estimated moire pattern. Consequently, the moire may be effectively reduced with keeping a low crosstalk level.

### (Step Barrier)

A step barrier may be used instead of the aforementioned various slant barriers as the separator 160A described with reference to FIG. 14.

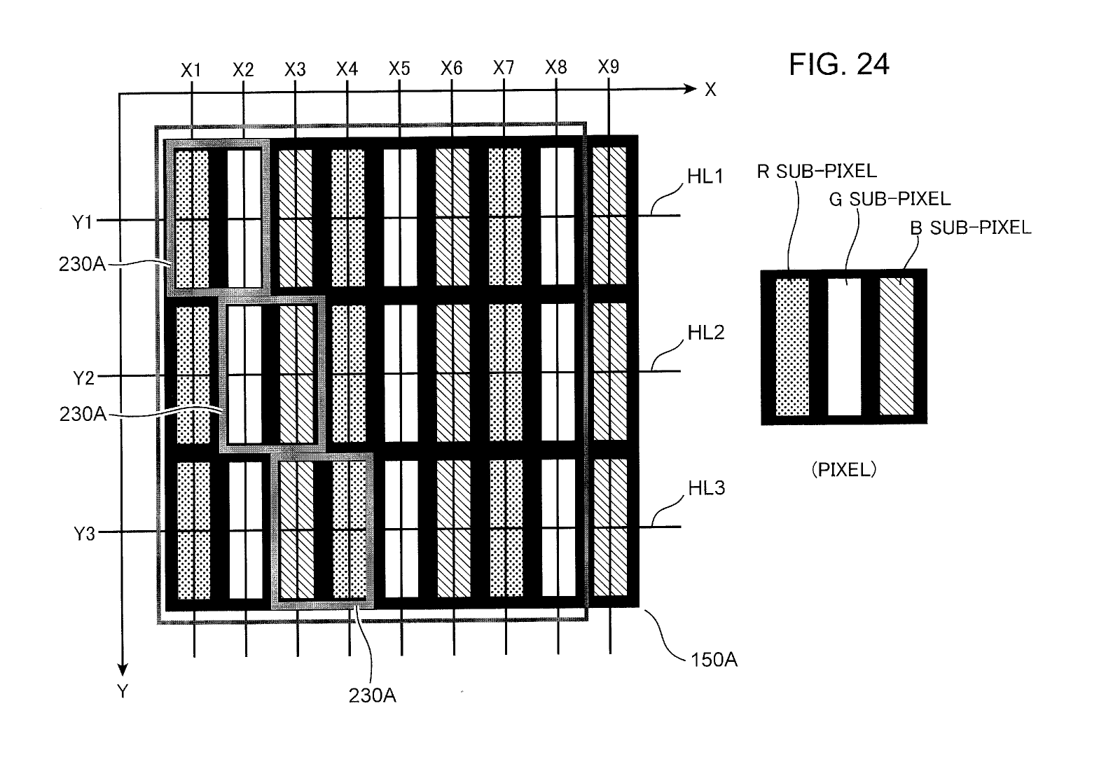

FIG. 24 is a schematic view of the opening 230A of the step barrier superimposed on the display portion 150A. The step barrier is described with reference to FIGS. 15 and 24.

The display portion 150A displays images under the display pattern described with reference to FIG. 15. In comparison between FIGS. 15 and 24, the opening 230A of the step barrier overlaps with the display groups LDG1 to LDG3. Accordingly, the sub-pixel (X1, Y1) and the sub-pixel (X2, Y1) become exposed from the opening 230A formed on the horizontal line HL1. The sub-pixel (X2, Y2) and the sub-pixel (X3, Y2) become exposed from the opening 230A formed on the horizontal line HL2. The sub-pixel (X3, Y3) and the sub-pixel (X4, Y3) become exposed from the opening 230A formed on the horizontal line HL3.

Like the display groups LDG1 to LDG3, the inclination angle of the arrangement of the opening 230A is “3:1”. The openings 230A arranged at the inclination angle of “3:1” form an opening region of a staircase pattern.

Like the slant barrier described with reference to FIG. 16, the relationship represented by the aforementioned Formula 2 may be applied to the step barrier with regard to the appropriate viewing distance. Accordingly, the step barrier shown in FIG. 24 may also achieve a short appropriate viewing distance.

Like the first embodiment, the relationship represented by the aforementioned Formula 1 may be applied to the step barrier with regard to the opening width. Accordingly, the step barrier shown in FIG. 24 is less likely to cause moire.

Even when the step barrier is used as the separator 160A, the display portion 150A displays images under the display pattern described with reference to FIG. 15. Since a rectangular region FPR with an aspect ratio set to be approximate to a square, problems such as an unnatural profile is less likely to happen.

Like the first embodiment, a region recognized as one pixel by a viewer at one viewpoint includes two R sub-pixels, two G sub-pixels and two B sub-pixels (RG+BR+GB). Accordingly, even when a step barrier is used, a color imbalance is less likely to occur.

Like the first embodiment, even after a horizontal movement of the viewer, a region of the left image viewed by the viewer's left eye is sufficiently wider than a region of the right image viewed by the viewer's left eye. Accordingly, noticeable crosstalk is less likely to occur.

### Third Embodiment

### Display Device

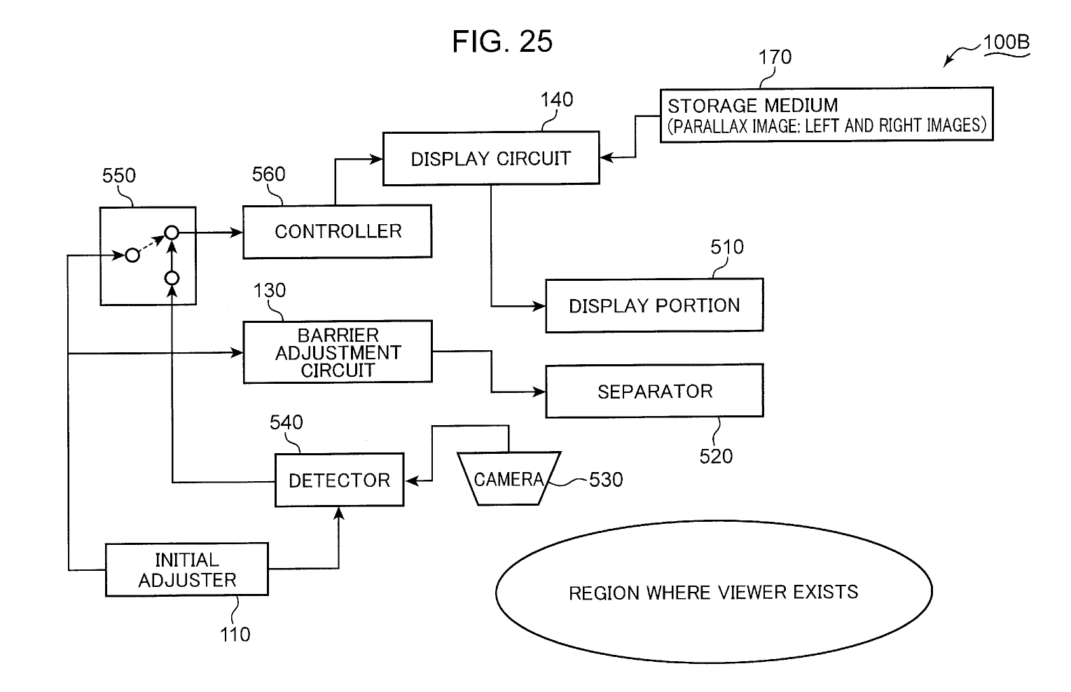

FIG. 25 is a schematic block diagram of the display device 100B according to the third embodiment. The display device 100B is described with reference to FIG. 25. It should be noted that the same reference numerals are assigned to elements common with the first embodiment. The explanation of the first embodiment may be applied to the elements to which the same reference numerals are assigned.

Like the first embodiment, the display device 100B includes the initial adjuster 110, the barrier adjustment circuit 130, the display circuit 140 and the storage medium 170. The display device 100B further includes a display portion 510, a separator 520, a camera 530, a detector 540, a switching portion 550, and a controller 560.

The camera 530 captures a region where there is a viewer viewing images displayed by the display portion 510 and generates image data. The image data is output from the camera 530 to the detector 540. The detector 540 uses the image data to acquire positional information about a position and a positional change of the viewer. In this embodiment, the detector 540 is exemplified as the acquisition portion.

When the display device 100B starts to display images or when the display device 100B is placed in a usage environment, the initial adjuster 110 adjusts the barrier adjustment circuit 130 and the display circuit 140. Simultaneously, the initial adjuster 110 adjusts the detector 540 so that the detector 540 may appropriately acquire the positional information.

The storage medium 170 stores image data about parallax images, which are obtained by synthesizing a left image to be viewed by a left eye and a right image to be viewed by a right eye. The image data is transferred from the storage medium 170 to the display circuit 140. The display circuit 140 processes the image data to generate drive signals. The drive signals are transferred from the display circuit 140 to the display portion 510. The display portion 510 displays parallax images (2D) in response to the drive signals.

The separator 520 may be a parallax barrier situated away from the display portion 510. A slant barrier and a step barrier are exemplified as the parallax barrier. The separator 520 includes blocking portions for defining a size and shape of the aforementioned openings. A blocking portion blocks image light emitted from the display portion 510 whereas the opening allows transmission of the image light. Accordingly, the image light may pass through the opening to reach the viewer's eyes. The separator 520 is formed so that image light in correspondence to the left image enters the left eye of the viewer existing at a predetermined position whereas image light in correspondence to the right image enters the right eye of the viewer. In addition, the separator 520 is formed so that the image light of the right image directed toward the left eye and the image light of the left image directed toward the right eye are blocked by the blocking portions.

The barrier adjustment circuit 130 controls the separator 520. The controller 560 controls the display circuit 140 in response to output signals from the initial adjuster 110 and the detector 540. Consequently, a display pattern of images displayed by the display portion 510 changes in response to a position of the viewer.

The separator 520 may be a fixed barrier member, which is formed from a thin film or a highly transparent material (e.g. glass). In this case, the initial adjuster 110 does not adjust a position of the opening or the barrier pitch. It should be noted that the barrier adjustment circuit 130 may make the film entirely transparent (state where transmission of light is allowed) or make the film entirely opaque (state where transmission of light is not allowed) while the initial adjuster 110 executes the aforementioned initial adjustment.

The separator 520 may be a barrier device (e.g. TFT liquid crystal panel) configured to change parameters such as a blocking position, blocking area, opening position and opening area under voltage application. The initial adjuster 110 may perform a positional control for the openings and blocking portions of the separator 520 every pixel or sub-pixel.

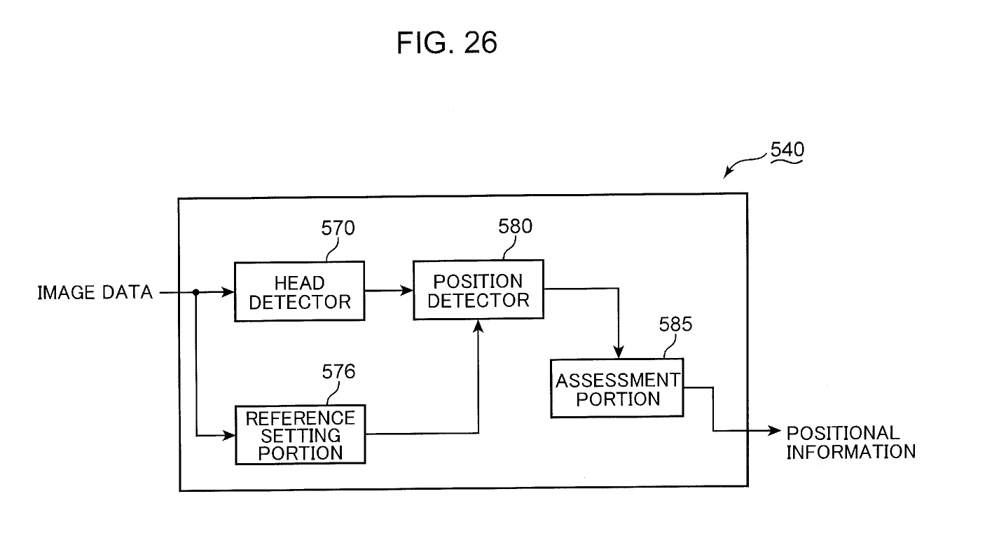

FIG. 26 is a schematic block diagram of the detector 540. The detector 540 is described with reference to FIGS. 25 and 26.

The detector 540 includes a head detector 570, a reference setting portion 576, a position detector 580, and an assessment portion 585. The image data output from the camera 530 is input to the head detector 570 and the reference setting portion 576. The head detector 570 detects the viewer's head from the image data. The reference setting portion 576 sets a reference point for detecting the viewer's position on the basis of the image data. The position detector 580 detects the viewer's position on the basis of information about the viewer's head detected by the head detector 570, and information about the reference point set by the reference setting portion 576. The assessment portion 585 determines whether the viewer's position changes on the basis of information about the viewer's position detected by the position detector 580. The determination result by the assessment portion 585 is output as positional information.

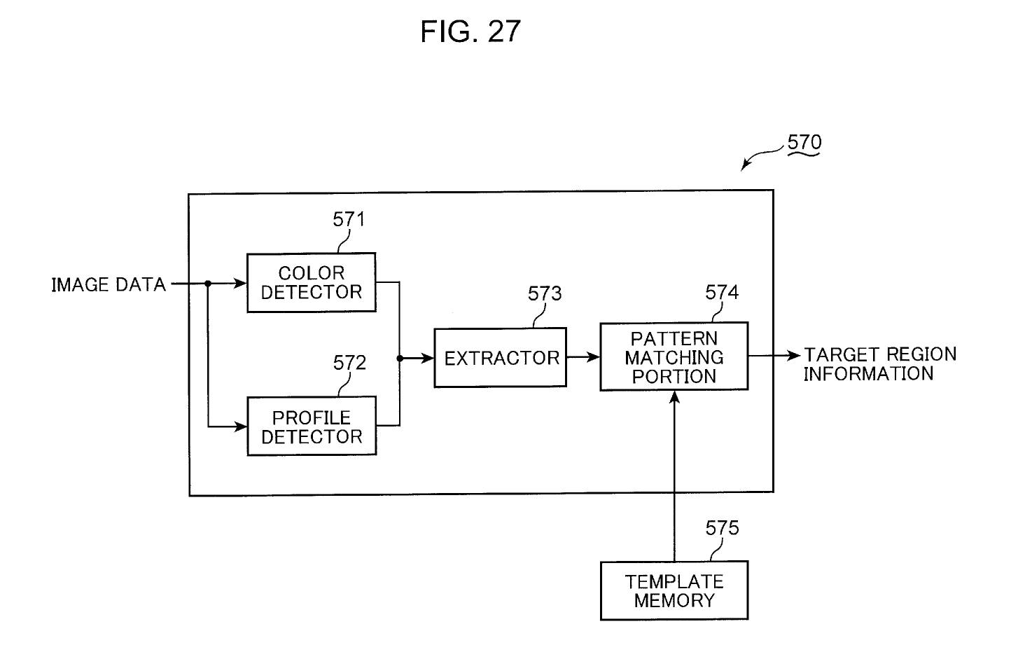

FIG. 27 is a schematic block diagram of the head detector 570. The head detector 570 is described with reference to FIGS. 25 to 27.

The head detector 570 includes a color detector 571, a profile detector 572, an extractor 573, a pattern matching portion 574 and a template memory 575. The image data output from the camera 530 is input to the color detector 571 and the profile detector 572. The color detector 571 detects information about colors on the basis of the image data. The profile detector 572 detects information about profiles on the basis of the image data. The extractor 573 extracts a feature amount of the image data on the basis of the information about color and profile. The template memory 575 stores template data used in matching processes performed by the pattern matching portion 574. The pattern matching portion 574 compares data about the extracted feature amount with the template data to output target region information, which is used in position detection processes performed by the position detector 580. In this embodiment, the template memory 575 is an external memory. Alternatively, the template memory may be a storage element built into the head detector 570.

### (Detector)

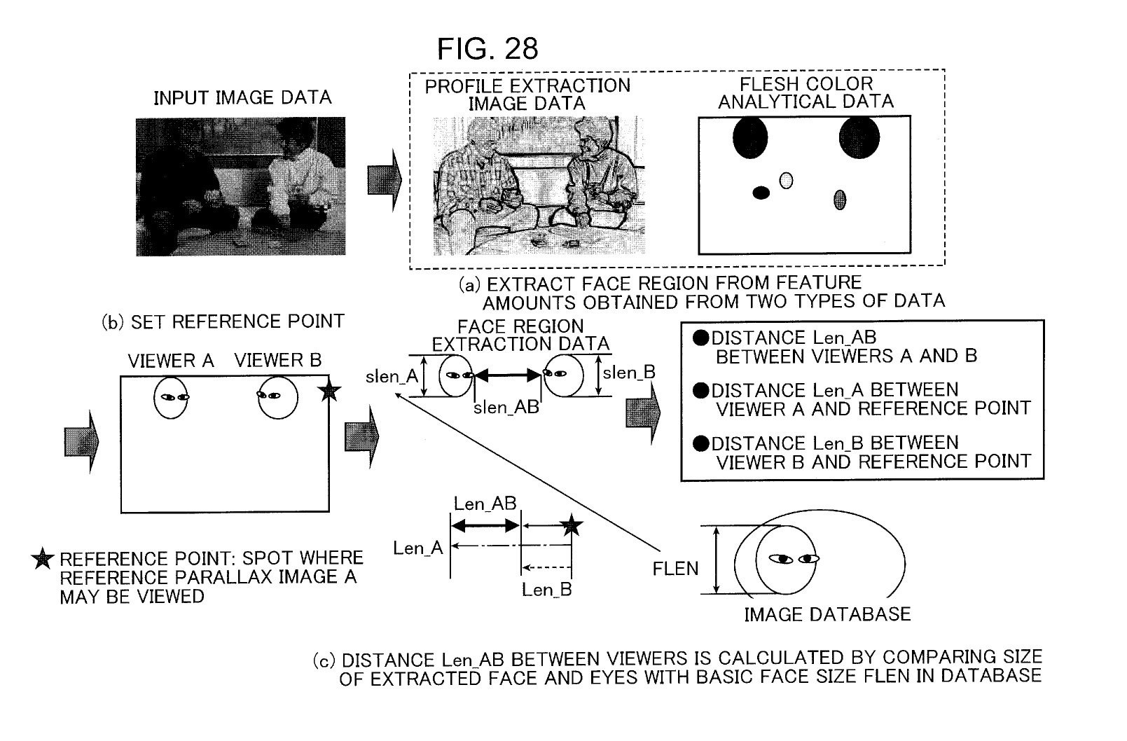

FIG. 28 is a conceptual view of processes executed by the detector 540. The processes executed by the detector 540 are described with reference to FIGS. 25 to 28.

As described above, the initial adjuster 110 performs the initial setting of the detector 540. For example, the initial adjuster 110 may use photograph data of a person positioned at a predetermined distance away from the camera 530 so as to face the camera 530. The initial adjuster 110 adjusts parameters about thresholds used in the matching processes executed by the pattern matching portion 574. The initial adjuster 110 may adjust a brightness distribution and a color distribution of the photograph data. Consequently, the detector 540 may appropriately extract a region of the viewer's face.

The initial adjuster 110 may adjust reference values for calculating a distance between viewers. The template memory 575 stores data about face images used as references. The initial adjuster 110 compares a size of a face image in the template memory 575 (indicated as symbol “FLEN” in FIG. 28) with a size of a facial portion of the aforementioned photograph data to calculate a relative ratio between these sizes.

Meanwhile, the initial adjuster 110 may perform evaluation and adjustment operations about visually recognized stereoscopic images by using test images. A viewer observing the stereoscopic images at an optimal viewing distance may view the test images to evaluate a level of visibility and blurring/fusion of the stereoscopic images. The viewer may use the display circuit 140 to tune gradation characteristics. Optionally, the viewer may adjust the parallax image to change a parallax amount between the left and right images (e.g. intensity control using a linear coefficient or adjustment to a shift amount in the horizontal direction). Consequently, the test images may be stereoscopically perceived at a reference point (point indicated with a star mark in FIG. 28) set by the reference setting portion 576.

As shown in FIG. 28, the camera 530 captures a region where there is a viewer. With respect to a capturing range, for example, a viewing angle from the display device 100B may be set to “100°”. A distance between the viewer and the display device 100B may be set within a range from “1.5 m” to “6 m” or “7 m”.

The camera 530 outputs image data, which represents the region where there is the viewer, to the head detector 570. The head detector 570 extracts the head of a person represented by the image data.

The image data, which represents the region where there is the viewer, is also output from the camera 530 to the reference setting portion 576. The reference setting portion 576 sets a reference point (point indicated with the star mark in FIG. 28). The reference point is used for detecting a relative size of the object represented by the image data.

The photograph of FIG. 28 shows two viewers (indicated as “viewer A” and “viewer B” in FIG. 28). The position detector 580 detects positions of the heads of the two viewers. The position detector 580 calculates a distance (indicated with symbol “Len_AB” in FIG. 28) between the two viewers, a distance (indicated with symbol “Len_A” in FIG. 28) from the reference point to one viewer (“viewer A” in FIG. 28), and a distance (indicated with symbol “Len_B” in FIG. 28) from the reference point to the other viewer (“viewer B” in FIG. 28).

The position detector 580 may acquire the aforementioned distance data by using the following Formula. In the following Formula, symbol “slen_A” represents a size of the head of “viewer A” extracted by the head detector 570. Symbol “slen_B” represents a size of the head of “viewer B” extracted by the head detector 570. Symbol “slen AB” represents a distance between the heads of “viewer A” and “viewer B”. Symbol “Rface” represents a relative ratio between a size of the head in the image data and a size of the face image in the template memory 575.

Len_{—}A=slen_{—}A×Rface [Formula 15]

Len_{—}B=slen_{—}B×Rface [Formula 16]

Len_{—}AB=slen_{—}AB×Rface [Formula 17]

The assessment portion 585 may determine whether the viewer moves or not, with reference to the distance data obtained from aforementioned Formulas 15 to 17. If two of the three types of the aforementioned distance data changes by a distance longer than half the distance of the parallax amount set between the left and right images, the assessment portion 585 may determine that the viewer moves. In this case, the assessment portion 585 outputs positional information to the controller 560. The controller 560 executes control for changing an image display pattern of the display portion 510 in response to the positional information.

As shown in FIG. 27, image signals (image data), which represent the color image, are input to the profile detector 572. The profile detector 572 acquires profile information about a profile from the image data.

The following determinant is an exemplary determinant which is used as a two-dimensional filter by the profile detector 572.

$$fx = [ \begin{matrix}{fx}_{00} & {fx}_{10} & {fx}_{20} \\ {fx}_{01} & {fx}_{11} & {fx}_{21} \\ {fx}_{02} & {fx}_{12} & {fx}_{22}\end{matrix} ] = [ \begin{matrix}- 1 & 0 & 1 \\ - 2 & 0 & 2 \\ - 1 & 0 & 1\end{matrix} ] , \\ fy = [ \begin{matrix}{fy}_{00} & {fy}_{10} & {fy}_{20} \\ {fy}_{01} & {fy}_{11} & {fy}_{21} \\ {fy}_{02} & {fy}_{12} & {fy}_{22}\end{matrix} ] = [ \begin{matrix}- 1 & - 2 & - 1 \\ 0 & 0 & 0 \\ 1 & 2 & 1\end{matrix} ] \qquad [ Formula 18 ]$$

The profile detector 572 uses the two-dimensional filter represented in “Formula 18” to calculate differential vectors in the image data. The following Formula represents calculated differential vectors. In the following Formula, symbol “i” represents “x coordinate” in the image data. Symbol “j” represents “y coordinate” in the image data. Symbol “xd(i, j)” is a function representing the differential vectors of “x-axis direction” corresponding to a position in the image data. Symbol “yd(i, j)” is a function representing the differential vectors of “y-axis direction” corresponding to a position in the image data. Symbol “k(i−n, j−m)” represents a value of the image data corresponding to a position in the image data.

$$xd ( i , j ) = {\sum }_{n = - 1}^{1} {\sum }_{m = - 1}^{1} {fx}_{n + 1 m + 1} \cdot k ( i - n , j - m ) \\ yd ( i , j ) = {\sum }_{n = - 1}^{1} {\sum }_{m = - 1}^{1} {fy}_{n + 1 m + 1} \cdot k ( i - n , j - m ) \qquad [ Formula 19 ]$$

The profile detector 572 may calculate a size of the differential vectors by using the differential vectors represented in the aforementioned “Formula 19”. It should be noted that symbol “stv(i, j)” in the following Formula represents a size of the differential vectors corresponding to a position in the image data.

$$stv ( i , j ) = \sqrt{\{ xd ( i , j ) \times xd ( i , j ) + yd ( i , j ) \times yd ( i , j ) \}} \qquad [ Formula 20 ]$$

The following Formula is a determination formula used by the profile detector 572. In the following Formula, symbol “E(i, j)” represents a determination result corresponding to a position in the image data. If the relationship represented by “E(i, j)=1” is satisfied, a pixel corresponding to the position “(i, j)” in the image data includes a profile. Otherwise, the pixel corresponding to the position “(i, j)” in the image data does not include the profile. Symbol “TH2” is a threshold which is used in the determination process performed by the profile detector 572. Consequently, the determination result of the profile detector 572 is digitized.

$$E ( i , j ) = [ \begin{matrix}1 & if ( stv ( i , j ) \geq TH 2 ) \\ 0 & if ( stv ( i , j ) < TH 2 )\end{matrix} \qquad [ Formula 21 ]$$

The profile information obtained from the aforementioned Formula 21 is output from the profile detector 572 to the extractor 573.

The image data from the camera 530 is also output to the color detector 571. The color detector 571 executes cluster classification on the basis of a color distribution in the image data. The color detector 571 executes a conversion process from the image data to the color information so that an output value of “1.0” is assigned to a cluster region obtained from the cluster classification if the cluster region contains many pixels representing a flesh color or a color approximate to a flesh color. The color detector 571 executes the conversion process from the image data to the color information so that an output value less than “1.0” is assigned to a cluster region if the cluster region contains few pixels representing a flesh color or a color approximate to a flesh color. The color information is output from the color detector 571 to the extractor 573.

The extractor 573 extracts the feature amount to identify a viewer in the image data on the basis of the profile information and the color information. The feature amount may be acquired from a linear combination between the profile information and the color information. Alternatively, the feature amount may be acquired from non-linear conversion processes applied to the profile information and the color information.

As described above, if there are many pixels representing a flesh color or a color approximate to a flesh color, there is a large output value assigned to the color information. If there are few pixels representing a flesh color or a color approximate to a flesh color, there is a small output value assigned to the color information. Accordingly, the color information may be used as a coefficient for intensifying or weakening the profile information. For example, the extractor 573 may extract the feature amount by multiplying data of the color information by data of the profile information. It should be noted that the extractor 573 does not have to use the color information. The extractor 573 may rely only on the profile information to extract the feature amounts.

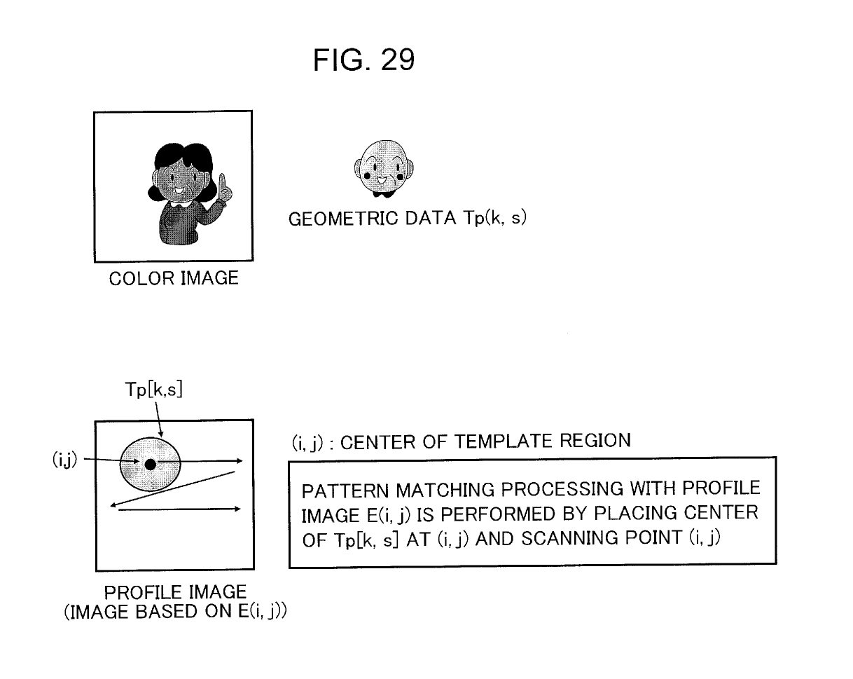

FIG. 29 is a conceptual view of processes executed by the pattern matching portion 574. The processes executed by the pattern matching portion 574 are described with reference to FIGS. 27 and 29.

FIG. 29 shows exemplary geometric data (indicated with symbol “Tp(k, s)” in FIG. 29) stored in the template memory 575. The template memory 575 may store several types of the geometric data.

The pattern matching portion 574 reads the geometric data from the template memory 575, and compares the geometric data with data about the feature amount output from the extractor 573. Consequently, a target region to be handled as the positional information is determined. In this embodiment, the facial region is extracted as the target region. Alternatively, a part of the viewer (upper body or entire body) or a facial part (eyes, nose or mouth) may be extracted as the target region.

Since the pattern matching portion 574 extracts the facial region as the target region, the template memory 575 has standard geometric data about the region of a face. The geometric data may be data about faces captured from various directions. When a part of the viewer (upper body or entire body) is handled as the target region, the template memory 575 may have data about a shape of the upper body and/or the entire body of a person. In this case, the geometric data may be data about the upper body and/or the entire body of a person captured from various directions. If a facial part (eyes, nose or mouth) is handled as the target region, the template memory 575 may have data about a shape of the facial part (eyes, nose or mouth).

The pattern matching portion 574 sets candidates of a rectangular region around arbitrary pixels which form the geometric data (image data) read from the template memory 575. The pattern matching portion 574 evaluates a matching degree between the feature amount and the geometric data by using the following evaluation function (indicated with symbol “R(i, j, Wp, Hp)” in the following Formula). It should be noted that symbol “Wp” in the following Formula refers to the number of pixels in the horizontal direction in the set rectangular region. Symbol “Hp” refers to the number of pixels in the vertical direction in the set rectangular region. Symbol “p” represents the number of templates.

$$R ( i , j , p ) = {\sum }_{k = 0}^{Wp - 1} {\sum }_{s = 0}^{Hp - 1} Tp [ k , s ] \cdot E ( i - Wp / 2 + k , j - Hp / 2 + s ) \qquad [ Formula 22 ]$$

The pattern matching portion 574 extracts the target region by using the following Formula.

$$BestSR [ i , j , W , H ] = \{ SR [ i , j , Wp , Hp ] \vert MR = {max}_{( i , j ) , p} \{ R ( i , j , p ) \} , MR \geq THMR \} \qquad [ Formula 23 ]$$

The pattern matching portion 574 calculates the maximum value of the evaluation function represented with the aforementioned “Formula 22”. The function represented with symbol “max” in the aforementioned “Formula 23” is a function for calculating the maximum value of the evaluation function. Symbol “THMR” in the aforementioned Formula refers to a threshold set for the value of the evaluation function. If the maximum value of the evaluation function exceeds the threshold, the pattern matching portion 574 extracts the rectangular region of the corresponding candidate as the target region. Without a rectangular region of a candidate which exceeds the threshold, the pattern matching portion 574 outputs information of the image output from the position detector 580. Data about the target region obtained by using aforementioned “Formula 23” is output as the positional information to the controller 560.

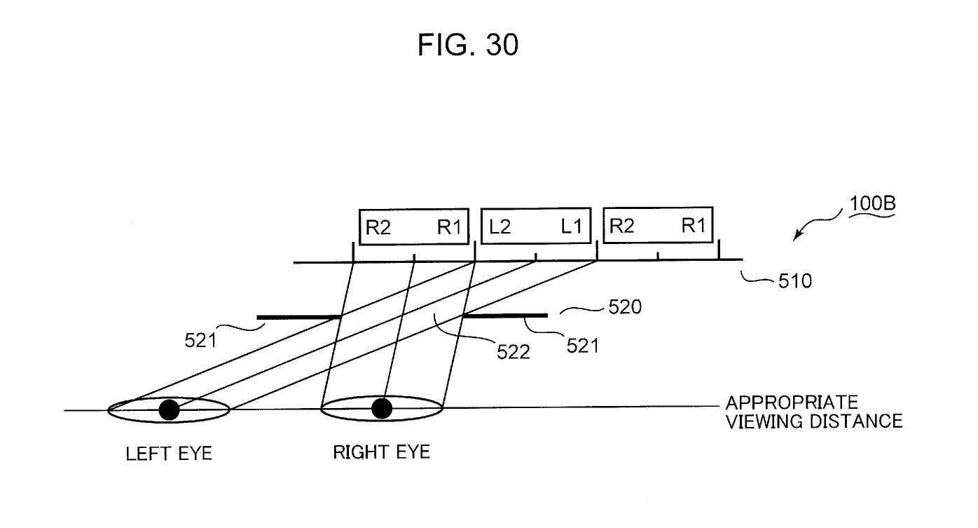

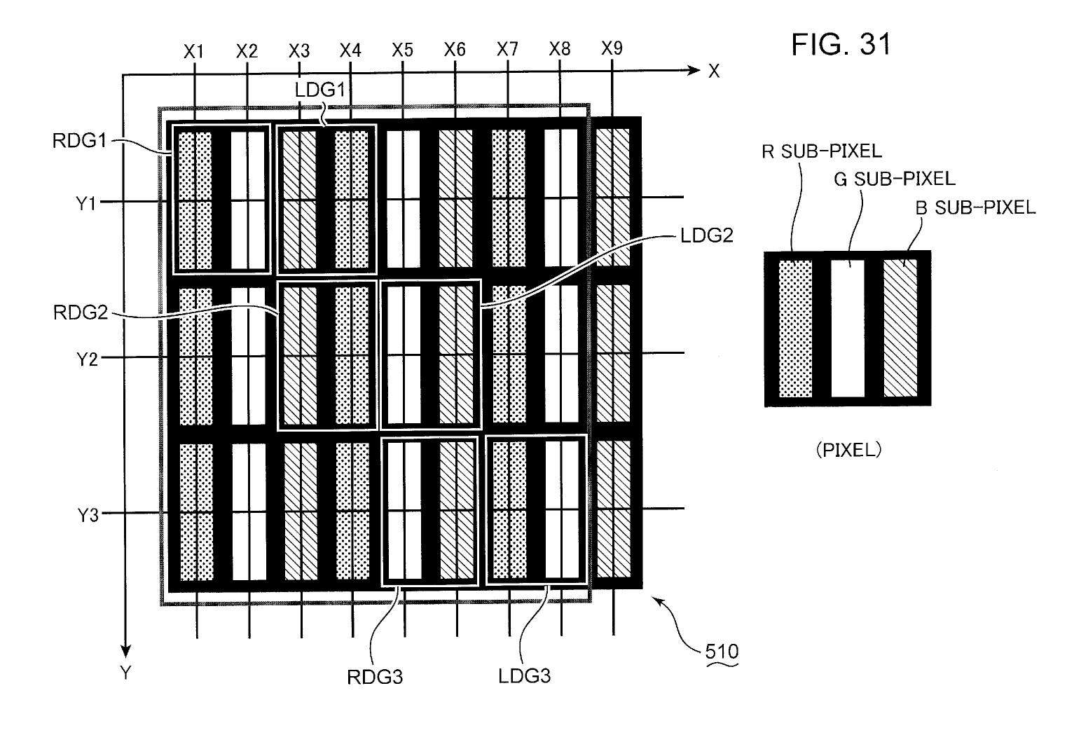

FIG. 30 is a schematic view of the display device 100B. FIG. 31 is a schematic view of the display portion 510 of the display device 100B shown in FIG. 30. A display pattern of the image displayed by the display portion 510 is described with reference to FIGS. 25, 30 and 31. It should be noted that the coordinates and names about sub-pixels shown in FIG. 31 are the same as those of the first embodiment.

FIG. 30 shows the viewer's left and right eyes. The viewer is positioned away from the display device 100B at an appropriate viewing distance.

As shown in FIG. 31, the display portion 510 sets a display group RDG1 for displaying a right image by using the sub-pixel (X1, Y1) and the sub-pixel (X2, Y1). The display portion 510 sets a display group RDG2 for displaying the right image by using the sub-pixel (X3, Y2) and the sub-pixel (X4, Y2). The display portion 510 sets a display group RDG3 for displaying the right image by using the sub-pixel (X5, Y3) and the sub-pixel (X6, Y3).

Symbol “R2” shown in FIG. 30 represents a group of the sub-pixel (X1, Y1), the sub-pixel (X3, Y2) and the sub-pixel (X5, Y3). Symbol “R1′” shown in FIG. 30 represents a group of the sub-pixel (X2, Y1), the sub-pixel (X4, Y2) and the sub-pixel (X6, Y3).

As shown in FIG. 30, the separator 520 includes blocking regions 521. An opening 522 is formed between the blocking regions 521. Image light emitted from the display groups RDG1 to RDG3 passes through the opening 522 to reach the viewer's right eye. On the other hand, the blocking regions 521 block the image light from the display groups RDG1 to RDG3 directed toward the viewer's left eye. Accordingly, the viewer may view the right image displayed by the display groups RDG1 to RDG3 only with one's right eye.

As shown in FIG. 31, the display portion 510 sets a display group LDG1 for displaying a left image by using the sub-pixel (X3, Y1) and the sub-pixel (X4, Y1). The display portion 510 sets a display group LDG2 for displaying the left image by using the sub-pixel (X5, Y2) and the sub-pixel (X6, Y2). The display portion 510 sets a display group LDG3 for displaying the left image by using the sub-pixel (X7, Y3) and the sub-pixel (X8, Y3).

Symbol “L2” shown in FIG. 30 represents a group of the sub-pixel (X3, Y1), the sub-pixel (X5, Y2) and the sub-pixel (X7, Y3). Symbol “L1′” shown in FIG. 30 represents a group of the sub-pixel (X4, Y1), the sub-pixel (X6, Y2) and the sub-pixel (X8, Y3).

The image light emitted from the display groups LDG1 to LDG3 passes through the opening 522 to reach the viewer's left eye. On the other hand, the blocking regions 521 block the image light from the display groups LDG1 to LDG3 directed toward the viewer's left eye. Accordingly, the viewer may view the left image displayed by the display groups LDG1 to LDG3 only with one's left eye.

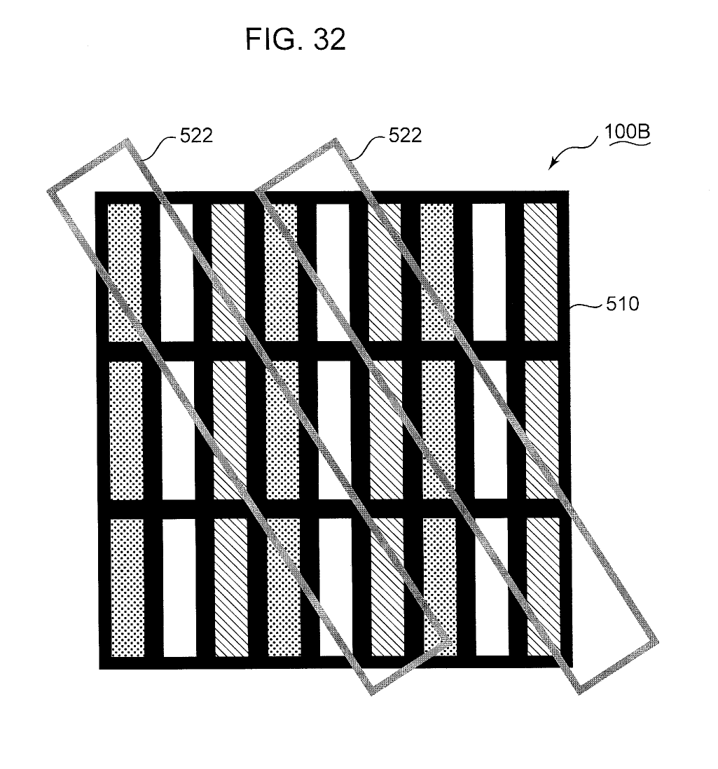

FIG. 32 is a schematic view of the display device 100B. The display device 100B is described with reference to FIG. 32.

The openings 522 are drawn in FIG. 32. An inclination angle of the openings 522 is “3:2”. It should be noted that the number of parallaxes is set to “2”.

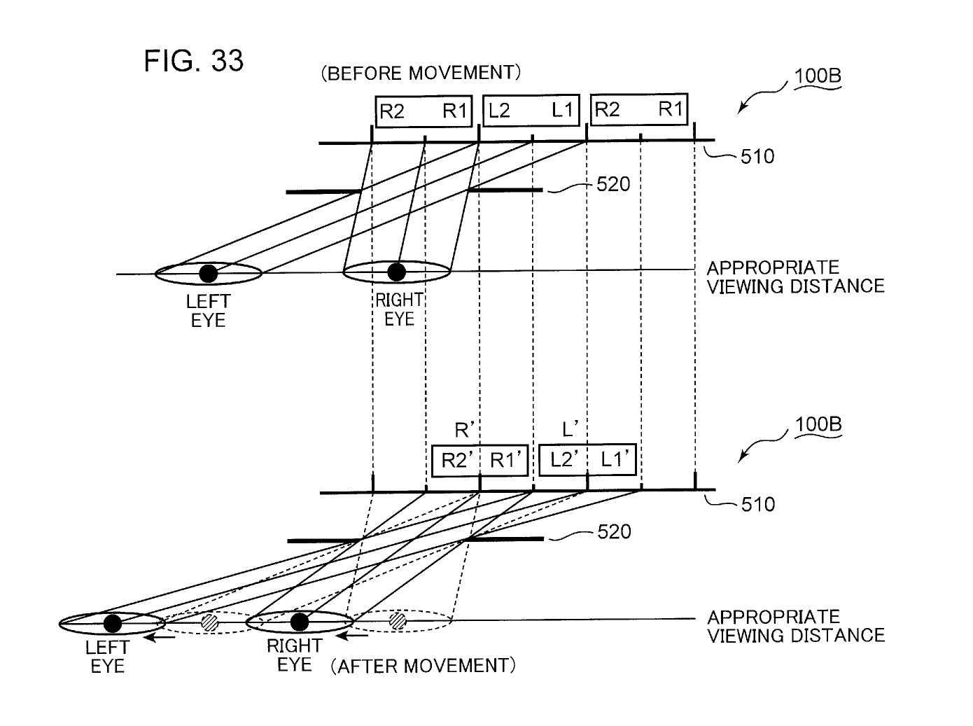

FIG. 33 shows the display device 100B before and after the viewer moves in the horizontal direction. The display device 100B is described with reference to FIGS. 25 and 33.

In FIG. 33, the viewer moves leftward by a distance which is half of the interocular distance. At this moment, the detector 540 detects the movement of the viewer. Consequently, signals representing the viewer's movement and the movement distance are output from the detector 540 to the controller 560 as the positional information. The controller 560 controls the display circuit 140 to cause the display portion 510 to change the display pattern.

Unless the display portion 510 changes the display pattern, the viewer may view the left image displayed by the group of the sub-pixels shown with symbol “L2” with one's right eye in addition to the right image displayed by the group of the sub-pixels shown with symbol “R1”. Likewise, unless the display portion 510 changes the display pattern, the viewer may view the right image displayed by the group of the sub-pixels shown with symbol “R2” with one's left eye in addition to the left image displayed by the group of the sub-pixels shown with symbol “L1”. As described above, the viewer may be less likely to appropriately view the stereoscopic image displayed by the display portion 510 because of the crosstalk.

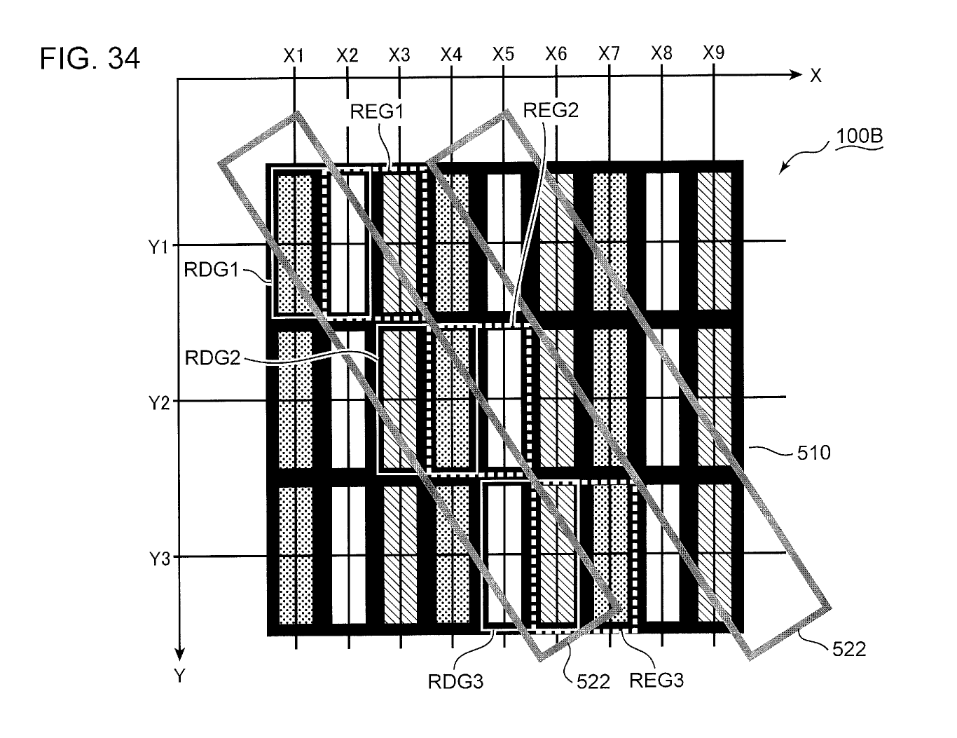

FIG. 34 is a schematic view of the changing operation for a display pattern of the display portion 510. The changing operation for a display pattern of the display portion 510 is described with reference to FIGS. 25 31, 33 and 34.

The display portion 510 regroups the display group in response to the positional information output from the detector 540. In FIG. 34, the rectangular frames shown with the solid line represent the display groups RDG1 to RDG3 described with reference to FIG. 31. In FIG. 34, the rectangular frames represented with the dotted line represent the display groups REG1 to REG3, which are newly set after the horizontal movement of the viewer described with reference to FIG. 33. The display groups REG1 to REG3 display the right image which was displayed by the display groups RDG1 to RDG3.

The display group REG1 is set by using the sub-pixel (X2, Y1) and the sub-pixel (X3, Y1). Like the display group RDG3, the display group REG1 includes a G sub-pixel and a B sub-pixel. Accordingly, the display group REG1 may display the image which was displayed by the display group RDG3.

The display group REG2 is set by using the sub-pixel (X4, Y2) and the sub-pixel (X5, Y2). Like the display group RDG1, the display group REG2 includes an R sub-pixel and a G sub-pixel. Accordingly, the display group REG2 may display the image which was displayed by the display group RDG1.

The display group REG3 is set by using the sub-pixel (X6, Y3) and the sub-pixel (X7, Y3). Like the display group RDG2, the display group REG3 includes a B sub-pixel and an R sub-pixel. Accordingly, the display group REG3 may display the image which was displayed by the display group RDG2.

Symbol “R2′” shown in FIG. 33 represents a group of the sub-pixel (X2, Y1), the sub-pixel (X4, Y2) and the sub-pixel (X6, Y3). Symbol “R1′” shown in FIG. 33 represents a group of the sub-pixel (X3, Y1), the sub-pixel (X5, Y2) and the sub-pixel (X7, Y3).

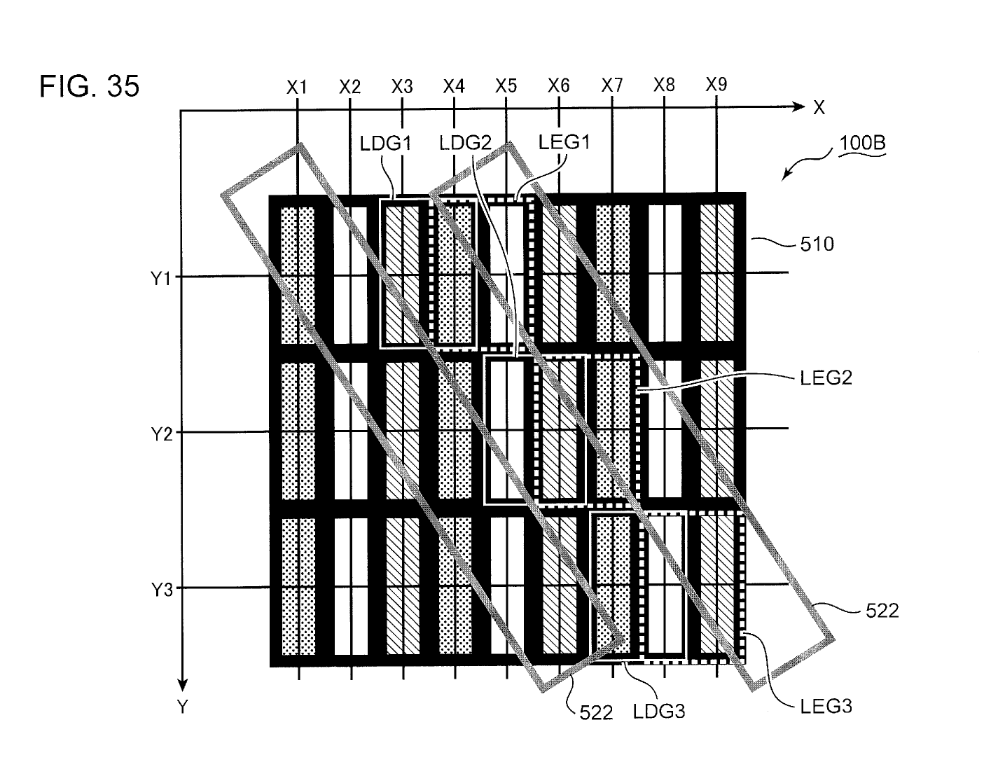

FIG. 35 is a schematic view of the changing operation for a display pattern of the display portion 510. The changing operation for a display pattern of the display portion 510 is described with reference to FIGS. 31, 33 and 35.

In FIG. 34, the rectangular frames shown with the solid line represent the display groups LDG1 to LDG3 described with reference to FIG. 31. In FIG. 35, the rectangular frames represented with the dotted line represent the display groups LEG1 to LEG3 which are newly set after the horizontal movement of the viewer described with reference to FIG. 33. The display groups LEG1 to LEG3 display the left image which was displayed by the display groups LDG1 to LDG3.

The display group LEG1 is set by using the sub-pixel (X4, Y1) and the sub-pixel (X5, Y1). Like the display group LDG3, the display group LEG1 includes an R sub-pixel and a G sub-pixel. Accordingly, the display group LEG1 may display the image which was displayed by the display group LDG3.

The display group LEG2 is set by using the sub-pixel (X6, Y2) and the sub-pixel (X7, Y2). Like the display group LDG1, the display group LEG2 includes a B sub-pixel and an R sub-pixel. Accordingly, the display group LEG2 may display the image which was displayed by the display group LDG1.

The display group LEG3 is set by using the sub-pixel (X8, Y3) and the sub-pixel (X9, Y3). Like the display group LDG2, the display group LEG3 includes a G sub-pixel and a B sub-pixel. Accordingly, the display group LEG3 may display the image which was displayed by the display group LDG2.

Symbol “L2” shown in FIG. 33 represents a group of the sub-pixel (X4, Y1), the sub-pixel (X6, Y2) and the sub-pixel (X8, Y3). Symbol “L1′” shown in FIG. 33 represents a group of the sub-pixel (X5, Y1), the sub-pixel (X7, Y2) and the sub-pixel (X9, Y3).

As described above, the principle of this embodiment may allow a viewer to appropriately view images even when the viewer moves. It should be noted that the principle of this embodiment also gives the following advantageous features, like the aforementioned various embodiments.

If a distance is constant between the separator and the display portion, the principle of this embodiment may set an appropriate viewing distance shorter than conventional technologies.

Since the principle of this embodiment allows setting of a wide opening, moire may be effectively reduced. With a separator having a narrower opening width than a horizontal width of a display group set by using sub-pixels aligned in the horizontal direction, crosstalk may be reduced, too.

The principle of this embodiment is less likely to cause color imbalance of images viewed by the viewer at one viewpoint. The color moire is less likely to occur even when the viewer moves in the horizontal direction.

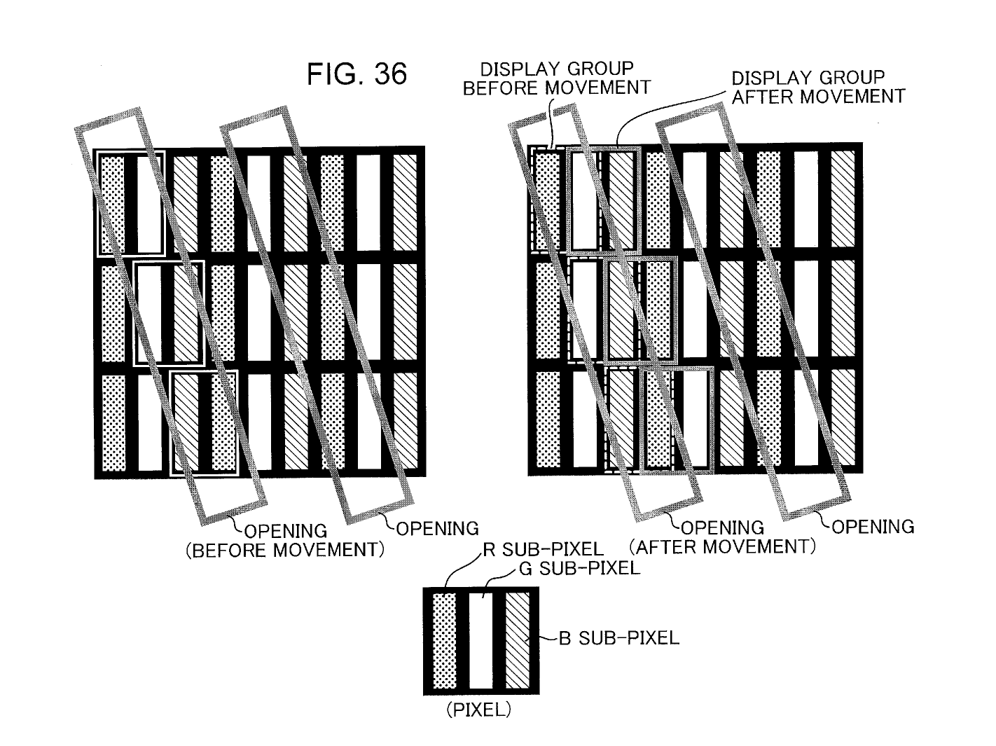

FIG. 36 is a schematic view of another changing operation for a display pattern. The changing operation for a display pattern is described with reference to FIGS. 32 and 36.

The principle of this embodiment is not dependent on an inclination angle of the openings of the separator. The openings of the slant barrier shown in FIG. 36 have the inclination angle of “3:1”. Accordingly, the slant barrier of FIG. 36 may achieve smaller crosstalk than the slant barrier which is designed by using the inclination angle of “3:2” described with reference to FIG. 32. It should be noted that the slant barrier of FIG. 36 may cause greater moire than the slant barrier described with reference to FIG. 32. However, the moire may be solved by the notch structure described in the context of the aforementioned various embodiments.

In this embodiment, since the display group includes two sub-pixels, the maximum opening width of the notch structure may be set to a value which is twice or less as large as the sub-pixel pitch. In this case, crosstalk is less likely to occur since there is little exposure of unwanted sub-pixels.

Moire may be considerably weakened even under manufacturing errors in a slant barrier if the vertical period width is set so that the parameter “nnd” determined on the basis of the aforementioned Formula 10 becomes a median value or an approximate value to the median value between consecutive integer values. The notch structure may be designed on the basis of the principle described in the context of the first and/or second embodiments.

Elements which form the notch structure may be triangular, trapezoidal or parallelogram. Further alternatively, a profile of these elements may be curved (e.g. an elliptic arc).

A protruding direction of the protrusions of the notch structure may be perpendicular to the horizontal line or the center line of the opening.

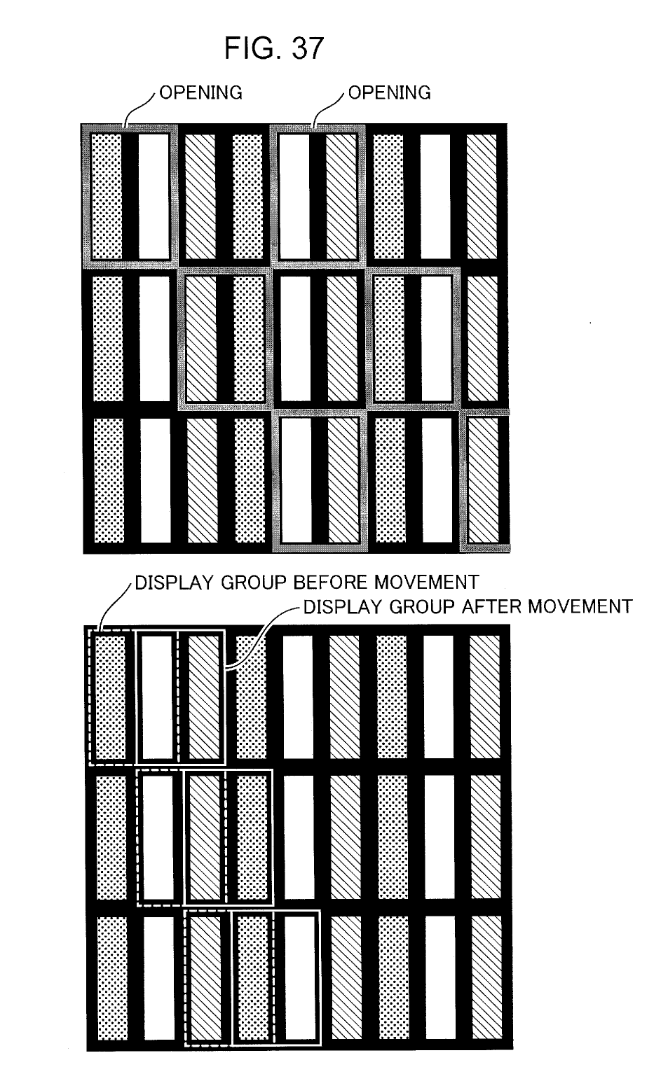

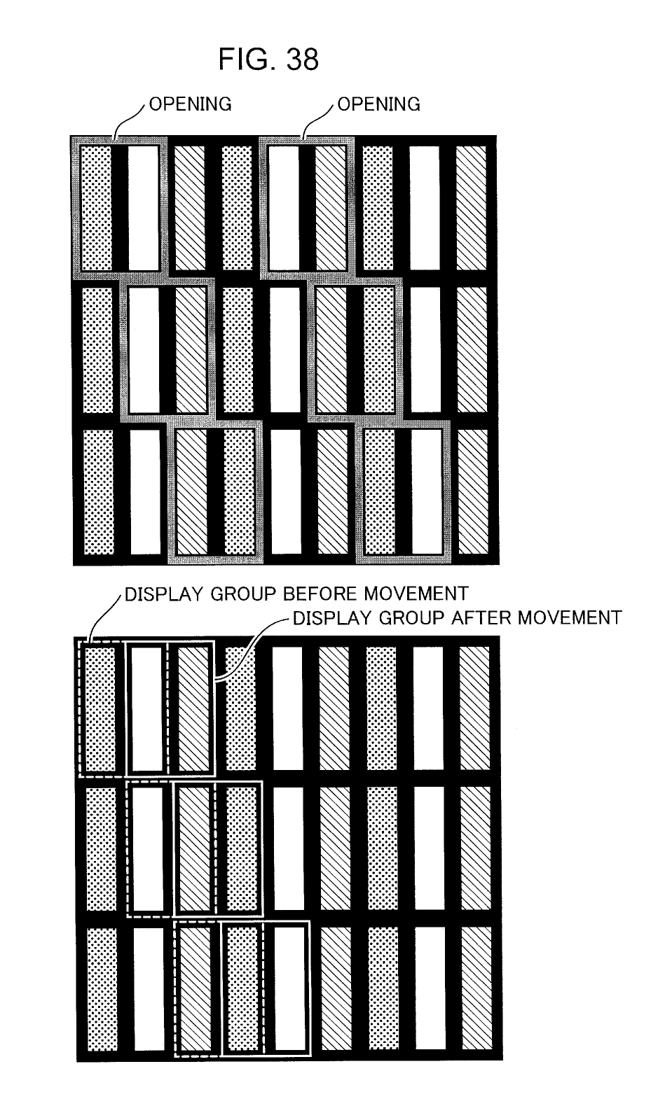

FIGS. 37 and 38 are schematic views of another changing operation for a display pattern. The changing operation of the display pattern is described with reference to FIGS. 37 and 38.

The upper diagrams of FIGS. 37 and 38 show openings of the step barrier described in the context of the first and second embodiments. This embodiment may be applicable under usage of these step barriers. If the display pattern is switched in response to a movement of the viewer, the viewer may appropriately view stereoscopic images.

### Fourth Embodiment

### Display Device

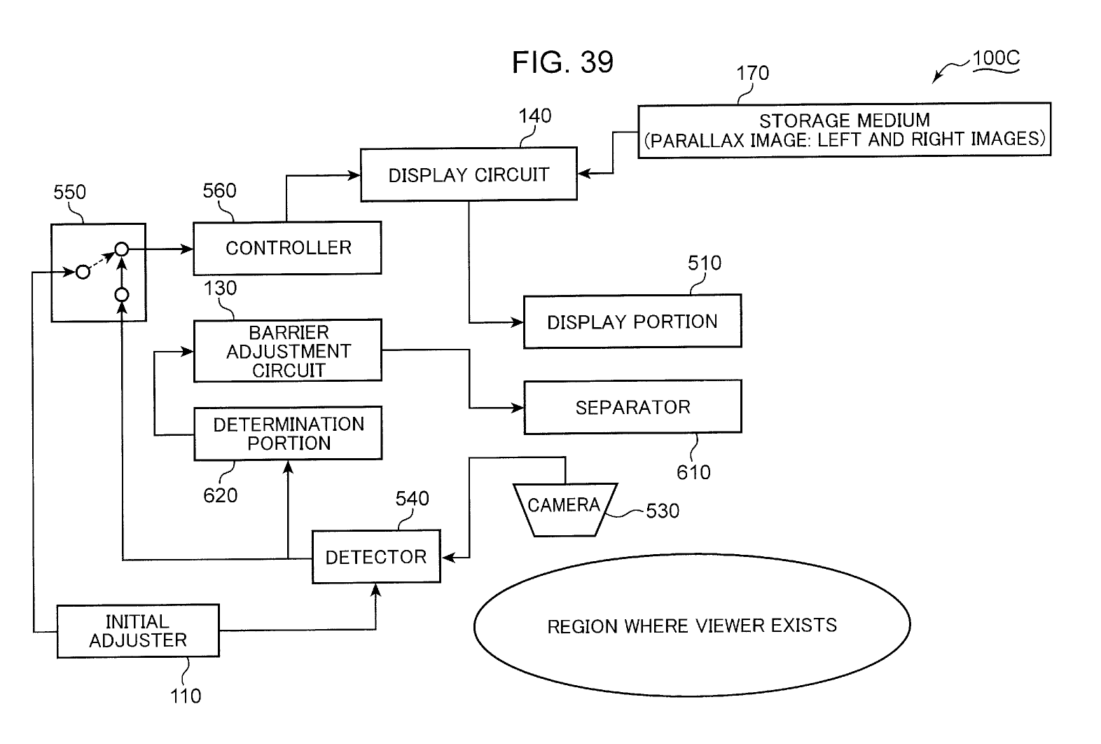

FIG. 39 is a schematic block diagram of the display device 100C according to the fourth embodiment. The display device 100C is described with reference to FIG. 39. It should be noted that the same reference numerals are assigned to elements common with the third embodiment. The description in the third embodiment may be applied to the elements to which the same reference numerals are assigned.

Like the third embodiment, the display device 100C includes the initial adjuster 110, the barrier adjustment circuit 130, the display circuit 140, the storage medium 170, the display portion 510, the camera 530, the detector 540, the switching portion 550 and the controller 560. The display device 100C further includes a separator 610 and a determination portion 620.

The storage medium 170 stores image data about parallax images, which are obtained by synthesizing a left image to be viewed by a left eye and a right image to be viewed by a right eye. The image data is transferred from the storage medium 170 to the display circuit 140. The display circuit 140 processes the image data to generate drive signals. The drive signals are transferred from the display circuit 140 to the display portion 510. The display portion 510 displays parallax images (2D) in response to the drive signals.

The separator 610 may be a parallax barrier situated away from the display portion 510. A slant barrier and a step barrier are exemplified as the parallax barrier. The separator 610 includes blocking portions for defining a size and shape of the aforementioned openings. The blocking portions block image light emitted from the display portion 510 whereas the opening allows transmission of the image light. Accordingly, the image light may pass through the openings to reach the viewer's eyes. The separator 610 is formed so that image light in correspondence to the left image enters the left eye of the viewer existing at a predetermined position whereas the image light in correspondence to the right image enters the right eye of that viewer. In addition, the separator 610 is formed so that image light of the right image directed toward the left eye and image light of the left image directed toward the right eye are blocked by the blocking portions.

The barrier adjustment circuit 130 controls the separator 610. For example, a shape of the separator 610 and a distance between the display portion 510 and the separator 610 are adjusted by the barrier adjustment circuit 130.

The camera 530 captures a region where there is a viewer viewing images displayed by the display portion 510 to generate image data. The image data is output from the camera 530 to the detector 540. The detector 540 uses the image data to acquire positional information about a position and a positional change of the viewer.

Unlike the third embodiment, the positional information is input not only to the controller 560 but also to the determination portion 620. The determination portion 620 uses the barrier adjustment circuit 130 to control the separator 610.

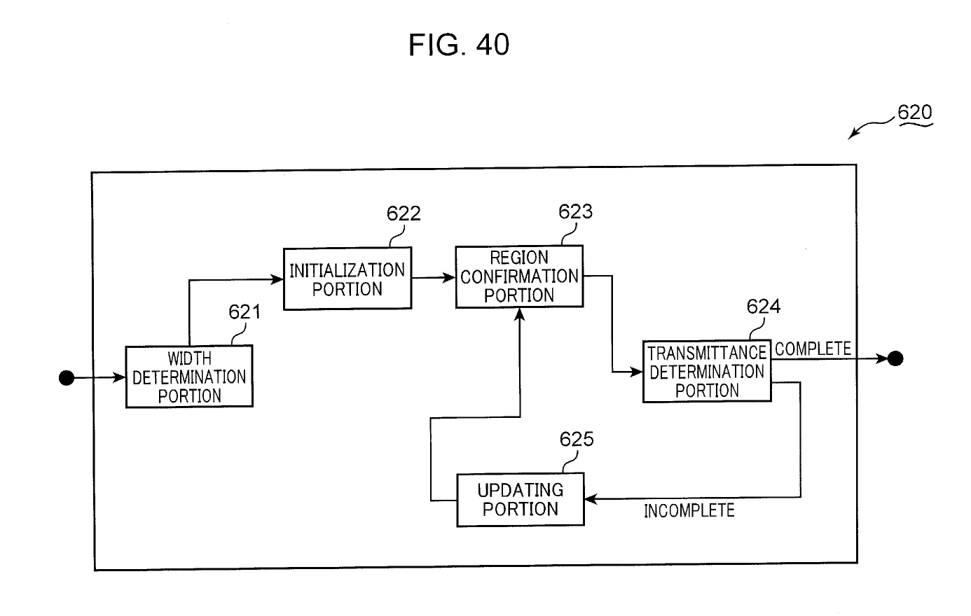

FIG. 40 is a schematic block diagram of the determination portion 620. The determination portion 620 is described with reference to FIGS. 39 and 40.

The determination portion 620 includes a width determination portion 621, an initialization portion 622, a region confirmation portion 623, a transmittance determination portion 624 and an updating portion 625. The positional information generated by the detector 540 is input to the width determination portion 621. The width determination portion 621 determines a position of blocking regions for blocking image light, a position and width of openings which allow transmission of the image light on the basis of the positional information. The initialization portion 622 sets a process target region to a predetermined initial position. The region confirmation portion 623 executes confirmation processes for the process target region. The transmittance determination portion 624 determines transmittance of the process target region. Unless the processes for the overall separator 610 are complete, the updating portion 625 newly sets a process target region.

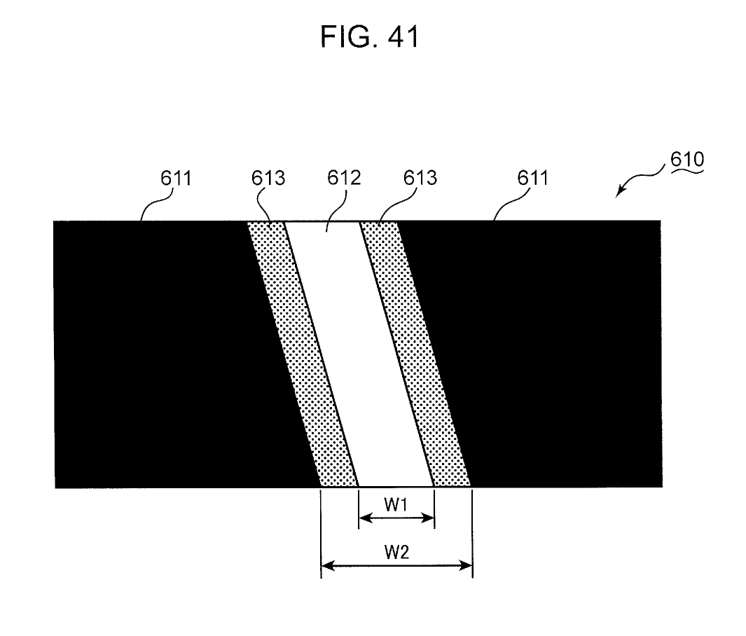

FIG. 41 is a schematic view of the separator 610. The separator 610 is described with reference to FIGS. 39 to 41. In this embodiment, a slant barrier is used as the separator 610. Alternatively, another type of barrier member (e.g. a step barrier) may be used as the separator 610.

The separator 610 includes a first region 611, a second region 612 and a third region 613. The first region 611 is a region that is determined as the blocking region by the width determination portion 621. The second region 612 is a region which is determined as the opening by the width determination portion 621. The third region 613 is a region in which transmittance changes in response to the width of the opening determined by the width determination portion 621. The region confirmation portion 623 identifies the region corresponding to the process target region from the first to third regions 611, 612, 613.

In this embodiment, the width determination portion 621 determines the width of the opening from two predetermined default values (indicated with symbols “W1”, “W2” in FIG. 41). Alternatively, the width determination portion 621 may set two values to be used as the width of the opening on the basis of a usage environment of the display device 100C.

The separator 610 may set transmittance by using a liquid crystal layer and a voltage which is applied to the liquid crystal layer. A TFT liquid crystal device is exemplified as the separator 610. In the first region 611, the voltage is adjusted to achieve optical transmittance of “0%”. In the second region 612, the voltage is adjusted to achieve optical transmittance of “100%”.

If transmittance of the third region 613 adjacent to the second region 612 is set to “0%”, a viewer may view a moire pattern. If the transmittance of the third region 613 adjacent to the second region 612 is set to “100%”, the viewer may view a moire pattern. The width determination portion 621 determines the opening width so that the viewer may not view a moire pattern between the width dimensions “W1”, “W2”, on the basis of the positional information. The transmittance determination portion 624 determines transmittance corresponding to the determined opening width. A voltage corresponding to the determined transmittance is applied to the third region 613. In this embodiment, the third region 613 is exemplified as the adjustment region.

For example, the width dimension “W2” may be set to a value which is “2 times” as large as the horizontal sub-pixel pitch. The width dimension “W1” may be set to be the same value as the horizontal sub-pixel pitch. When the transmittance of the third region 613 is set to “50%”, an opening with a width dimension, which is “1.5 times” as large as the horizontal sub-pixel pitch, is covered by the second and third regions 612, 613. If the transmittance of the third region 613 is set appropriately, moire may be effectively reduced.

In this embodiment, moire is reduced by electrical control. Accordingly, unlike moire reduction technologies relying on mechanical processing accuracy, moire may be reduced without precise processing technologies.

The principle of this embodiment may be applied to the third embodiment. The width dimension and position of the opening may be adjusted to match an image display pattern of the display portion in response to a positional change of the viewer's head. For example, a horizontal position of an opening may be changed in response to movement of a viewer. In this case, the barrier pitch is maintained. The principle of this embodiment is not dependent on the number of parallaxes. For example, the principle of this embodiment is effective even under conditions in which the number of parallaxes exceeds “2”.

It should be noted that the first and second regions may be positionally fixed. In this case, a voltage for achieving a transmittance of “100%” is applied to the second region. The first region having transmittance of “0%” may be formed by using a glass or a film subjected to masking processes.

The principle of this embodiment may be suitably applied to a step barrier and a vertical stripe barrier in addition to a slant barrier.

A plasma display, a liquid crystal display and an organic EL display are exemplified as the display portion described in the aforementioned various embodiments.

In the aforementioned various embodiments, the display group is set to include two sub-pixels, which are adjacent in the horizontal direction. Alternatively, the display group may be set to include more than “2” of sub-pixels. In this case, preferably, a ratio between the number of sub-pixels aligned in the vertical direction and the number of sub-pixels aligned in the horizontal direction in the region (region corresponding to the rectangular region FPR shown in FIG. 2), which is recognized as one pixel by the viewer, is consistent at all of the set viewpoints. In addition, preferably, the number of sub-pixels in the display group is set so that the width of the display group is not become excessively large with respect to the width dimension of the opening.

In the third and fourth embodiments, image data acquired by a camera is used. It should be noted that the image data may be obtained with several cameras. If image data obtained with several cameras is used, positional detection accuracy for the head may be improved.

It should be noted that the detector may measure the TOF (Time of Flight) other than the imaged data (TOF method). If a time length from light emission such as an LED toward an object (viewer) to a time at which the reflected light is returned is measured, a distance between the display device and the object may be appropriately detected. It should be noted that three-dimensional position measuring technologies using electromagnetic force may be used as the aforementioned tracking technologies.

The display device may control an arrangement of a parallax image in response to a position of the viewer's head. For example, the display device may calculate arrangement of the parallax image by using a CPU or a GPU in real-time. Alternatively, the display device may select the arrangement of the parallax image from an LUT prepared in advance.

The aforementioned principle of the various embodiments is not limited to a barrier structure. A slant barrier, a step barrier or a vertical stripe barrier may be used as the separator. Or, the principle of the aforementioned embodiments is also effective in the use of a barrier structure having various other opening patterns.

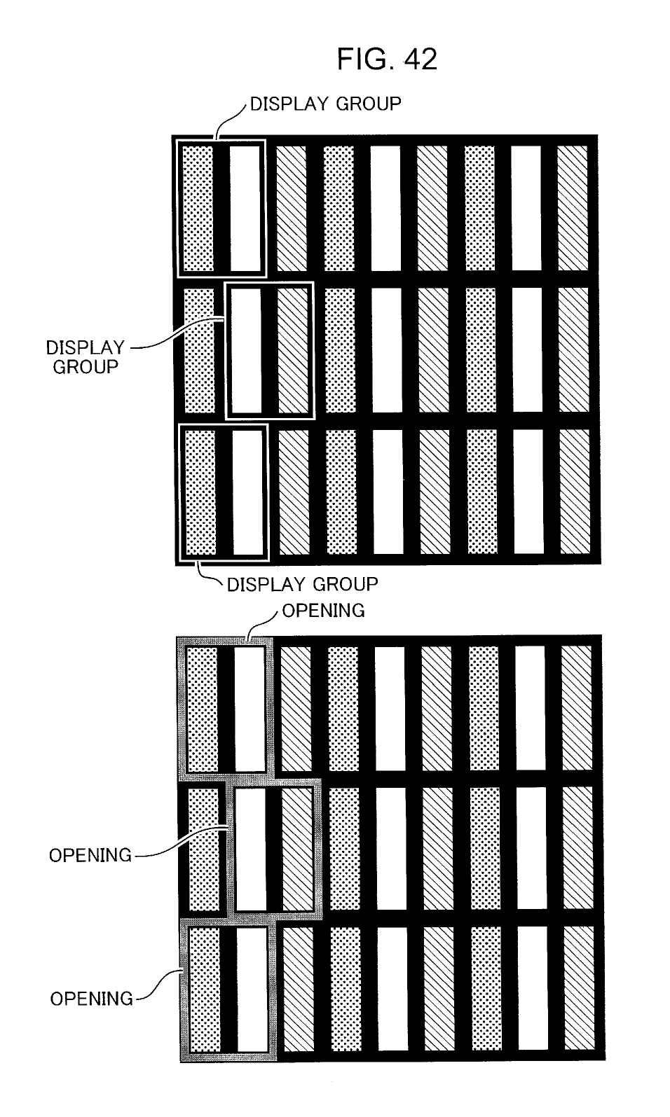

FIG. 42 is a schematic view of another barrier structure. The other barrier structure is described with reference to FIG. 42.

The display portion sets a display group for displaying a left or right image. The uppermost display group and the lowermost display group are aligned in the vertical direction whereas the central display group is shifted rightward by one sub-pixel with respect to the other display groups. The barrier structure may include a rectangular opening configured to match a pattern of the set display group.

In this embodiment, the aspect ratio of the sub-pixels is “3:1”. Alternatively, the sub-pixels may have other aspect ratios. For example, the sub-pixels may have an aspect ratio of “5:1”. The inclination angle is set to the slant barrier and the step barrier in response to the aspect ratio of the sub-pixels. According to the first embodiment, the inclination angle of the opening of the barrier structure is set to “5:2”. According to the second embodiment, the inclination angle of the opening of the barrier structure is set to “5:1”.

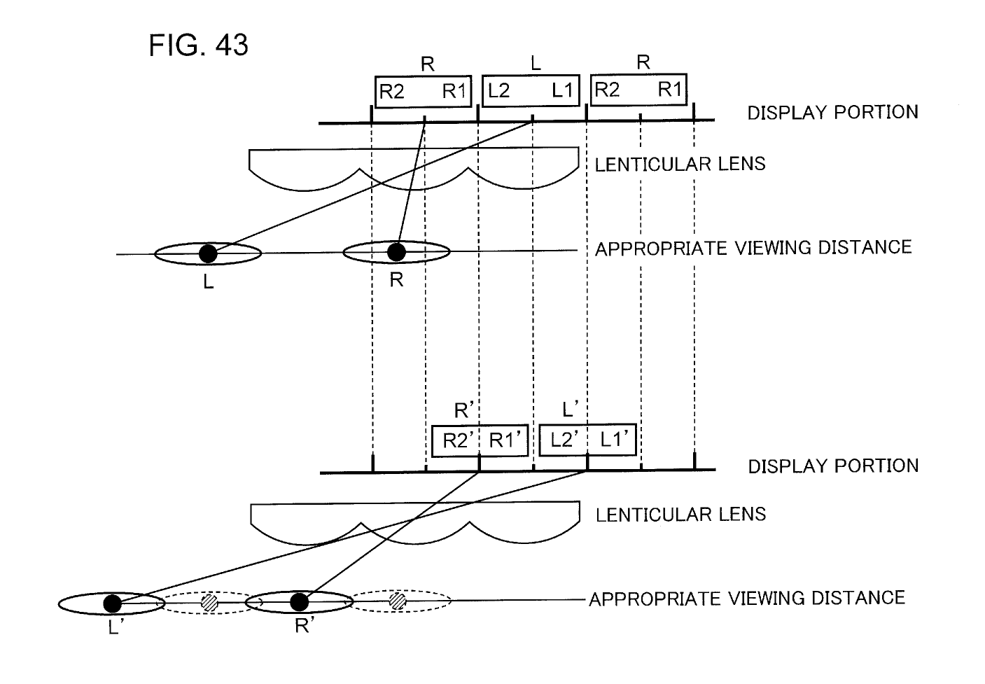

FIG. 43 is a schematic view of the display device with a lenticular lens. The display device is described with reference to FIG. 43.

A lenticular lens may be used instead of the barrier structure described with reference to the aforementioned various embodiments. In this case, the lenticular lens functions as the separator.

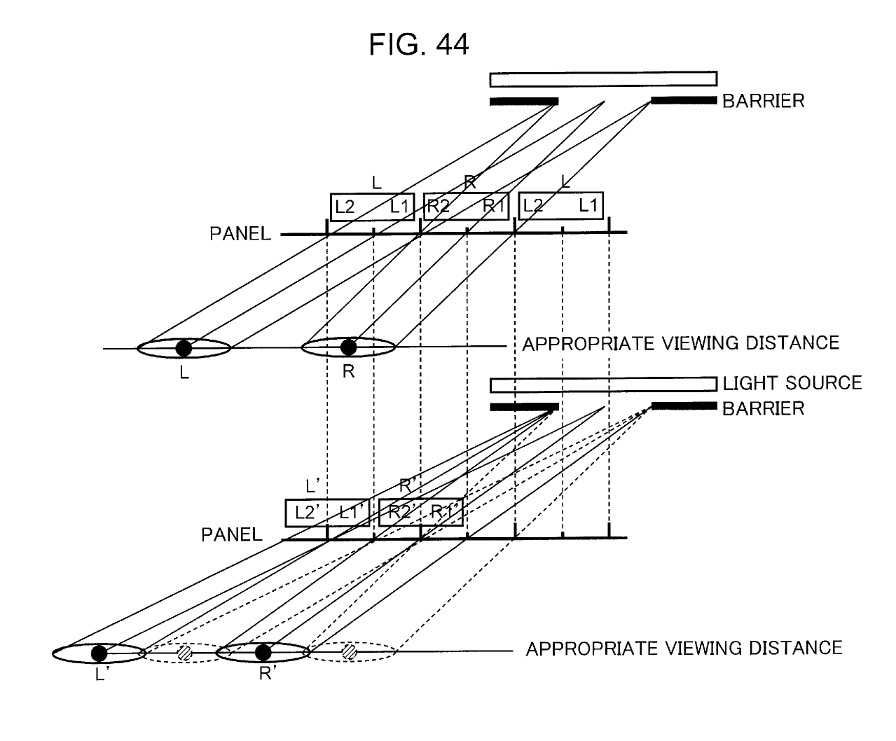

FIG. 44 is a schematic view of the display device. The display device is described with reference to FIG. 44.

The barrier structure described with reference to the aforementioned various embodiments does not have to be situated between the viewer and the display portion. For example, if a liquid crystal panel is used as the display portion, the barrier structure may be situated between the liquid crystal panel and a light source.

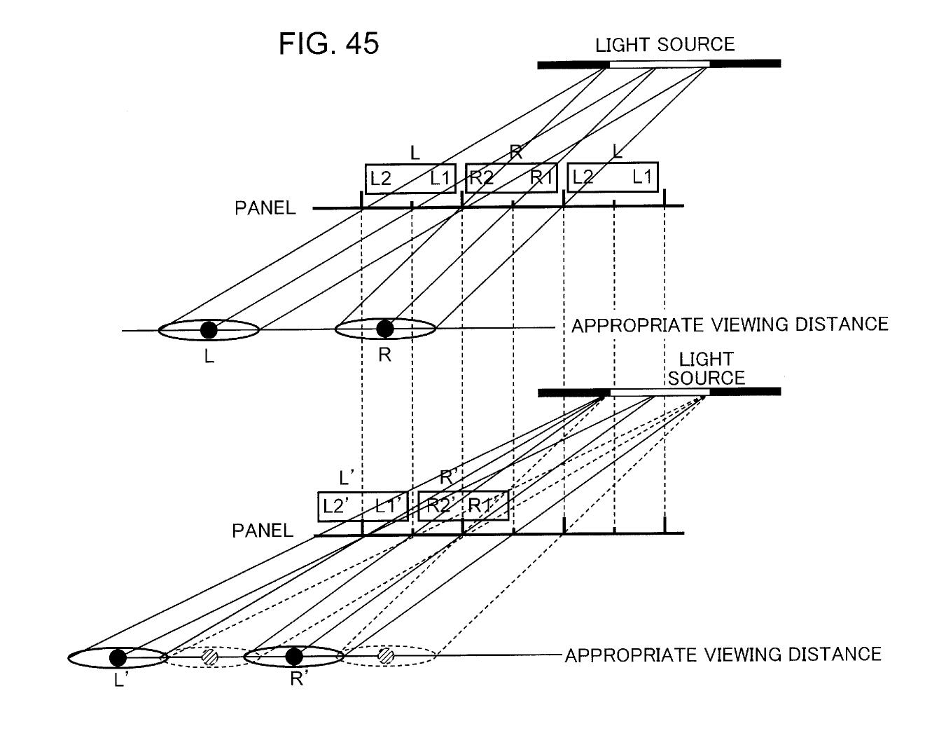

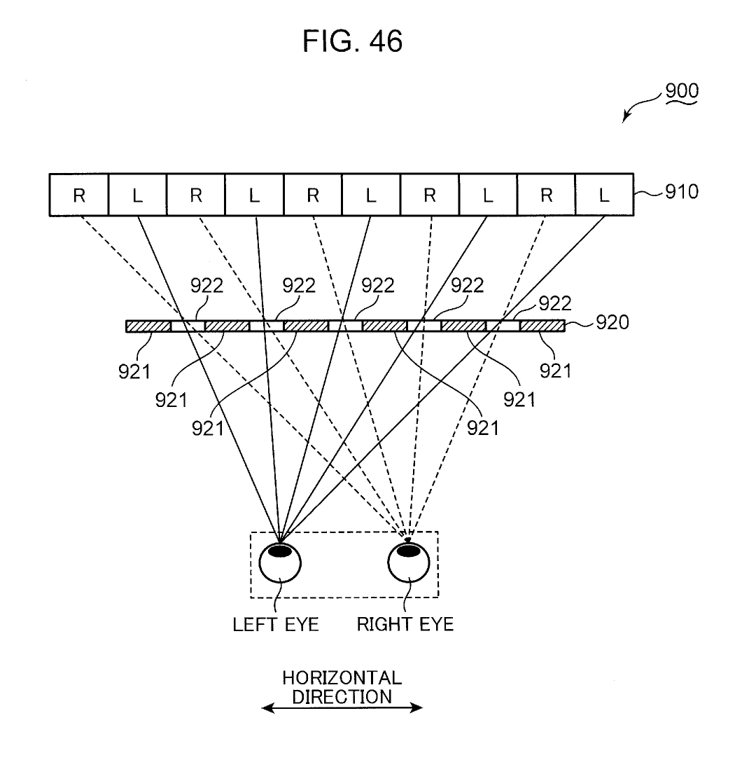

FIG. 45 is a schematic view of the display device. The display device is described with reference to FIG. 45.

If a liquid crystal panel is used as the display portion, the barrier structure may not be required. For example, if the light source has a stripe emission region, the advantageous effects resulting from the aforementioned various embodiments may be obtained without a barrier structure.

Elements for appropriately setting a vertical period width of the notch structure described in the aforementioned embodiments may be adopted. For example, elements for determining a vertical period width may be provided to set the vertical period width is set so that the notch structure itself may not cause a moire pattern.

A notch structure with triangular protrusion is described in the aforementioned various embodiments. Alternatively, the notch structure may have a profile of a saw blade shape, a saw blade shape, a rectangular shape, a trapezoidal shape, a parallelogram shape or a falcate shape. The profile of the notch structure may be drawn by a triangular function (sine function, cosine function, tangent function) or an approximate function to them. The principle of the aforementioned various embodiments is not limited to a specific shape drawn by a contour portion of the notch structure.

In the aforementioned various embodiments, a notch structure in which the protrusions (and/or depressions) are geometrically uneven may be used. The expression of “geometrically uneven protrusions (and/or depressions)” may mean that several notch depths are set within one notch structure.

In the aforementioned various embodiments, various dimensions of the notch structure are determined with reference to the sub-pixels. Alternatively, the smallest element used for displaying images may be used as a reference for designing the notch structure. For example, a pixel including sub-pixels may be used as a reference for designing the notch structure.

The various technologies described in the context of the aforementioned embodiments mainly include the following features.

The display device according to one aspect of the aforementioned embodiments includes a display portion configured to display a composite image of a left image to be viewed by a left eye and a right image to be viewed by a right eye by using display elements arranged in a matrix. The display portion defines first element groups for displaying one of the left and right images, and second element groups for displaying the other of the left and right images among the display elements. The first element groups include a first height group situated at a first vertical position, and a second height group situated at a second vertical position different from the first vertical position. The second element groups include a first adjacent group adjacent to the first height group in the horizontal direction, and a second adjacent group adjacent to the second height group in the horizontal direction. The first adjacent group includes a first adjacent element adjacent to the first height group. The second adjacent group includes a second adjacent element adjacent to the second height group. The first adjacent element emits different light in a color from the second adjacent element.

According to the aforementioned configuration, since the display portion displays a composite image of a left image to be viewed by a left eye and a right image to be viewed by a right eye by using display elements arranged in a matrix, the display device may provide a stereoscopic image to the viewer. If there is a change in a viewing position of the viewer, the viewer may view the first adjacent element in the first adjacent group adjacent to the first height group and the second adjacent element in the second adjacent group adjacent to the second height group. Since the first adjacent element emits different light in a color from the second adjacent element, strong moire is less likely to happen. Since the moire may be weakened substantially irrespective of a width of an opening of a barrier structure which blocks image light from the display portion, crosstalk is less likely to increase.

In the aforementioned configuration, the first element groups may form a first group column inclined at a predetermined angle from a vertical line. The second element groups may form a second group column inclined at the predetermined angle. The first and second group columns may be alternately arranged in the horizontal direction.

According to the aforementioned configuration, since the first and second group columns are inclined at the predetermined angle from the vertical line, an aspect ratio of a region recognized as one pixel by the viewer at one viewpoint may be set appropriately. Accordingly, the viewer may enjoy high quality images.

In the aforementioned configuration, the display device may further include a separator situated away from the display portion and configured to separate image light of the composite image into the left and right image lights. The separator may include blocking regions for blocking the image light. An opening may be formed between the blocking regions so as to allow transmission of the image light. The opening may extend along the first or second group column.

According to the aforementioned configuration, since the separator blocks the image light with the blocking regions, which define the opening extending along the first or second group column, the image lights of the left and right images may be appropriately separated.

In the aforementioned configuration, the blocking regions may include protrusions which protrude toward the center line of the opening inclined at the predetermined angle from the vertical line.

According to the aforementioned configuration, since an area and shape of the display elements, which are exposed from the opening, are appropriately adjusted by the protrusions protruding toward the center line of the opening, the viewer is less likely to perceive moire.

In the aforementioned configuration, the blocking regions may include a first contour defining a boundary with the opening, and a second contour facing the first contour. The first and second contours may extend in an extending direction of the center line. A distance between the first and second contours may be shorter than a horizontal width of the first or second element group.

According to the aforementioned configuration, since the distance between the first and second contours extending in the extending direction of the center line of the opening is shorter than a horizontal width of the first or second element group, the first and second adjacent elements are likely to be hidden from the viewer due to the blocking regions. Accordingly, the viewer is less likely to perceive crosstalk.

In the aforementioned configuration, the display device may further include an acquisition portion configured to acquire positional information about a position of a viewer viewing an image displayed by the display portion. The display portion may select the first element groups and the second element groups among the display elements in response to the positional information.

According to the aforementioned configuration, since the display portion selects the first element groups and the second element groups among the display elements in response to the positional information, the viewer may appropriately view a stereoscopic image even when the viewer moves.

In the aforementioned configuration, the blocking regions may include an adjustment region configured to adjust transmittance of the image light. The adjustment region is formed around the opening. The display portion may change the transmittance in response to the positional information.

According to the aforementioned configuration, since a shape of the opening is appropriately adjusted by the adjustment region in response to the positional information, the viewer may appropriately view stereoscopic images.

In the aforementioned configuration, the display elements may be sub-pixels.

According to the aforementioned configuration, the display device may use the sub-pixels to appropriately display stereoscopic images.

### INDUSTRIAL APPLICABILITY

The principle of the aforementioned various embodiments may be suitably applied to devices configured to display stereoscopic images or multiple-view images. The aforementioned principle is particularly useful for portable display devices (e.g. tablet devices).

1. A display device, comprising:
a display portion configured to display a composite image of a left image to be viewed by a left eye and a right image to be viewed by a right eye by using display elements arranged in a matrix,
wherein the display portion defines first element groups for displaying one of the left and right images, and second element groups for displaying another of the left and right images among the display elements,
wherein the first element groups include a first height group situated at a first vertical position, and a second height group situated at a second vertical position different from the first vertical position,
wherein the second element groups include a first adjacent group adjacent to the first height group in a horizontal direction, and a second adjacent group adjacent to the second height group in the horizontal direction,
wherein the first adjacent group includes a first adjacent element adjacent to the first height group,
wherein the second adjacent group includes a second adjacent element adjacent to the second height group, and
wherein the first adjacent element emits different light in a luminescent color from the second adjacent element.

2. The display device according to claim 1,
wherein the first element groups form a first group column inclined at a predetermined angle from a vertical line,
wherein the second element groups form a second group column inclined at the predetermined angle, and
wherein the first and second group columns are alternately arranged in the horizontal direction.

3. The display device according to claim 2, further comprising:
a separator situated away from the display portion and configured to separate image light of the composite image into left image light corresponding to the left image and right image light corresponding to the right image,
wherein the separator includes blocking regions for blocking the image light,
wherein an opening is formed between the blocking regions so as to allow transmission of the image light, and
the opening extends along the first or second group column.

4. The display device according to claim 3,
wherein the blocking regions include protrusions which protrude toward a center line of the opening inclined at the predetermined angle from the vertical line.

5. The display device according to claim 4,
wherein the blocking regions include a first contour defining a boundary with the opening, and a second contour facing the first contour,
wherein the first and second contours extend in an extending direction of the center line, and
wherein a distance between the first and second contours is not greater than a horizontal width of the first or second element group.

6. The display device according to claim 3, further comprising:
an acquisition portion configured to acquire positional information about a position of a viewer viewing an image displayed by the display portion,
wherein the display portion selects the first element groups and the second element groups among the display elements in response to the positional information.

7. The display device according to claim 6,
wherein the blocking regions include an adjustment region configured to adjust transmittance of the image light,
wherein the adjustment region is formed around the opening, and
wherein the display portion changes the transmittance in response to the positional information.

8. A display device, comprising:
a display portion configured to display a composite image of a left image to be viewed by a left eye and a right image to be viewed by a right eye by using display elements arranged in a matrix,
wherein the display portion defines first element groups for displaying one of the left and right images, and second element groups for displaying another of the left and right images from among the display elements,
wherein the first element groups include a first height group situated at a first vertical position, and a second height group situated at a second vertical position different from the first vertical position,
wherein the second element groups include a first adjacent group adjacent to the first height group in a horizontal direction, and a second adjacent group adjacent to the second height group in the horizontal direction,
wherein the display portion defines a first boundary element between the first adjacent group and the first height group,
wherein the display portion defines a second boundary element between the second adjacent group and the second height group, and
wherein the first boundary element emits different light in a luminescent color from the second boundary element.

9. The display device according to claim 1,
wherein the display elements are sub-pixels.
